(19) United States
(12) Patent Application Publication
(10) Pub. No.: US 2008/0068977 A1
(43) Pub. Date: Mar. 20, 2008

(54) INFORMATION STORAGE MEDIUM AND DISK APPARATUS

(75) Inventors: Hideo Ando, Hino-shi (JP); Seiji Morita, Yokohama-shi (JP); Koji Takazawa, Tokyo (JP); Yasuaki Ootera, Yokohama-shi (JP); Naoki Morishita, Yokohama-shi (JP); Kazuyo Umezawa, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/848,102

(22) Filed: Aug. 30, 2007

(30) Foreign Application Priority Data
Sep. 13, 2006 (JP) 2006248349

(51) Int. Cl. G11B 3/70

(52) U.S. Cl. 369/277

(57) ABSTRACT

According to one embodiment, an information storage medium has a substrate, a first recording layer containing an organic dye material, a first barrier layer, a spacer layer, a second recording layer, a second barrier layer, and a protective layer formed on the second barrier layer. The angle that the outer side surface and inner side surface of the protective layer make with a direction parallel to the surface of the second barrier layer is 30° to 150°, at least one of the first and second barrier layers has lands and grooves on its two major surfaces and the depth of the lands on one major surface is smaller than that of the lands on the other major surface close to the substrate, or the first and second barrier layers are made of a material formable by coating.

### CROSS-REFERENCE TO RELATED APPLICATIONS

This application is based upon and claims the benefit of priority from Japanese Patent Application No. 2006-248349, filed Sep. 13, 2006, the entire contents of which are incorporated herein by reference.

### BACKGROUND

1. Field

One embodiment of the present invention relates to an information storage medium capable of recording and playing back information by using a short-wavelength laser beam such as a blue laser beam, and a disk apparatus that plays back the medium.

2. Description of the Related Art

As is well known, the importance of media that store digital data is recently increasing along with the spread of personal computers and the like. For example, information storage media capable of digital recording and playback of, e.g., long-time video information and audio information are presently spreading. Also, information storage media for digital recording and playback are beginning to be used in mobile devices such as cell phones.

Many information storage media of this type are disk-like media. The reasons are that the disk-like media have a large information recording capacity and high random access performance capable of rapidly searching for desired recorded information, and are small in size, light in weight, superior in space-saving property and portability, and inexpensive.

Of these disk-like information storage media, so-called optical disks are presently most frequently used because they can record and play back information in a non-contact state by emitting a laser beam. The optical disks mainly comply with the CD (Compact Disk) standards or DVD (Digital Versatile Disk) standards, and the two standards are compatible.

The optical disks are classified into three types: read-only optical disks incapable of information recording, such as a CD-DA (Digital Audio), CD-ROM (Read Only Memory), DVD-V (Video), and DVD-ROM; write-once optical disks capable of writing information just once, such as a CD-R (Recordable) and DVD-R; and rewritable optical disks capable of rewriting information any number of times, such as a CD-RW (ReWritable) and DVD-RW.

Of the recordable optical disks, the write-once optical disks using an organic dye in a recording layer are most widely used because the manufacturing cost is low.

Recently, a double-layered DVD-R is proposed to meet the demand for increasing the capacity of the write-once recording disk. The double-layered DVD-R is a DVD-R having two recording layers; the disk has two organic dye recording layers.

Unfortunately, it is difficult for this double-layered DVD-R to obtain satisfactory recording/playback characteristics.

Also, a double-layered, write-once recording disk like this may have a structure obtained by sequentially stacking, e.g., a light-reflecting layer, recording layer, barrier layer, semi-light-transmitting layer, recording layer, barrier layer, and protective layer on a transparent resin substrate or the like. This structure extremely complicates the manufacturing process, and often increases the manufacturing cost and decreases the yield.

As a manufacturing process technique that increases the yield, Jpn. Pat. Appln. KOKAI Publication Nos. 2005-259311 and 2005-4944, for example, describe a method of divisionally forming a protective layer in two steps by spinner coating. This method can dry the protective layer within a short time period. However, the thickness of the protective layer often varies to deteriorate the recording/playback characteristics.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is sectional view schematically showing an embodiment of an information storage medium of the present invention;

FIG. 2 is a sectional view schematically showing another example of the information storage medium of the present invention;

FIG. 3 is a view for explaining the specifications of B-format optical disks;

FIG. 4 is a view showing the arrangement of a picket code (error correction block) in B format;

FIG. 5 is a view for explaining a wobble address in B format;

FIG. 6 is a view showing details of the structure of a wobble address combining the MSK method and STW method;

FIG. 7 is a view showing an ADIP unit that is a unit of 56 wobbles and expresses a bit “0” or “1”;

FIG. 8 is a view showing an ADIP word made up of 83 ADIP units and indicating one address;

FIG. 9 is a view showing the ADIP word;

FIG. 10 is a view showing 15 nibbles contained in the ADIP word;

FIG. 11 is a view showing the track structure of B format;

FIG. 12 is a view showing the recording frame of B format;

FIGS. 13A and 13B are views showing the structures of recording unit blocks;

FIG. 14 is a view showing the structures of data run-in and data run-out;

FIG. 15 is a view showing the arrangement of data related to the wobble address;

FIGS. 16A and 16B are views for explaining a guard 3 region placed at the end of a data run-out region;

FIG. 17 is a view showing a manufacturing step of an information storage medium according to an embodiment of the present invention;

FIG. 18 is a view showing a manufacturing step of the information storage medium according to the embodiment of the present invention;

FIG. 19 is a view showing a manufacturing step of the information storage medium according to the embodiment of the present invention;

FIG. 20 is a view showing a manufacturing step of the information storage medium according to the embodiment of the present invention;

FIG. 21 is a view showing a manufacturing step of the information storage medium according to the embodiment of the present invention;

FIG. 22 is a view showing a manufacturing step of the information storage medium according to the embodiment of the present invention;

FIG. 23 is a perspective view showing the longitudinal section of a disk-like information storage medium according to an embodiment of the present invention;

FIG. 24 is an enlarged view of a portion of the section shown in FIG. 23;

FIG. 25 is an enlarged view of another portion of the section shown in FIG. 23;

FIG. 26 is a view showing recording film structures, in which (a) and (b) are views respectively showing a standard phase-change recording film structure and organic dye recording film structure;

FIG. 27 is a graph for explaining an example of the light absorption spectrum of an organic dye recording material used in the current DVD-R disk;

FIGS. 28A and 28B are views comparing the shapes of a phase-change recording film and organic dye recording film in a pre-pit region or pre-groove region 10;

FIGS. 29A and 29B are views showing practical plastic deformation states of a transparent substrate 2-2 in the position of a recording mark 9 of a write-once information storage medium using the conventional organic dye material;

FIGS. 30A to 30C are views for explaining the shapes and dimensions of recording films that easily cause the recording principle;

FIGS. 31A to 31C are views for explaining features of the shapes and dimensions of recording films;

FIG. 32 is a graph for explaining the light absorption spectrum of an “H→L” recording film in an unrecorded state;

FIG. 33 is a graph for explaining the light absorption spectrum in a recording mark of the “H→L” recording film;

FIG. 34 is a graph for explaining the light absorption spectrum of an “L→H” recording film in an unrecorded state;

FIG. 35 is a graph showing the change in light absorption spectrum of the “L→H” recording film in a recorded state and unrecorded state;

FIG. 36 is a graph for explaining an example of the change in light absorption spectrum of the “H→L” recording film before and after recording;

FIG. 37 is a graph for explaining an example of the change in light absorption spectrum of the “L→H” recording film before and after recording; and

FIG. 38 is a graph for explaining another example of the change in light absorption spectrum of the “L→H” recording film before and after recording.

### DETAILED DESCRIPTION

Various embodiments of the present invention will be explained below.

The information storage medium is classified into the first to fifth embodiments having the following features.

Information storage media according to the first to third embodiments are basically information storage media capable of recording and playing back information from one side, and have a structure in which a first recording layer containing an organic dye material, a first barrier layer, a space layer, a second recording layer containing an organic dye material, a second barrier layer, and a protective layer are sequentially formed on a substrate having lands and grooves with a concentric shape or spiral shape. Lands and grooves synchronizing with the concentric shape or spiral shape are formed on at least one major surface of each of the first recording layer, first barrier layer, space layer, second recording layer, and second barrier layer.

In the first embodiment of the present invention, the information storage medium has a central hole, and the angle that the outer side surface and inner side surface of the protective layer make with a direction parallel to the surface of the second barrier layer can be 30° to 150°.

In the second embodiment of the present invention, at least one of the first and second barrier layers can have lands and grooves synchronizing with the concentric shape or spiral shape on its two major surfaces, and the depth of the lands on one major surface can be smaller than that of the lands on the other major surface close to the substrate.

In the third embodiment, the first and second barrier layers can be made of a material formable by coating.

Information storage media according to the fourth and fifth embodiments of the present invention are basically information storage media capable of recording and playing back information from one side, and have a structure in which a light-reflecting layer, a first recording layer containing an organic dye material, a first barrier layer, a space layer, a semi-light-transmitting layer, a second recording layer containing an organic dye material, a second barrier layer, and a protective layer are sequentially formed on a substrate having lands and grooves with a concentric shape or spiral shape. Lands and grooves synchronizing with the concentric shape or spiral shape are formed on at least one major surface of each of the light-reflecting layer, first recording layer, first barrier layer, space layer, semi-light-transmitting layer, second recording layer, and second barrier layer.

In the fourth embodiment of the present invention, the wobble width of the grooves of the first recording layer that face the semi-light-transmitting layer can be larger than that of the grooves of the second recording layer that face a light-reflecting layer.

In the fifth embodiment of the present invention, the depth of the lands of the first recording layer can differ from that of the lands of the second recording layer.

In the first embodiment, the angle that the inner or outer side surface of the transparent protective layer makes with the recording layer is set within the range of 30° to 150°. Therefore, the thickness of the transparent protective layer can be made uniform over the wide region from the inner peripheral portion to the outer peripheral portion of the information storage medium. Consequently, it is possible to prevent deterioration of the characteristics of the recording layer that occurs when water penetrates the recording layer through the transparent protective layer. In addition, since the thickness of the transparent protective layer is uniform over the broad range from the inner peripheral portion to the outer peripheral portion, it is possible to improve the playback characteristic or recording characteristic of an information recording/playback apparatus with respect to the recording layer.

In the second embodiment, at least one of the first and second barrier layers has the lands and grooves synchronizing with the concentric shape or spiral shape on its two major surfaces, and the depth of the lands on one major surface is smaller than that of the lands on the other major surface close to the substrate. Since the wettability of the first and second recording layers is thus taken into consideration, the wobble signal amounts obtained from the first and second recording layers can be made almost equal to each other. This makes it possible to obtain stable wobble signals from both the first and second recording layers.

In the third embodiment, the barrier layer is formed between the recording layer and space layer. Therefore, the space layer can be stably formed without deteriorating the characteristics and shape of the recording layer. Likewise, the barrier layer is formed between the recording layer and protective layer, so the transparent protective layer can be stably formed without deteriorating the characteristics and shape of the recording layer. Also, the barrier layers can be formed by various coating methods because the material formable by coating is selected as the barrier layers. The coating method facilitates manufacture and shortens the manufacturing time, compared to the conventional sputtering method or vacuum evaporation method. In addition, since manufacture is possible at normal pressure, the apparatus is simple and inexpensive. Consequently, the cost of the information storage medium according to the third embodiment of the present invention can be reduced.

In the fourth embodiment, the wobble width of the lands and grooves of the space layer is made smaller than that of the lands and grooves of the substrate by taking account of the difference in wettability between the first and second recording layers when they are formed. Accordingly, the wobble signal amounts obtained from the first and second recording layers can be made almost equal to each other, thereby improving the wobble signal detection stability of an information recording/playback apparatus.

In the fifth embodiment, the depth of the lands of the first recording layer differs from that of the lands of the second recording layer. Since the difference in wettability between the first and second recording layers is thus taken into consideration, the wobble signal amounts obtained from the first and second recording layers can be made almost equal to each other. This makes it possible to obtain stable wobble signals from both the first and second recording layers.

Furthermore, as the material of the first and second barrier layers, it is possible to use, e.g., aqueous paint. Since the aqueous paint is inexpensive and easy to handle, it is possible to reduce the manufacturing cost and shorten the manufacturing time of the information storage medium according to the present invention.

The present invention will be explained in more detail below with reference to the accompanying drawing.

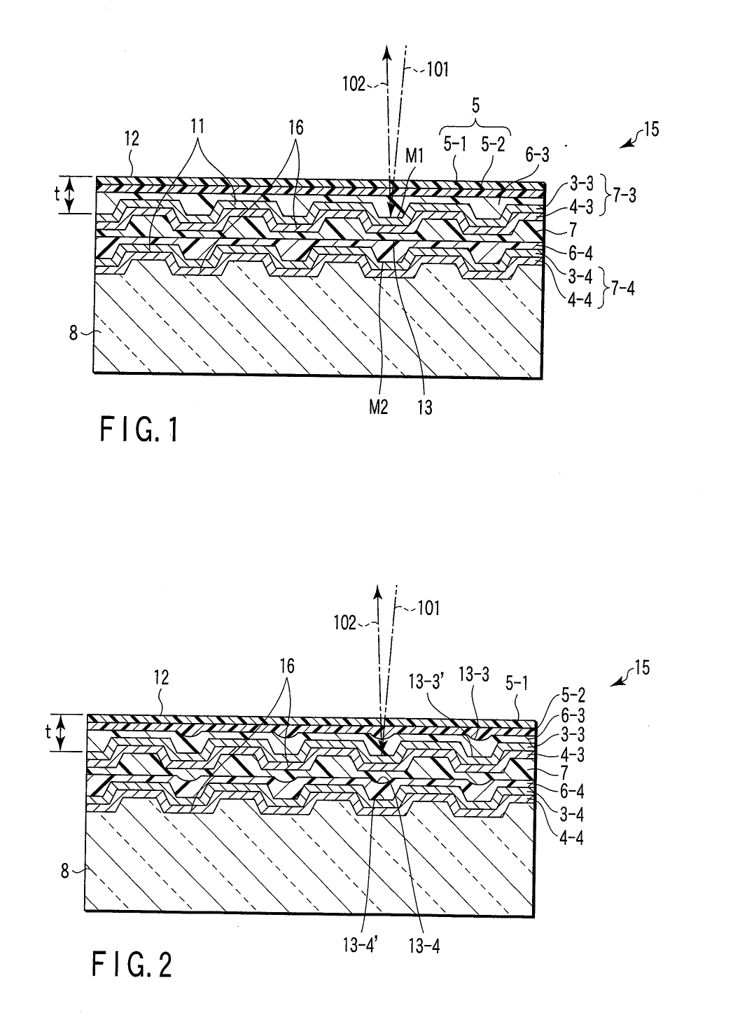

FIG. 1 is a sectional view schematically showing an embodiment of an information storage medium of the present invention.

As shown in FIG. 1, an information storage medium 15 has a substrate 8 having concentric or spiral lands and grooves on one major surface. On the substrate 8, a light-reflecting layer 4-4 and recording layer 3-4 each having lands and grooves on the two major surfaces are sequentially stacked. A barrier layer 6-4 is formed on the recording layer 3-4 so as to fill at least portions of recesses of the lands. A space layer 7 is formed on the barrier layer 6-4, and concentric or spiral lands and grooves are formed on the surface of the space layer 7 by a stamper (not shown). On the space layer 7, a semi-light-transmitting layer 4-3 and recording layer 3-3 each having lands and grooves on the two major surfaces are sequentially formed. A second barrier layer 6-3 is formed on the recording layer 3-3 so as to fill at least portions of recesses of the lands. On the barrier layer 6-3, transparent protective layers 5-2 and 5-1 are sequentially stacked to form a transparent protective layer 5.

Assume that a combination of the semi-light-transmitting layer 4-3 and recording layer 3-3 is a layer L0 as a recording portion, and a combination of the light-reflecting layer 4-4 and recording layer 3-4 is a layer L1 as another recording portion.

For example, a laser beam entering in the direction of an arrow 101 is reflected by the layer L0 in the direction of an arrow 102. Recorded information can be read on the basis of this reflected light.

In this information storage medium, the protective layer 5-1 is a read surface. Of projections 11 and recesses 16, therefore, the projections 11 closer to the read surface function as grooves, and the recesses 16 farther from the read surface than the grooves 11 function as lands.

The substrate has a sufficient thickness, e.g., a thickness of a little less than 1.1 mm.

A thickness t of the protective layer is, e.g., about 0.1 mm.

In the first embodiment, the angle that the outer and inner surfaces of the protective layer make with a direction parallel to the barrier layer surface is 30° to 150° in the information storage medium shown in FIG. 1.

By making the side-surface angle of the protective layer close to 30° to 150°, particularly, 90°, it is possible to ensure the uniformity of the thickness of the transparent protective layer on the inner periphery and outer periphery of the information storage medium. This makes it possible to prevent deterioration of the characteristics of the recording layer that occurs when water penetrates the recording layer through the protective layer 5. In addition, the read accuracy and recording accuracy of an information recording/playback apparatus can be secured.

FIG. 2 is a sectional view schematically showing another example of the information storage medium of the present invention.

As shown in FIG. 2, the information storage medium according to the second embodiment of the present invention has the same arrangement as FIG. 1 except that at least one of barrier layers 6-3 and 6-4 has lands and grooves synchronizing with a concentric shape or spiral shape on two major surfaces 13-3 and 13-3′ and/or 13-4 and 13-4′, and that the depth of the lands on the major surfaces 13-3 and 13-4 can be smaller than that of the lands on the major surfaces 13-3′ and 13-4′ on the substrate side.

By making the step amounts in the interfaces of the barrier layers different, it is possible to facilitate formation of the space layer and protective layer on the barrier layers, and improve the reliability of mass-production. The cost of the information storage medium can also be reduced by simplifying the manufacture of the information storage medium.

In the third embodiment of the present invention, a material formable by a coating method can be used as the material of the barrier layers 6-3 and 6-4 in the information storage medium shown in FIG. 1.

In addition, it is necessary to prevent dissolution, deformation, and modification of the recording layers 3-3 and 3-4 when the barrier layers 6-3 and 6-4 are formed by the coating process.

Therefore, water, polyvinyl alcohol (PVA), polyurethane vinyl alcohol, perfluoroether, von prioni oil, or the like can be selected as the solvent of a solution containing the material of the barrier layers 6-3 and 6-4, and a water-soluble material, aqueous paint, gelatin-based material, nitrile rubber-based material, silicone-based material, urethane rubber-based material, or the like that dissolves in the solvent can be selected as the material of the barrier layers 6-3 and 6-4. Making the barrier layers 6-3 and 6-4 formable by coating facilitates the manufacture and shortens the manufacturing time. As a consequence, the manufacturing cost of the information storage medium can be largely reduced.

In the fourth and fifth embodiments of the present invention, the wobble amplitude of a land M2 between the light-reflecting layer 4-4 and recording layer 3-4 can be made smaller than that of a land M1 between the semi-light-transmitting layer 4-3 and recording layer 3-3, or the depths of these lands in the layers L1 and L0 can be made different from each other, in the information storage medium shown in FIG. 1.

In the formation stage of the recording layers 3-4 and 3-3, the shapes or the dimensions such as the depths of the land M2 of the recording layer 3-4 and the land M1 of the recording layer 3-3 can be made different from each other by making the wettability between a coating solution containing the organic dye material of the recording layer 3-4 and the light-reflecting layer different from that between a coating solution containing the organic dye material of the recording layer 3-3 and the semi-light-transmitting layer 4-3. This makes it possible to match the characteristics of playback signals from the layers L0 and L1, and improve the recording/playback characteristics of an information recording/playback apparatus.

Another embodiment of the present invention can secure the flatness of the surface of the protective layer over the entire surface of the information storage medium.

Deterioration of the recording layer caused by the penetration of water can be prevented by flattening the surface of the transparent protective layer over the entire surface of the information storage medium. It is also possible, by making the thickness t of the transparent protective layer uniform, to assure high read accuracy or high write accuracy of an information recording/playback apparatus over the entire surface of the information storage medium.

Still another embodiment of the present invention can give the protective layer a multilayered structure.

The protective layer having the stacked structure makes it possible to facilitate the manufacture of the information storage medium and secure a low cost and high reliability of the information storage medium, compared to a single-layered protective layer having a large thickness.

Also, in the information storage media shown in FIGS. 1 and 2, the lands 16 and grooves are preformed, and address information is prerecorded by wobbling the grooves 11. Examples of the contents of information recorded in the pre-groove 11 and the format of data recorded in the recording layer 3-3 or 3-4 of the information storage medium according to this embodiment will be described below.

§ Explanation of B Format

Specifications of B-Format Optical Disks

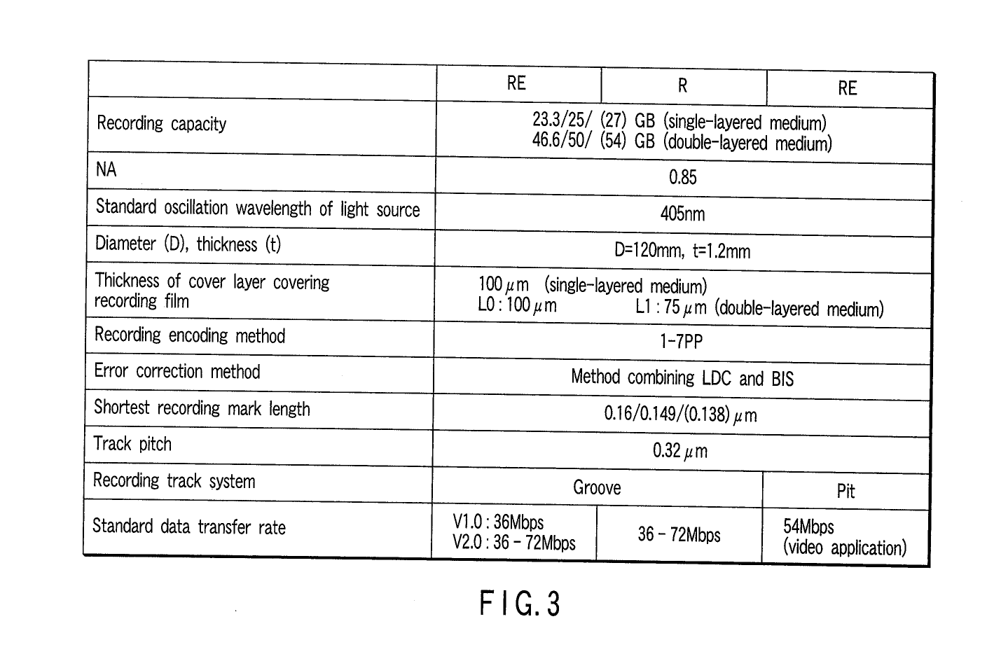

FIG. 3 shows the specifications of B-format optical disks using a blue-violet laser source. The B-format optical disks are classified into a rewritable disk (RE disk), read-only disk (ROM disk), and write-once disk (R disk). As shown in FIG. 3, however, the specifications are common to these types except for the standard data transfer rate. This facilitates implementation of a common drive compatible to different types. The current DVD is obtained by adhering two 0.6-nm thick disk substrates. On the other hand, B format adopts a structure in which a recording layer is formed on a 1.1-nm thick disk substrate and covered with a 0.1-nm thick transparent cover layer. B format also defines a single-sided, double-layered medium.

[Error Correction Method]

B format adopts an error correction method called a picket code capable of efficiently detecting a burst error. Pickets are inserted at predetermined intervals in a sequence of main data (user data). A strong, efficient Reed-Solomon code protects the main data. A second, very strong, efficient Reed-Solomon code different from the one protecting the main data protects the pickets. In decoding, the pickets first undergo error correction. The correction information can be used to estimate the positions of burst errors in the main data. As symbols of these positions, flags called “Erasure” that are used to correct code words of the main data are set.

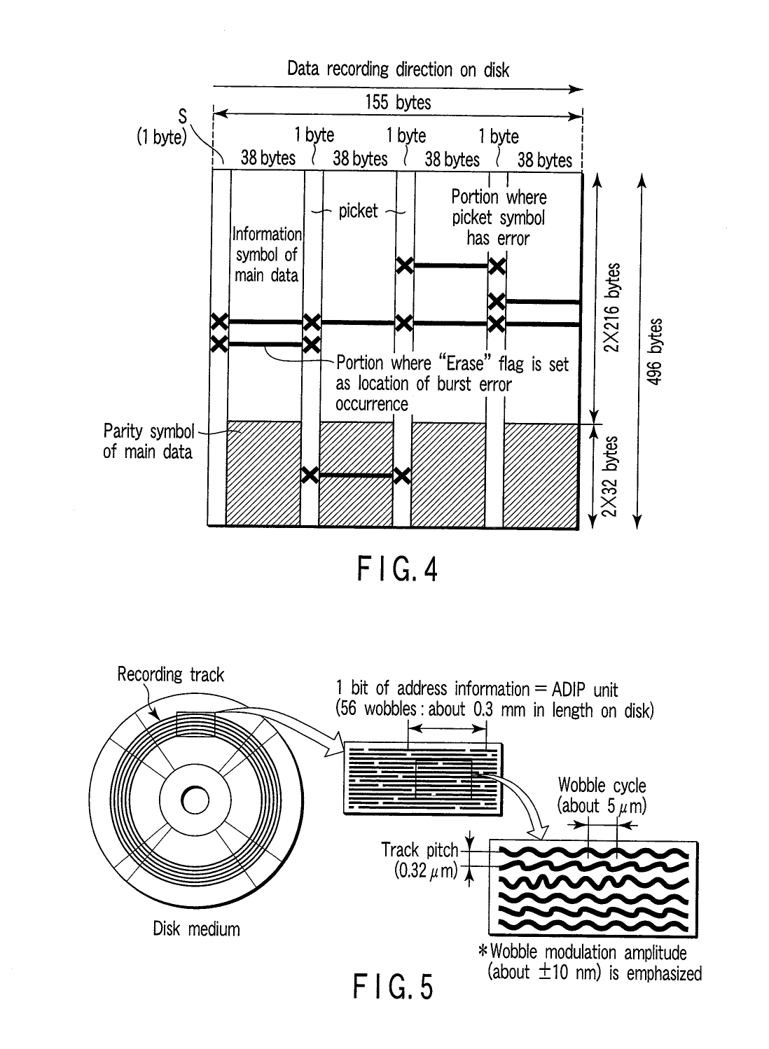

FIG. 4 shows the arrangement of the picket code (error correction block). Similar to H format, the error correction block (ECC block) of B format is formed by using 64-Kbyte user data as a unit. A very strong Reed-Solomon code LDC (Long Distance Code) protects this data.

The LDC includes 304 code words. Each code word includes 216 information symbols and 32 parity symbols. That is, the code word length has 248 (=216+32) symbols. These code words are interleaved for every 2×2 code words in the longitudinal direction of the ECC block, thereby forming the ECC block having 152 (=304÷2) bytes in the lateral direction and 496 (=2×216+2×32) bytes in the longitudinal direction.

The interleave length of the picket has 155×8 bytes (the 496 bytes include eight control code correction sequences), and the interleave length of the user data has 155×2 bytes. The recording unit of the 496 bytes in the longitudinal direction has 31 rows. As parity symbols of the main data, a parity symbol of two groups is inverted on every row.

B format adopts picket codes embedded in the form of a “column” at predetermined intervals into this ECC block. A burst error is detected by checking the statuses of errors. More specifically, four picket sequences are arranged at equal intervals in one ECC block. An address exists in the picket. The picket contains a unique parity.

It is also necessary to correct symbols in the picket sequences. Therefore, the three picket sequences on the right side are protected by error correction coding by using a BIS (Burst Indicator Subcode). The BIS includes 30 information symbols and 32 parity symbols, and has a code word length of 62 symbols. The ratio of the information symbols to the parity symbols shows that the BIS has extremely powerful correction capability.

The BIS code words are stored as they are interleaved in three picket sequences each including 496 bytes. The numbers of parity symbols per code word of the two codes LDC and BIS are equal, i.e., 32. This means that a common Reed-Solomon decoder can decode both the LDC and BIS.

To decode data, the picket sequences are first corrected by the BIS. In this manner, the locations of burst errors are estimated, and flags called “Erasure” are set in these locations. These flags are used to correct code words of the main data.

Note that the information symbols protected by the BIS code form an additional data channel (side channel) different from the main data. Address information is stored in this side channel. Errors in this address information are corrected by using a dedicated Reed-Solomon code prepared separately from the one for the main data. This code includes five information symbols and four parity symbols. This makes it possible to grasp the address with high speed and high reliability, independently of the main data error correction system.

[Address Format]

Similar to the CD-R disk, very narrow grooves are cut like spirals as recording tracks on the RE disk. Of the projections and recesses, recording marks are written on only the projections when viewed in the incident direction of a laser beam (ON groove recording).

As in the CD-R disk and the like, address information indicating absolute positions on the disk is embedded by slightly wobbling (zigzagging or swinging) the grooves. A signal is modulated, and digital data representing “1” or “0” is carried on the shape or period of the zigzag. FIG. 5 shows the wobble method. The amplitude of the zigzag is only ±10 nm in the disk radial direction. 56 wobbles (about 0.3 mm as a length on the disk) form one bit of address information=ADIP unit (to be described later).

To write fine recording marks with almost no positional deviation, it is necessary to generate a stable, accurate recording clock signal. Accordingly, the present inventors have focused on a method by which the wobble has a single main frequency component, and the grooves smoothly continue. If the wobble has a single frequency, a stable recording clock signal can be easily generated from the wobble component extracted by a filter.

Timing information and address information are added to the wobble based on a single frequency. “Modulation” is performed for this purpose. As this modulation method, a method that does not easily cause errors even if there are various distortions unique to an optical disk is selected.

The wobble signal distortions produced in an optical disk are classified into the following four distortions in accordance with the causes:

(1) Disk noise: The disturbance (surface roughness) of the surface shape produced in the groove portion during manufacture, noise produced in a recording film, crosstalk noise leaking from recorded data, and the like.

(2) Wobble shift: A phenomenon in which the detection sensitivity lowers because a wobble detection position relatively deviates from a normal position in a recording/playback apparatus. This phenomenon readily occurs immediately after a seeking operation.

(3) Wobble beat: Crosstalk occurring between wobble signals on a track to be recorded and an adjacent track. This crosstalk occurs if there is a difference between the angular frequencies of adjacent wobbles when a rotation control method is CLV (Constant Linear Velocity).

(4) Defects: Defects are produced by local defects caused by dust or flaws on the disk surface.

For the RE disk, two different wobble modulation methods are combined so as to produce the synergistic effect, under the conditions that the disk has a high resistance against all the four different types of signal distortions described above. This is so because it is possible to obtain, without side effects, the resistance to the four types of signal distortions, which is generally difficult to be achieved by only one type of a modulation method.

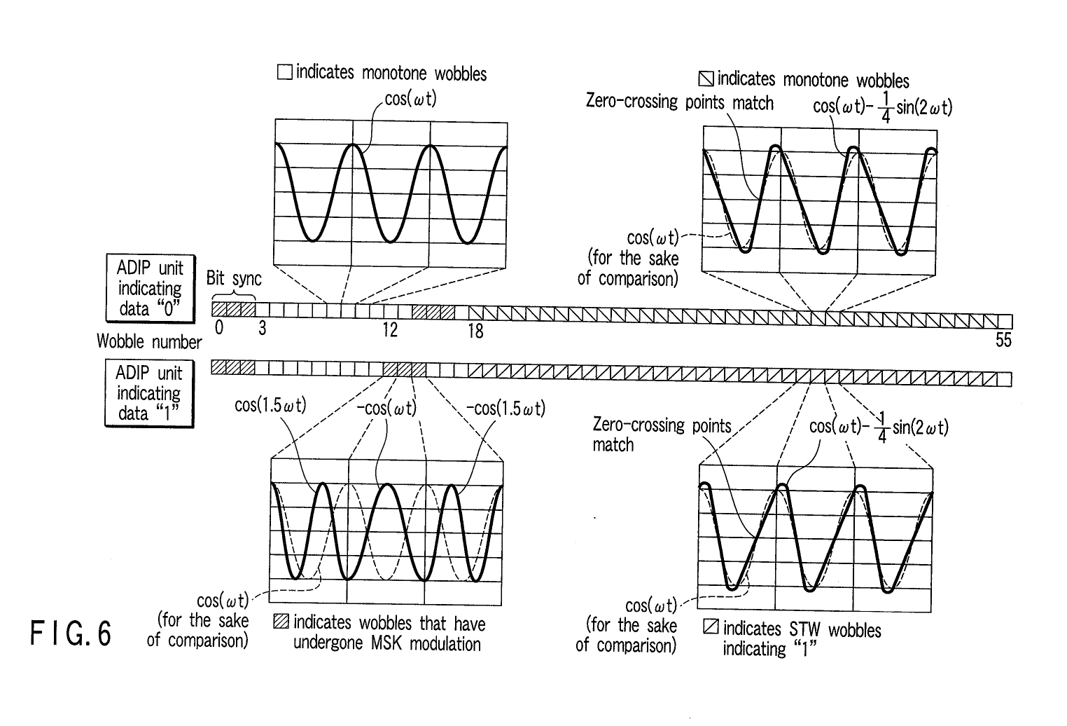

The two methods are the MSK (Minimum Shift Keying) method and STW (Saw Tooth Wobble) method (FIG. 6). The latter method is named STW because the waveform resembles “a saw tooth”.

In the RE disk, a total of 56 wobbles express one bit “0” or “1”. This unit of 56 wobbles is called an ADIP (ADdress InPre Groove) unit. An ADIP word indicating one address is obtained by successively reading out 83 ADIP units. The ADIP word includes 24-bit address information, 12-bit auxiliary data, a reference (calibration) region, error correction data, and the like. In the RE disk, three ADIP words are allocated to one RUB (Recording Unit Block, the unit is 64 Kbytes) that records the main data.

The ADIP unit made up of 56 wobbles is roughly divided into the first and second halves. The MSK method modulates the first half having wobble numbers 0 to 17, and the STW method modulates the second half having wobble numbers 18 to 55, thereby smoothly connecting one ADIP unit to another. One ADIP unit can express one bit. In accordance with whether the bit is “0” or “1”, the positions of wobbles modulated by the MSK method are changed in the first half, and the direction of the shape of the saw tooth wave is changed in the second half.

The first half modulated by the MSK method is subdivided into three wobble regions modulated by MSK, and a monotone wobble cos(wt) region. The three wobbles having wobble numbers 0 to 2 start from a wobble having undergone MSK modulation in any ADIP unit. This is called bit sync (an identifier indicating the start position of the ADIP unit).

After that, monotone wobbles continue. Data is represented by the number of monotone wobbles before the next three wobbles having undergone MSK modulation. More specifically, data is “0” if the number is 11, and “1” if the number is 9. A difference of two wobbles distinguishes between the two data.

The MSK method uses a local phase change of the fundamental wave. In other words, a region having no phase change is dominant. The STW method also effectively uses this region as a place where the phase of the fundamental wave remains unchanged.

A region having undergone MSK modulation has a length of three wobbles. The first wobble is set at a frequency 1.5 times (cos(1.5 wt)) that of the monotone wobble, the second wobble is set at the same frequency as the monotone wobble, and the third wobble is set at the 1.5-time frequency again, thereby returning the phase to the original one. Consequently, the polarity of the second (central) wobble is reversed from that of the monotone wobble, and this reversed polarity is detected. The start point of the first wobble and the end point of the third wobble are exactly in phase with the monotone wobble. This allows a smooth connection with no discontinuous portion.

On the other hand, the second half has two types of waveforms of the STW method. One waveform abruptly rises toward the outer periphery of the disk, and returns in the form of a gentle slope toward the disk center. The other waveform rises in the form of a gentle slope, and abruptly returns. The former waveform represents data “0”, and the latter waveform represents data “1”. The reliability of data is improved by indicating the same bit in one ADIP unit by using both the MSK method and STW method.

When mathematically expressed, the STW method is the addition or subtraction of a secondary harmonic sin(2 wt) having a ¼ amplitude to or from the fundamental wave cos(wt). However, the zero-crossing point is the same as that of the monotone wobble regardless of whether the STW method represents “0” or “1”. That is, when extracting a clock signal from the same fundamental wave component as the monotone wobble portion of the MSK method, the phase is not influenced at all.

As described above, the MSK method and STW method function to complement each other's weak points.

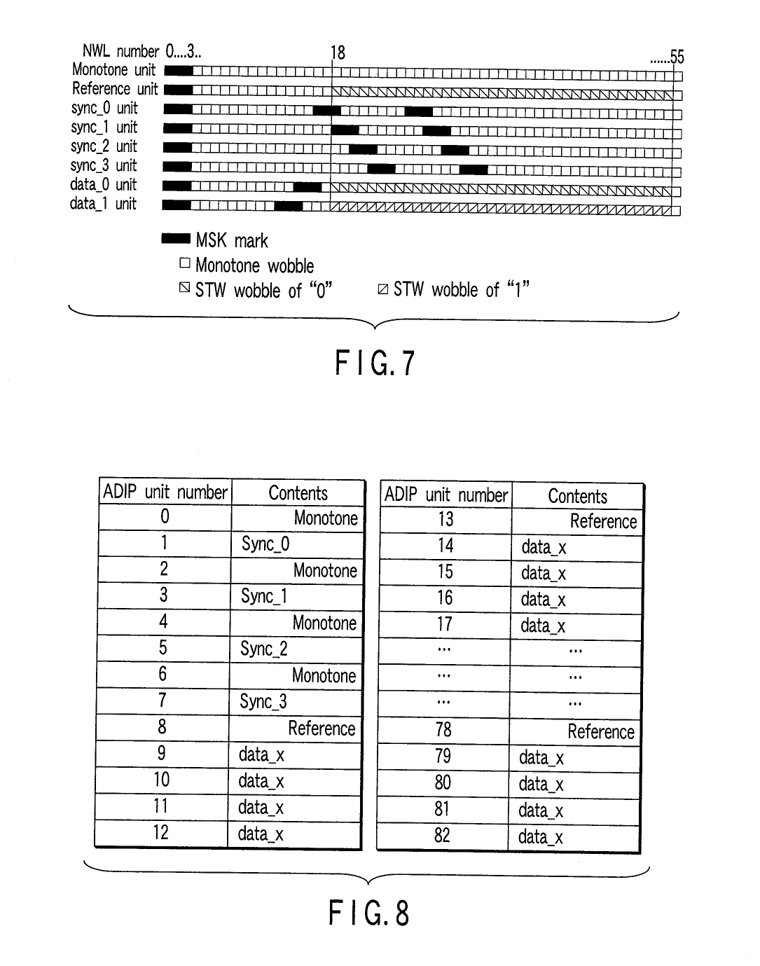

FIG. 7 shows the ADIP unit. The basic unit of the address wobble format is the ADIP unit. Each group having 56 NML (Nominal Wobble Length) is called an ADIP unit. One NML equals 69 channel bits. An ADIP unit of a different type is defined by inserting a modulation wobble (MSK mark) in a specific position of the ADIP unit (FIG. 6). Eighty-three ADIP units form one ADIP word. A minimum section of data recorded on the disk accurately matches three consecutive ADIP words. Each ADIP word contains 36 information bits (24 bits of which are address information bits).

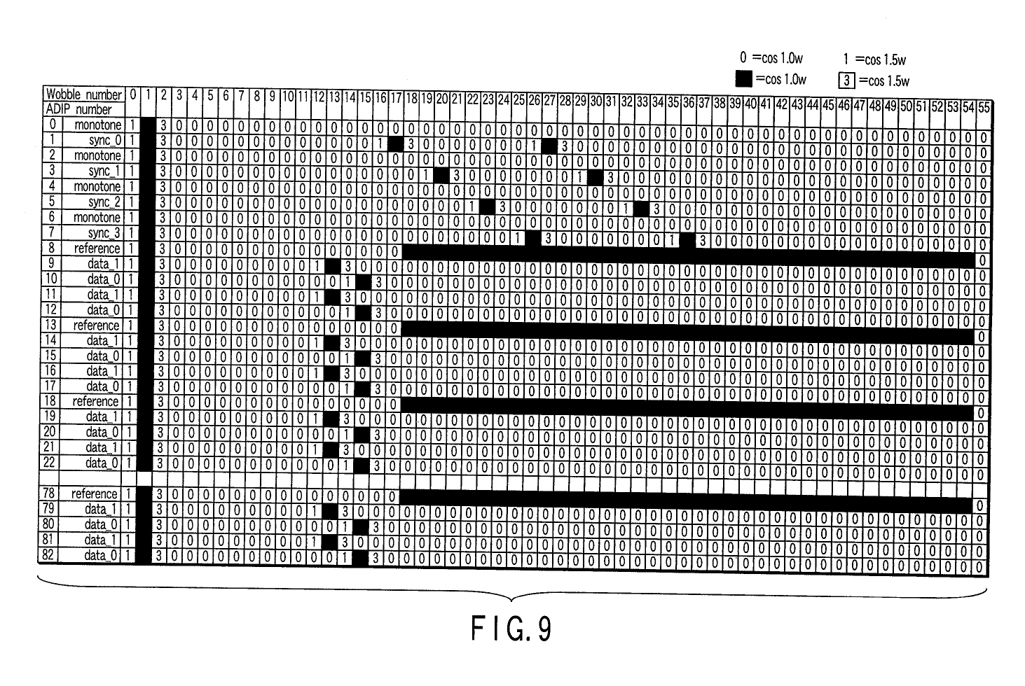

FIGS. 8 and 9 illustrate the arrangement of one ADIP word.

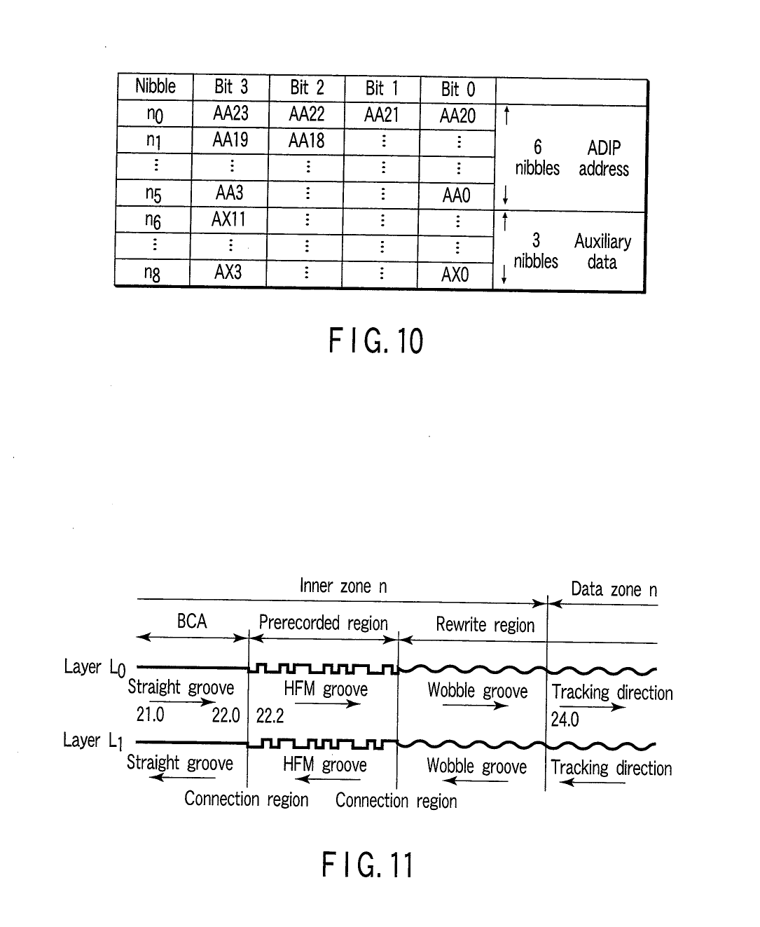

One ADIP word includes 15 nibbles. As shown in FIG. 10, nine nibbles are information nibbles, and other nibbles are used to correct errors of the ADIP. The 15 nibbles form a code word of a Reed-Solomon code [15, 9, 7].

The code word includes nine information nibbles; six information nibbles record address information, and three information nibbles record auxiliary information (e.g., disk information).

The Reed-Solomon code [15, 9, 7] is nonsystematic, and prior knowledge can increase the Hamming distance by “Informed Decoding”. “Informed Decoding” is that all code words have a distance of 7 and all code words of nibble n0 have a distance of 8 in common, so prior knowledge concerning n0 increases the Hamming distance. Nibble n0 includes a layer index (three bits) and the MSB of a physical sector number. If nibble n0 is known, the distance increases from 7 to 8.

FIG. 11 shows the track structures. The track structures of a first layer (far from a laser source) and a second layer of a single-sided, double-layered disk will be explained. Grooves are formed to make push-pull tracking feasible. A plurality of types of track shapes are used. The first layer L0 and second layer L1 are different in tracking direction; a direction from the left to the right in FIG. 11 is the tracking direction in the first layer, and a direction from the right to the left in FIG. 11 is the tracking direction in the second layer. The left side in FIG. 11 is the inner periphery of the disk, and the right side in FIG. 11 is the outer periphery of the disk. A BCA region having a straight groove, a prerecorded region having an HFM (High Frequency Modulated) groove, and a wobble groove region in a rewrite region of the first layer correspond to the lead-in area of H format. A wobble region in a rewrite region, a prerecorded region having an HFM (High Frequency Modulated) groove, and a BCA region having a straight groove of the second layer correspond to the lead-out area of H format. In H format, however, the lead-in area and lead-out area are recorded by the prepit system instead of the groove system. The phases of the HFM grooves in the first and second layers are shifted so as not to produce any interlayer crosstalk.

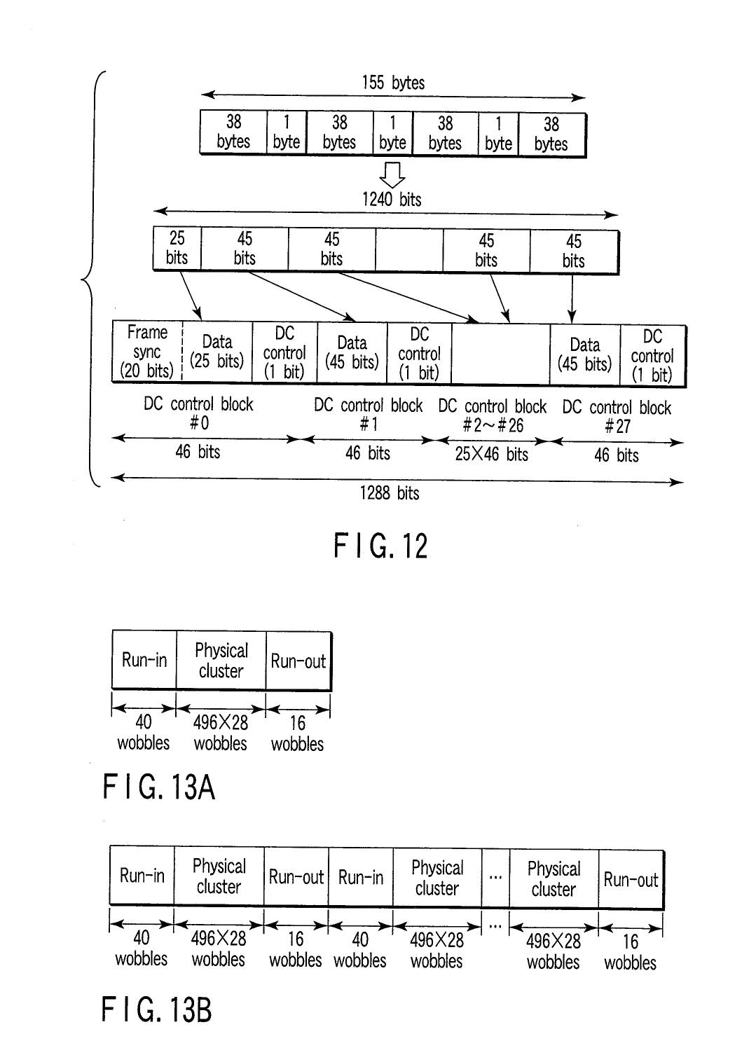

FIG. 12 shows a recording frame. As shown in FIG. 4, the user data is recorded in each-64-Kbyte section. Each row of an ECC cluster is converted into a recording frame by adding a frame sync bit and DC control bit. A 1,240-bit (155-byte) stream of each row is converted as follows. In the 1,240-bit stream, 25-bit data is placed at the head, and the stream after that is divided into 45-bit data. Twenty frame sync bits are added before the 25-bit data, and one DC control bit is added after the 25-bit data. Similarly, one DC control bit is added after each 45-bit data. A block containing the first 25-bit data is DC control block #0, and succeeding blocks each containing the 45-bit data and one DC control bit are DC control blocks #1, #2, . . . , #27. Four hundred ninety-six recording frames are called physical clusters.

The recording frame undergoes 1-7 PP modulation at a ⅔ rate. The modulation rules are applied to 1,268 bits except for the first frame sync to obtain 1,902 channel bits, and 30 frame sync bits are added to the head of the entire frame. That is, 1,932 channel bits (=28 NML) are formed. The channel bits are recorded on the disk after NRZI modulation.

Structure of Frame Sync

Each physical cluster includes 16 address units. Each address unit includes 31 recording frames. Each recording frame starts with frame sync having 30 channel bits. The first 24 bits of the frame sync violate the 1-7 PP modulation rule (i.e., include a runlength twice that of 9T). The 1-7 PP modulation rule performs parity preserve/prohibit PMTR (Repeated Minimum Transition Runlength) by using the (1, 7) PLL modulation method. Parity preserve controls a so-called DC (Direct Current) component of a code (reduces the DC component of the code). The six remaining bits of the frame sync change to allow identification of seven frame syncs FS0, FS1, . . . , FS6. Symbols of these six bits are selected so that the distance concerning a deviation amount is 2 or more.

The seven frame syncs make it possible to obtain position information more detailed than that obtained by only 16 address units. The seven different frame syncs alone are, of course, insufficient to identify 31 recording frames. Accordingly, seven frame sync sequences are selected from 31 recording frames so that each frame can be identified by combining its own frame sync with frame sync of one of four preceding frames.

FIGS. 13A and 13B illustrate the recording unit block RUB. The unit of recording is called an RUB. As shown in FIG. 13A, the RUB includes 40-wobble data run-in, a physical cluster having 496×28 wobbles, and 16-wobble data run-out. The data run-in and data run-out allow data buffering sufficient to facilitate completely random overwrite. The RUBs can be recorded one by one, or, as shown in FIG. 13B, a plurality of RUBs may also be continuously recorded.

The data run-in mainly has repetitive patterns of 3T/3T/2T/2T/5T/5T in which two frame syncs (FS4 and FS6) are spaced apart from each other by 40 cbs as indicators indicating the start position of the next recording unit block.

The data run-out starts with FS0, and patterns of 9T/9T/9T/9T/9T/9T indicating the end of data follow FS0. The data run-out mainly has repetitive patterns of 3T/3T/2T/2T/5T/5T.

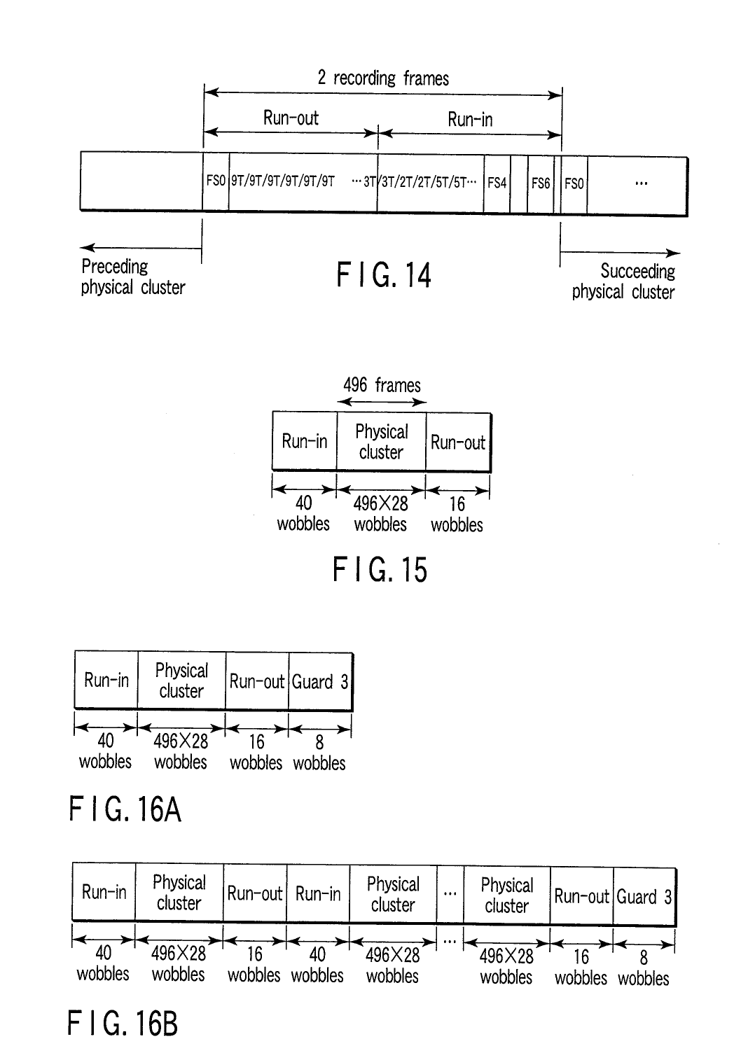

FIG. 14 shows the structures of the data run-in and data run-out.

FIG. 15 is a view showing the arrangement of data pertaining to the wobble address. A physical cluster has 496 frames. The data run-in and data run-out have a total of 56 wobbles (NWL) that are 2×28 wobbles and equivalent to two recording frames. 1 RUB = 496 + 2 = 498 recording frames 1 ADIP unit = 56 NWL = 2 recording frames 83 ADIP units = 1 ADIP word (including 1 ADIP address) 3 ADIP words = 3 × 83 ADIP units 3 ADIP words = 3 × 83 × 2 = 498 recording frames

To record data on a write-once disk, the data must be recorded following already recorded data. If a gap is produced between data, the data cannot be played back any longer. Therefore, to record (overwrite) the first data run-in region of a succeeding recording frame on the last data run-out region of a preceding recording frame, a guard 3 region is placed at the end of the data run-out region as shown in FIGS. 16A and 16B. FIG. 16A shows the case that only one physical cluster is recorded. FIG. 16B shows the case that a plurality of physical clusters are continuously recorded. In FIG. 16B, the guard 3 region is formed after the run-out of only the last cluster. The guard 3 region thus terminates each singly recorded recording unit block, or a plurality of continuously recorded recording unit blocks. The guard 3 region guarantees that there is no unrecorded area between two recording unit blocks.

In “§ Explanation of B Format” as described above, an information recording/playback apparatus is desired to read the address signal with high accuracy from the wobble signal in the groove 11 shown FIGS. 5 to 11. In the information storage medium of this embodiment, if a layer 1 7-4 and layer 0 7-3 are different in wobble signal quality, the wobble detection characteristic deteriorates in a specific layer. As described above, therefore, the detection signal characteristics obtained from wobbles by an information recording/playback apparatus are made almost equal to each other by making the shapes of the pre-grooves 11 in the layer 0 7-3 and layer 1 7-4 different from each other. Consequently, stable wobble detection signals can be obtained regardless of the layers. Note that the layer 0 7-3 means a combination of the recording layer 3-3 and semi-light-transmitting layer 4-3 shown in FIG. 1, and the layer 1 7-4 means a combination of the recording layer 3-4 and light-reflecting layer 4-4 shown in FIG. 1.

Also, the information shown in FIGS. 12 to 16A and 16B is recorded in the recording layers 3-4 and 3-3, and the error correction method as shown in FIG. 4 is used. However, this error correction shown in FIG. 4 is sometimes unsatisfactory for the information storage medium according to this embodiment. Accordingly, this embodiment improves the playback signal characteristics in particularly the inner or outer peripheral portion by ensuring the flatness of the surface of the transparent protective layer 5 over the entire information storage medium. This makes it possible to stably play back the recorded signal shown in FIGS. 12 to 16A and 16B.

Likewise, this embodiment improves the recording characteristics in particularly the inner or outer peripheral portion by securing the flatness of the surface of the transparent protective layer 5 over the entire surface of the information storage medium. This makes it possible to further stabilize recording based on the format shown in FIGS. 13A and 13B to 16A and 16B.

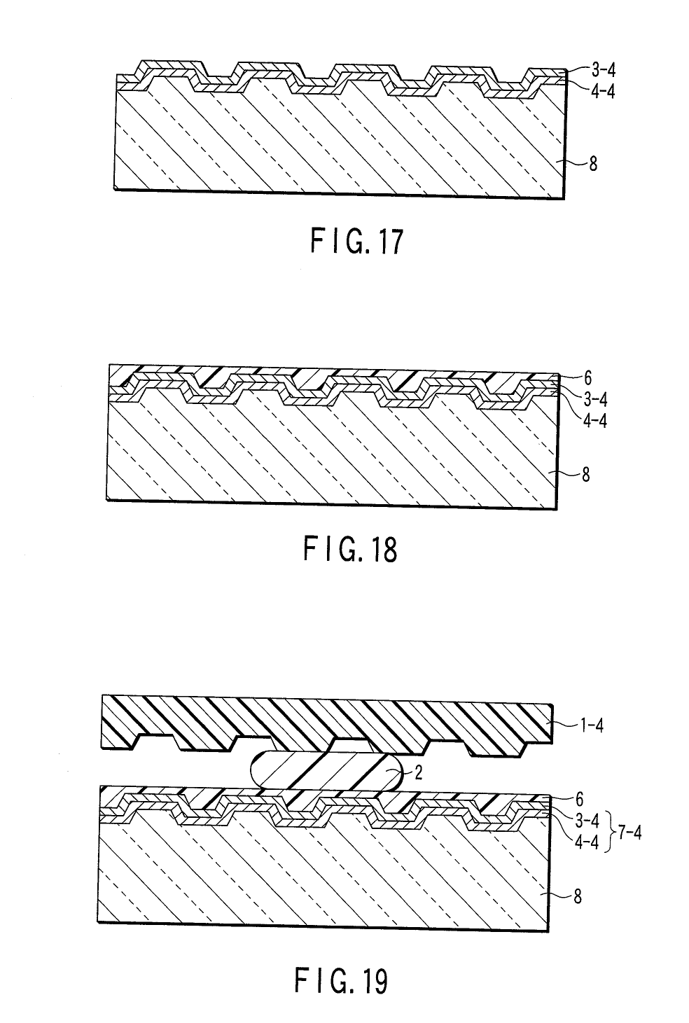

A method of manufacturing the information storage medium of this embodiment will be explained below with reference to FIGS. 1 and 17 to 22. A substrate 8 made of polycarbonate and having a thickness of a little less than 1.1 mm is prepared. The substrate 8 has lands and grooves on its surface. A light-reflecting layer 4-4 is formed on the substrate 8 by vacuum evaporation or sputtering.

This embodiment uses, e.g., silver bismuth AgBi as the material of the light-reflecting layer 4-4. The thickness of the light-reflecting layer 4-4 can be, e.g., 100 nm or more. When the light-reflecting layer 4-4 is thus sufficiently thick, the surface characteristic of silver bismuth AgBi directly appears on the undercoat when forming a recording layer 3-4 as will be described later. This embodiment forms the recording layer 3-4 on the light-reflecting layer 4-4 by spinner coating.

Also, this embodiment uses an organic metal complex as the material of the recording layer 3-4. A practical example of the organic metal complex is an azo metal complex. The light-reflecting layer 4-4 is coated with a solution prepared by dissolving the azo metal complex in a solvent. The solution is evenly spread by rotating the substrate 8, and the recording layer 3-4 is formed by evaporating the solvent. In the step of evenly spreading the solution on the light-reflecting layer 4-4 by spinner coating, the structure has low wettability to the solution because the surface of the light-reflecting layer 4-4 has the surface characteristic of silver bismuth AgBi alone as described above. Referring to FIG. 1, the recording layer 3-4 is formed along the projections and recesses of the light-reflecting layer 4-4. In reality, however, the recording layer 3-4 is often formed into a shape duller than the shape of the light-reflecting layer 4-4 due to the low wettability. This wettability has influence on the steps formed in the recording layer 3-4; the lands 16 may be formed into a shape duller than that explained previously, i.e., the width and depth of the lands 16 may decrease.

In this embodiment, the width and depth of the lands 16 mean the shape of the interface between the substrate 8 and light-reflecting layer 4-4. A difference between the height of the lands 16 and the height of portions except for the lands 16 in the interface between the substrate 8 and light-reflecting layer 4-4 is called a depth of the lands 16. This embodiment defines the width of a central portion of the step on the side surface of the land 16 as the width of the land 16. Accordingly, the step amount (depth) of that portion of the recording layer 3-4 which corresponds to the land 16 is smaller than that depth of the land 16 which complies with the definition. Similarly, the width of the step in that portion of the recording layer 3-4 which corresponds to the land 16 is smaller than that width of the land 16 which complies with the definition.

A space layer 7 is formed by 2P resin (a photopolymer). The formation of the space layer 7 poses the problem that the recording layer 3-4 is partially broken and cannot be stably held any longer.

This is so because when the space layer 7 is formed by coating of liquid 2P resin (by spinner coating), the recording layer 3-4 made of the material that dissolves in an organic solvent dissolves in this liquid 2P resin, and partially peels off. To prevent this, this embodiment forms a barrier layer 6-4 between the recording layer 3-4 and space layer 7, thereby preventing damage to the recording layer 3-4 when the space layer 7 is formed. If the barrier layer 6-4 is formed by vacuum evaporation or sputtering by using, e.g., an oxide such as SiO₂, an oxide, sulfide, nitride, or carbide of a metal or semiconductor such as Si₃N₄, or a fluoride of, e.g., Ca, Mg, or Li, the manufacturing time prolongs, and the manufacturing cost rises. However, this embodiment selects a material formable by coating (spinner coating) as the barrier layer 6-4. This makes it possible to largely shorten the formation time of the barrier layer 6-4, and decrease the cost of the information storage medium.

In this embodiment, the recording layer 3-4 is made of the material that dissolves in an organic solvent. Therefore, the barrier layer 6-4 cannot be formed by a solution containing an organic solvent. However, the material forming the recording layer 3-4 dissolves in an organic solvent but hardly dissolves in water. In this embodiment, therefore, it is possible by using this property to use a water-soluble material that dissolves in water as the material of the barrier layer 6-4. More specifically, water-soluble paint or the like can be used. When this water-soluble paint that dissolves in water is used as the barrier layer 6-4, it is possible to prevent the recording layer 3-4 from dissolving in a solution containing the barrier layer material when forming the barrier layer 6-4. When the barrier layer 6-4 is thus formed by using the water-soluble paint, the recording layer 3-4 does not peel off but stably holds its shape and characteristics during the formation of the barrier layer. In this embodiment, the material of the barrier layer 6-4 is not limited to the water-soluble paint. Examples are spin on glass that is water-soluble glass, gelatin (YAMATO glue), and water-soluble silicone.

Also, in this embodiment, the organic recording material forming the recording layer 3-4 does not dissolve in any of polyvinyl alcohol (PVA), polyurethane vinyl alcohol, perfluoroether, and von prioni oil. As another application example of this embodiment, therefore, it is possible to select, as the material of the barrier layer 6-4, an organic material capable of using PVA, polyurethane vinyl alcohol, perfluoroether, or von prioni oil as a solvent. Practical examples are a nitrile rubber-based organic material, silicone-based organic material, and urethane rubber-based organic material capable of using perfluoroether or von prioni oil as a solvent, and gelatin and a silicone-based organic material capable of using PVA (polyvinyl alcohol) or polyurethane vinyl alcohol as a solvent. When the barrier layer 6-4 is formed, therefore, the recording layer 3-4 does not dissolve in a solution before the barrier layer is formed, but stably holds its shape and characteristics.

In this embodiment, the surface of the barrier layer 6-4 looks like a relatively flat surface as shown in FIG. 18. In reality, however, when the barrier layer 6-4 is formed by coating (spinner coating), steps are more or less formed by the influence of the recesses of the lands 16 in the recording layer 3-4 as shown in FIG. 2. However, the projections and recesses on the surface of the barrier layer 6-4 are smaller than those on the substrate 8. Since the projections and recesses on the surface of the barrier layer 6-4 are thus smoothened to some extent, the space layer 7 can be easily formed on it.

As shown in FIG. 19, the space layer 7 is formed by coating ultraviolet-curing resin (2P resin) 2, and transferring the three-dimensional shape based on the lands 16 and grooves 11 by a polycarbonate stamper 1-4. More specifically, the liquid 2P resin 2 is dropped on the barrier layer 6-4 shown in FIG. 18, the polycarbonate stamper 1-4 having lands and grooves similar to those on the substrate surface is applied as shown in FIG. 19, and the 2P resin 2 is spread by rotating the whole substrate 8. During the rotation, the three-dimensional shape of the lands and grooves on the polycarbonate stamper 1-4 is transferred. After that, ultraviolet rays are radiated from the side of the polycarbonate stamper 1-4. The ultraviolet rays enter the 2P resin 2 through the polycarbonate stamper 1-4. As a consequence, the ultraviolet radiation cures the 2P resin 2.

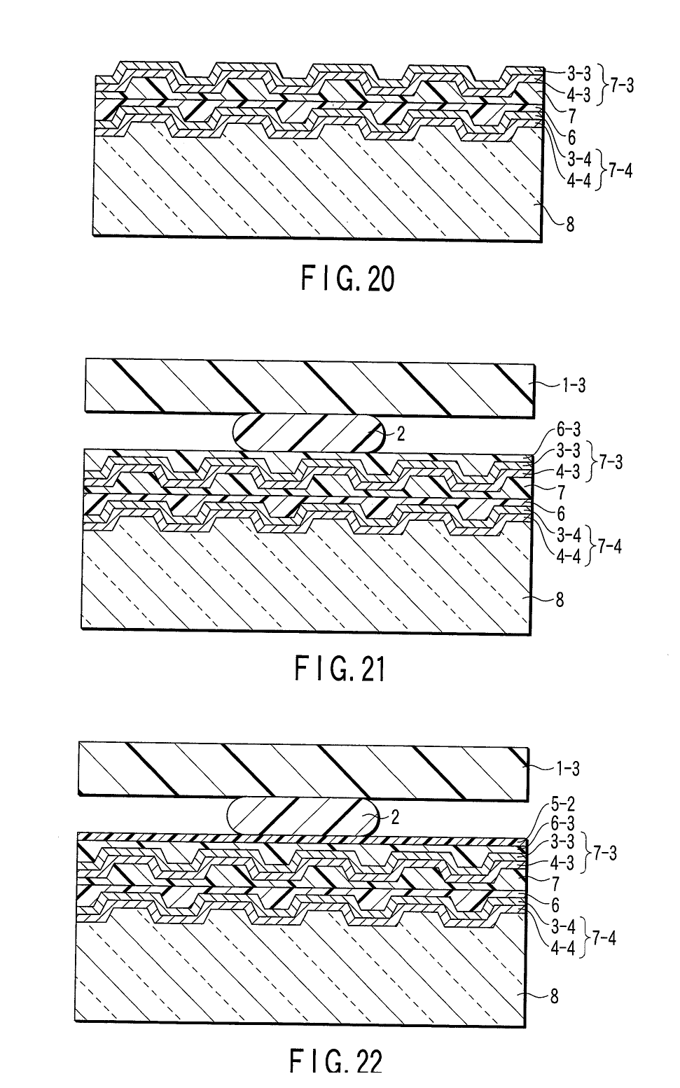

When the space layer 7 is formed by the 2P resin 2 in the step shown in FIG. 19, the three-dimensional shape of the polycarbonate stamper 1-4 is transferred to form projections and recesses on the surface of the space layer 7, thereby forming pre-grooves 11 and lands 16. As shown in FIG. 20, a semi-light-transmitting layer 4-3 is formed on the space layer 7. This embodiment forms the semi-light-transmitting layer 4-3 by sputtering or vacuum evaporation by using silver bismuth AgBi as the material. In this embodiment, a laser beam 9 must pass through the semi-light-transmitting layer 4-3 in order to play back information recorded in the recording layer 3-4. Accordingly, the thickness of the semi-light-transmitting layer 4-3 is preferably as small as possible, and desirably 100 nm or less. This embodiment can set the thickness of the semi-light-transmitting layer 4-3 to 23 to 25 nm.

After the semi-light-transmitting layer 4-3 is formed, as shown in FIG. 20, a recording layer 3-3 is formed by spinner coating. Similar to the recording layer 3-4, an organic metal complex is used as the material of the recording layer 3-3. In this embodiment, a practical example of the organic metal complex usable as the recording layer 3-3 is an azo metal complex.

The recording layer 3-4, however, is required to have high-sensitivity recording characteristics. That is, since the laser beam 9 reaches the recording layer 3-4 after passing through the recording layer 3-3 and semi-light-transmitting layer 4-3, the recording layer 3-4 must have high-sensitivity characteristics as the required performance. On the other hand, the recording layer 3-3 must have high light transmittance in order to transmit the laser beam 9 to the recording layer 3-4. Accordingly, this embodiment can use recording materials that are azo metal complexes but different in component or molecular structure, in accordance with the required performances of the recording layers 3-4 and 3-3.

As described above, the thickness of the light-reflecting layer 4-4 is sufficiently large. When viewed from the recording layer 3-4 formed on the light-reflecting layer 4-4, therefore, the undercoat has the same characteristics as silver bismuth AgBi alone, so the wettability to a solution containing the recording material is low when the recording layer 3-4 is formed. By contrast, the thickness of the semi-light-transmitting layer 4-3 is sufficiently small. Accordingly, when the recording layer 3-3 is formed, the wettability to a solution containing the recording material relatively rises by reflecting the characteristics of the underlying space layer 7. As described previously, the recording layer 3-3 is also formed by the spinner coating method. That is, the substrate 8 is coated with a solution containing the recording material (azo metal complex) for forming the recording layer 3-3, and the solution is spread by rotating the substrate 8. Since the wettability of the surface of the semi-light-transmitting layer 4-3 to the solution is high, the recording layer 3-3 can well reproduce the three-dimensional shape of the surface of the semi-light-transmitting layer 4-3, i.e., the shapes of the lands 16 and pre-grooves 11.

Consequently, if the shapes (width and depth) of the lands 16 and pre-grooves 11 on the substrate 8 are the same as the shapes (width and depth) of the lands 16 and pre-grooves 11 on the surface of the space layer 7, both the depth and width of the pre-grooves 11 of the recording layer 3-3 become larger than those of the pre-grooves 11 of the recording layer 3-4. This makes the amounts of wobble address signals from the lands 16 and pre-grooves 11 obtained from the recoding layers 3-4 and 3-3 different from each other.

The wobble address information from the pre-grooves 11 shown in FIGS. 5 to 11 must be almost equal in the layers 0 7-3 and 1 7-4. For this purpose, this embodiment can make the shape of the pre-groove 11 on the surface of the space layer 7 different from that of the pre-groove 11 on the surface of the substrate 8 by taking the wettability of the recording solution in consideration. As described above, the wettability of the solution forming the recording layer 3-3 is higher than that of the solution forming the recording layer 3-4. Since this improves the transferability of the three-dimensional shape of the lands 16 and pre-grooves 11, the depth of the pre-grooves 11 of the space layer 7 can be made smaller than that of the substrate 8. Various experiments indicate that the wobble signal amplitudes can be made almost equal when the small depth is 95% or less of the large depth. In addition, the width of the pre-grooves 11 of the space layer 7 is changed more than that of the pre-grooves 11 of the substrate 8, in the direction in which the wobble detection signal amplitude decreases.

This embodiment can also use another method. That is, the shapes of the lands 16 and pre-grooves 11 on the surfaces of the space layer 7 and substrate 8 are not made different from each other but made equal to each other. Instead, the wobble amplitude of the pre-grooves 11 of the space layer 7 (layer 0 7-3 side) is made smaller than that of the pre-grooves 11 of the substrate 8 (layer 1 7-4 side) so as to decrease the wobble detection signal amplitude, thereby making the wobble signal amplitudes from the layers 0 7-3 and 1 7-4 almost equal to each other. The results of various experiments reveal that the wobble signal amplitudes can be made almost equal when the small amplitude is 95% or less of the large amplitude. Another aspect shows that the wobble signal amplitudes can be made almost equal when the small amplitude is 80% or less of the large amplitude.

Subsequently, as shown in FIG. 21, a barrier layer 6-3 is formed on the recording layer 3-3. In this embodiment, the material and formation method of the barrier layer 6-3 can be the same as the barrier layer 6-4 described above. This makes it possible to reduce the manufacturing cost of the information storage medium.

In addition, this embodiment can flatten a surface 12 of a protective layer 5 by using a polycarbonate stamper 1-3 having a flat surface when forming the protective layer 5 on the barrier layer 6-3. To increase the productivity, it is also possible to decrease the film thickness per layer by stacking protective layers 5-1 and 5-2 as the protective layer 5, thereby increasing the manufacturing efficiency and the film flatness. As shown in FIG. 21, liquid 2P resin 2 is dropped on the barrier layer 6-3, and the polycarbonate stamper 1-3 whose flatness is secured is placed on the 2P resin 2 and rotated together with the substrate 8. This makes it possible to evenly spread the 2P resin 2 in the information storage medium. Then, the 2P resin 2 is irradiated with ultraviolet rays through the polycarbonate stamper 1-3, thereby forming a transparent protective layer 5-2.

Furthermore, as shown in FIG. 22, the liquid 2P resin 2 is dropped on the cured transparent protective layer 5-2 in the same manner as in FIG. 21, and the polycarbonate stamper 1-3 having the flat surface is placed on the 2P resin 2 again and rotated together with the substrate 8, thereby spreading the 2P resin 2 over the entire information storage medium. After that, a protective layer 5-1 is formed by irradiating the 2P resin 2 with ultraviolet rays through the polycarbonate stamper 1-3.

As shown in FIG. 1, this embodiment can set the thickness t of the protective layer 5 to, e.g., 0.1 mm. If the thickness t of the protective layer 5 is as sufficiently large as 0.1 mm, however, the viscosity of the liquid 2P resin 2 must be increased in order to use spinner coating. If the protective layer 5 is formed by the highly viscous 2P resin 2 like this, it often becomes difficult to ensure the uniform thickness in the information storage medium. By contrast, when the protective layer 5 is separated into two layers as in this embodiment, the thickness of the protective layer 5-1 or 5-2 need only be 50 μm. This thickness requires the 2P resin 2 to have only low viscosity, and facilitates the manufacture. Also, even if the thickness of the protective layer 5-2 is not uniform in the information storage medium, the variation in thickness of the protective layer 5-2 can be canceled by improving the way the polycarbonate stamper 1-3 is placed when forming the protective layer 5-1. Consequently, the uniformity of the thickness t of the information storage medium can be totally assured with the protective layers 5-2 and 5-1 being stacked. When the protective film 5 is formed by using the polycarbonate stamper 1-3 as shown in FIGS. 21 and 22, the thickness variation of the protective layer 5 can be largely reduced because the flatness of the polycarbonate stamper 1-3 is transferred, compared to the method of forming the protective layer 5 by spinner coating by using the 2P resin 2.

An organic stamper (polyolefin-based stamper) made of a COP (cycloolefin polymer) is known as a stamper that transmits ultraviolet rays. However, the COP is expensive and raises the cost of the information storage medium. By contrast, this embodiment uses inexpensive polycarbonate that passes ultraviolet rays as the stamper used to form the transparent protective layer 5. This largely reduces the manufacturing cost of the stamper 1-3 whose flatness is secured. Frequently replacing the inexpensive polycarbonate stamper 1-3 with a new product makes it possible to prevent the influence of flaws or contamination of the stamper 1-3, and maintain the low cost and high quality of the information storage medium. In the information storage medium thus formed, as shown in FIG. 1, information can be recorded or played back by irradiating the recording layer 3-3 with the laser beam 9 through the transparent protective layers 5-1 and 5-2 and the barrier layer 6-3. It is also possible to record or play back information by irradiating the recording layer 3-4 with the laser beam 9 through the semi-light-transmitting layer 4-3, space layer 7, and barrier layer 6-4.

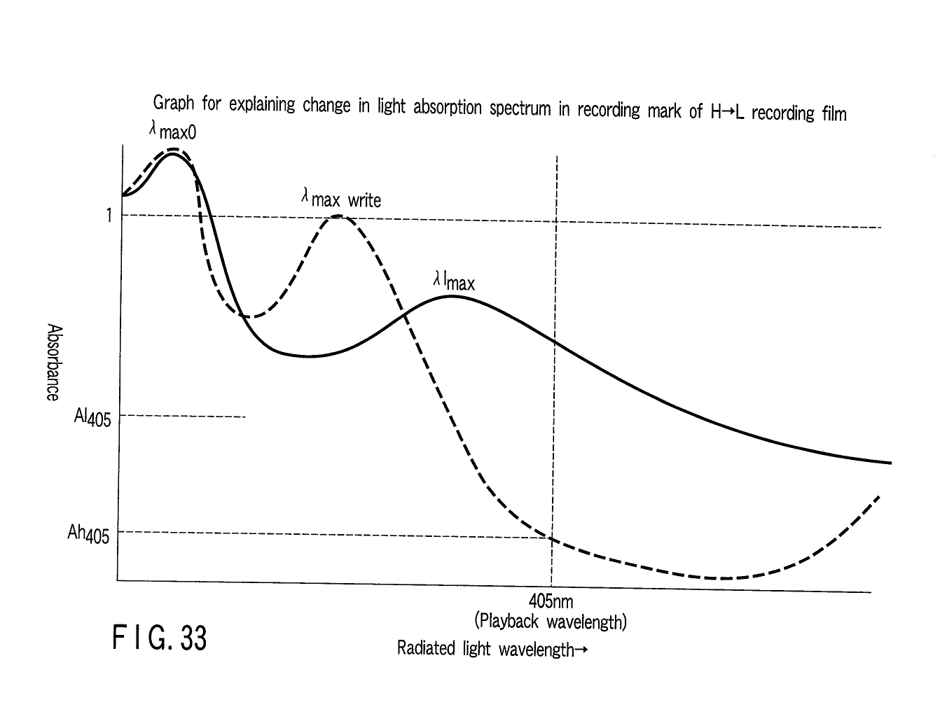

The flatness of the surface 12 of the transparent protective layer 5 and the thickness uniformity of the transparent protective layer 5 will be explained below. When the transparent protective layer 5 is formed by spinner coating by using the 2P resin 2, the thickness t of the transparent protective layer 5 sometimes decreases or increases in the inner or outer peripheral portion of the information storage medium. When playing back or recording data shown in FIG. 33 or FIGS. 41 to 45 described previously, if the thickness t of the transparent protective layer 5 locally increases as shown in FIG. 21, the spherical aberration of an internal optical head of an information recording/playback apparatus deteriorates the recording or playback performance.

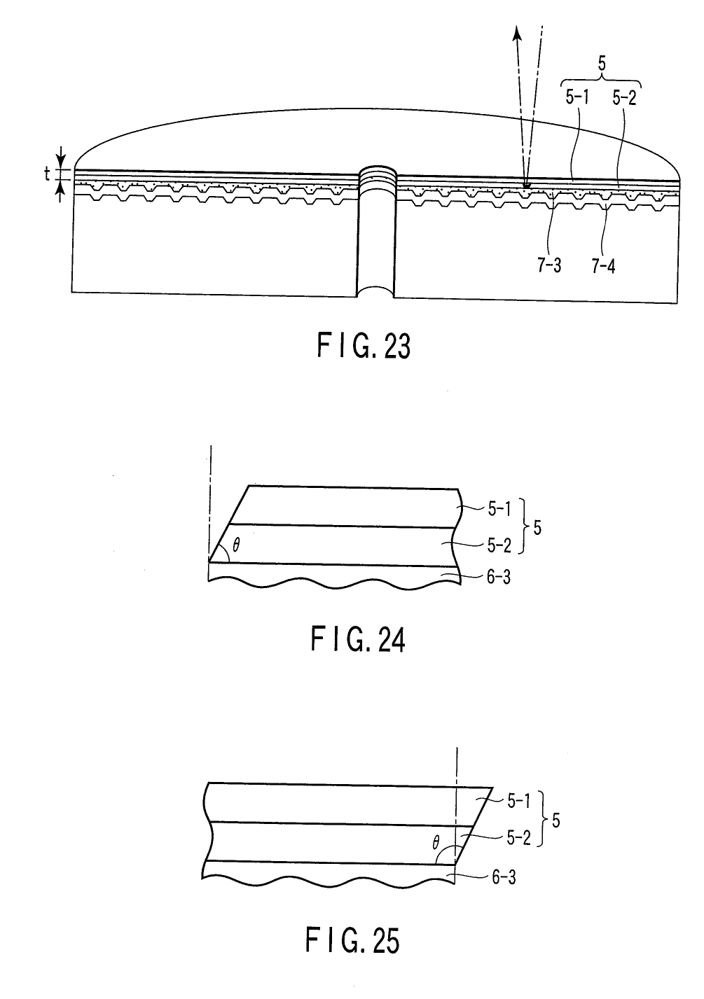

FIG. 23 is a perspective view showing the longitudinal section of a disk-like information storage medium according to an embodiment of the present invention. Since this embodiment transfers the flatness of the polycarbonate stamper 1-3, the thickness t of the transparent protective layer 5 is uniform anywhere in the information storage medium as shown in FIG. 23. This makes it possible to prevent film deterioration and recording/playback signal characteristic deterioration of the recording layer 3-3 caused by the penetration of water, thereby greatly improving the recording/playback performance of the information storage medium. In addition, the manufacturing method disclosed in this embodiment can have great features (to be described later) with respect to the sectional shape in the boundary of the transparent protective layer 5.

FIG. 24 is an enlarged view of the section in the boundary of the transparent protective layer 5 in the inner peripheral portion shown in FIG. 23. FIG. 25 shows the sectional shape in the outer peripheral portion of the transparent protective layer 5 shown in FIG. 23.

When the manufacturing method of this embodiment is used, as shown in FIGS. 21 and 22, the polycarbonate stamper 1-3 and the barrier layer 6-3 or transparent protective layer 5-2 sandwich the 2P resin 2 forming the transparent protective layer 5. This makes an inclination angle θ of the boundary side surfaces in the inner and outer peripheral portions close to 90°. The results of many experiments indicate that when the flatness of the polycarbonate stamper 1-3 is transferred, an angle of 30° (inclusive) to 150° (inclusive) can be secured as the angle θ of the boundary side surfaces shown in FIGS. 24 and 25. If no such stamper is used, however, the angle θ of the section in the transparent protective layer boundary sometimes becomes smaller than 30° or exceed 150°. As described above, by setting the angle of the boundary side surface in the inner or outer periphery of the transparent protective layer 5 within the range of 30° to 150°, it is possible to make the thickness t of the transparent protective layer 5 uniform to almost the inner and outer peripheral portions of the information storage medium, and ensure stable recording or playback performance over the broad range from the inner peripheral portion to the outer peripheral portion.

In addition, when it is necessary to make the thickness t of the transparent protective layer 5 uniform over a broader range from the inner peripheral portion to the outer peripheral portion of the information storage medium, the angle of the boundary side surfaces of the protective layer 5 can be set at 45° (inclusive) to 135° (inclusive). When it is necessary to further extend the effective recording range of the information storage medium and necessary to make the thickness t of the transparent protective layer 5 uniform over a still broader range from the inner peripheral portion to the outer peripheral portion, the side-surface angle θ in the boundaries of the protective layer 5 shown in FIGS. 24 and 25 can be set at 60° (inclusive) to 120° (inclusive).

When the manufacturing method shown in FIGS. 1, 21, and 22 is used, the side-surface angle θ in the boundaries of the protective layer 5 can be readily set within the range of 60° (inclusive) to 120° (inclusive) by appropriately controlling the manufacturing conditions.

Practical materials of the recording layers 3-4 and 3-3 shown in FIG. 1 will be explained below.

As described above, the recording layer 3-4 is required to have high sensitivity, and the recording layer 3-3 is required to have high light transmittance. Therefore, the structure or a mixing material of the material to be used changes in accordance with the required performance. However, both the recording layers 3-4 and 3-3 use azo metal complexes as organic metal complexes. The material and molecular structure common to the recording layers 3-4 and 3-3 will be explained below.

§ Material and Molecular Structure Common to Recording Layers

Explanation of Difference in Playback Signal between Phase-Change Recording Film and Organic Dye Recording Film

2-1) Difference in Recording Principle/Recording Film Structure and Basic Conceptual Difference Concerning Playback Signal Generation

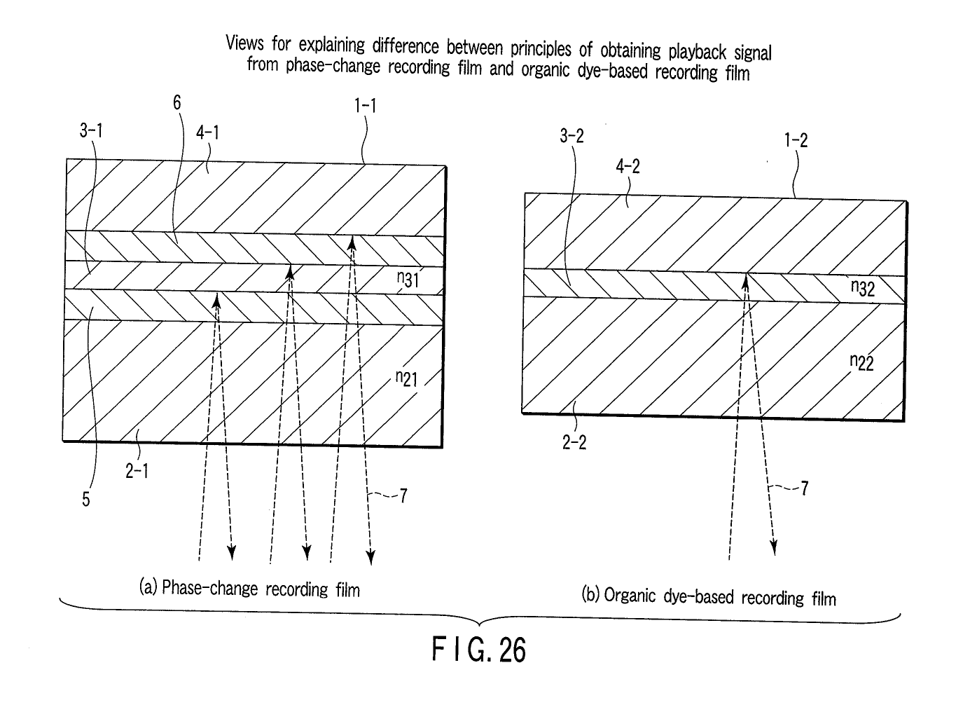

FIG. 26A shows a standard phase-change recording film structure (mainly used in rewritable information storage media). FIG. 26B shows a standard organic dye recording film structure (mainly used in write-once information storage media). In the explanation of this embodiment, the whole recording film structures (including light-reflecting layers 4-1 and 4-2) except for transparent substrates 2-1 and 2-2 shown in FIGS. 26(a) and 26(b) are defined as “recording films”, and distinguished from recording layers 3-1 and 3-2 containing recording materials. In a recording material using a phase change, an optical characteristic change between a recorded region (inside a recording mark) and an unrecorded region (outside a recording mark) is generally small, so an enhancement structure for enhancing the relative change rate of a playback signal is used. In the phase-change recording film structure, therefore, as shown in FIG. 26A, an undercoating intermediate layer 5 is formed between the transparent substrate 2-1 and phase-change recording layer 3-1, and an upper intermediate layer 6 is formed between the light-reflecting layer 4-1 and phase-change recording layer 3-1. This embodiment uses polycarbonate PC or acryl PMMA (polymethyl methacrylate) that is a transparent plastic material as the material of the transparent substrates 2-1 and 2-2. The center wavelength of a laser beam 7 used in this embodiment is 405 nm, and refractive indices n₂₁ and n₂₂ of polycarbonate PC at this wavelength are close to 1.62. A standard refractive index n₃₁ and standard absorption coefficient k₃₁ of GeSbTe (germanium antimony tellurium) most generally used as a phase-change recording material are n₃₁≈1.5 and k₃₁≈2.5 in the crystal region and n₃₁≈2.5 and k₃₁≈1.8 in the amorphous region. That is, the refractive index (in the amorphous region) of the phase-change recording material largely differs from that of the transparent substrate 2-1, so reflection of the laser beam 7 readily occurs in the interface of each layer in the phase-change recording film structure. As described above, (1) the phase-change recording film structure takes the enhancement structure, and (2) the refractive index difference between layers is large. For these reasons, the light reflection amount change (the difference between the light reflection amount from a recording mark and that from an unrecorded region) during playback from the recording mark recorded in the phase-change recording film is obtained as the results of interference between multiple reflected light beams generated in the interfaces between the undercoating intermediate layer 5, recording layer 3-1, upper intermediate layer 6, and light-reflecting layer 4-1. Referring to FIG. 26A, the laser beam 7 is reflected by only the interface between the undercoating intermediate layer 5 and recording layer 3-1, the interface between the recording layer 3-1 and upper intermediate layer 6, and the interface between the upper intermediate layer 6 and light-reflecting layer 4-1. In reality, however, the light reflection amount change is obtained by the results of a plurality of times of interference between multiple reflected light beams.

By contrast, the organic dye recording film structure takes a very simple stacked structure including only the organic dye recording layer 3-2 and light-reflecting layer 4-2. An information storage medium (optical disk) using this organic dye recording film is called a write-once information storage medium, and capable of recording information once. However, it is impossible to erase or rewrite once recorded information unlike in a rewritable information storage medium using the phase-change recording film. The refractive index at 405 nm of a general organic dye recording material is n₃₂≈1.4 (the refractive index range at 405 nm of various organic dye recording materials is also n₃₂≈1.4 to 1.9), and the absorption coefficient at 405 nm of a general organic dye recording material is k₃₂≈0.2 (the absorption coefficient range at 405 nm of various organic dye recording materials is also k₃₂≈0.1 to 0.2). Since the refractive index difference between the organic dye recording material and transparent substrate 2-2 is small, almost no light reflection occurs in the interface between the recording layer 3-2 and transparent substrate 2-2. Accordingly, the main cause of the optical playback principle (the reason that produces the reflected light amount change) from the organic dye recording film is “the light amount loss (including interference) midway along the optical path with respect to the laser beam 7 returning after being reflected by the light-reflecting layer 4-2”, rather than “multiple interference” in the phase-change recording film as described above. Practical reasons that cause the light amount loss midway along the optical path are “an interference phenomenon caused by a phase difference partially produced in the laser beam 7” and “a light absorption phenomenon in the recording layer 3-2”. The light reflectance of the organic dye recording film in an unrecorded region on a mirror surface having neither pre-grooves nor pre-pits is simply obtained by subtracting the light absorption amount when the laser beam 7 passes through the recording layer 3-2 from the light reflectance of the light-reflecting layer 4-2 to the laser beam 7. This is a big difference from the phase-change recording film whose light reflectance is obtained by calculating “multiple interference” as described previously.

First, the recording principle interpreted by the current DVD-R disk will be explained below as the prior art. When the laser beam 7 irradiates the recording film of the current DVD-R disk, the recording layer 3-2 locally absorbs the energy of the laser beam 7 and generates high heat. If the heat exceeds a specific temperature, the transparent substrate 2-2 locally deforms. The mechanism that induces the deformation of the transparent substrate 2-2 changes from one DVD-R disk manufacture to another. However, possible causes are:

(1) Local plastic deformation of the transparent substrate 2-2 caused by the vaporization energy of the recording layer 3-2.

(2) Local plastic deformation of the transparent substrate 2-2 caused by the heat conducted from the recording layer 3-2 to the transparent substrate 2-2.

When the transparent substrate 2-2 locally plastically deforms, the optical distance of the laser beam 7 that is reflected by the light-reflecting layer 4-2 through the transparent substrate 2-2 and returns through the transparent substrate 2-2 again changes. A phase difference is produced between the laser beam 7 which returns from a recording mark through the locally plastically deformed portion of the transparent substrate 2-2, and the laser beam 7 which returns from the peripheral potion of the recording mark through an undeformed portion of the transparent substrate 2-2. This changes the light amount of the reflected light by interference between the two laser beams. Especially when mechanism (1) occurs, a practical change in refractive index n₃₂ caused by cavitation of a recording mark in the recording layer 3-2 by vaporization (evaporation), or a change in refractive index n₃₂ caused by thermal decomposition of the organic dye recording material in a recording mark also contributes to the production of the phase difference.

In the current DVD-R disk, the recording layer 3-2 must heat up to a high temperature (the vaporization temperature of the recording layer 3-2 in mechanism (1), or the internal temperature of the recording layer 3-2 required to plastically deform the transparent substrate 2-2 in mechanism (2)) until the transparent substrate 2-2 locally deforms, or a high temperature is necessary to thermally decompose or vaporize (evaporate) a portion of the recording layer 3-2. Therefore, the laser beam 7 must have high power to form a recording mark.

To form a recording mark, the recording layer 3-2 needs to be able to absorb the energy of the laser beam 7 in the first stage. The light absorption spectrum in the recording layer 3-2 has large influence on the recording sensitivity of the organic dye recording film. The light absorption principle in the organic dye recording material forming the recording layer 3-2 will be explained below by using (A3) of this embodiment.

Formula 1 indicates a practical formula of a practical content “(A3) azo metal complex+Cu” of a constituent element of the information storage medium. A circular peripheral region centering around a central metal M of the azo metal complex indicated by Formula 1 is a color development region 8. When the laser beam 7 passes through the color development region 8, localized electrons in the color development region 8 resonate with the field change of the laser beam 7, and absorb the energy of the laser beam 7. A value obtained by converting the frequency of the field change, by which the localized electrons resonate most and well absorb the energy, into the wavelength of the laser beam 7 is called a maximum absorption wavelength, and represented by λₘₐₓ. As the length of the color development region 8 (resonance range) as indicated by Formula 1 increases, the maximum absorption wavelength λₘₐₓ shifts to the long wavelength side. Also, when atoms of the central metal M are changed in Formula 1, the localization range of the localized electrons around the central metal M changes (the degree to which the central metal M draws the localized electrons toward the center changes), and the value of the maximum absorption wavelength λₘₐₓ changes.

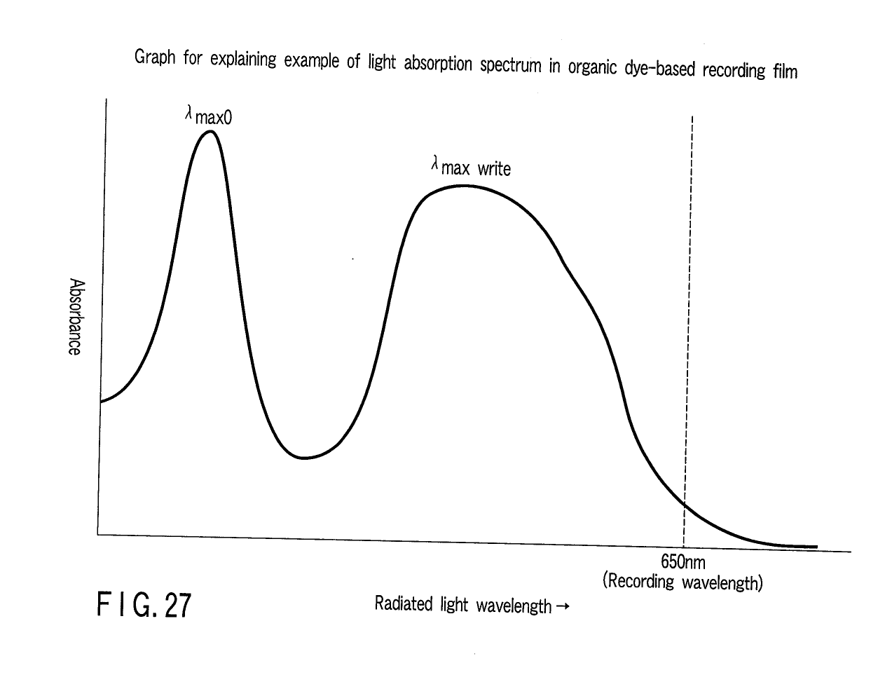

When the temperature is absolute zero, the purity is high, and there is only one color development region 8, the light absorption spectrum of the organic dye recording material presumably draws a narrow line spectrum near the maximum absorption wavelength λₘₐₓ. However, the light absorption characteristic of a general organic dye recording material containing an impurity at room temperature and including a plurality of light absorption regions exhibits a wide light absorption characteristic with respect to the wavelength of light centering around the maximum absorption wavelength λₘₐₓ. FIG. 27 shows an example of the light absorption spectrum of an organic dye recording material used in the current DVD-R disk. Referring to FIG. 27, the abscissa indicates the wavelength of light emitted to an organic dye recording film formed by coating of the organic dye recording material, and the ordinate indicates the absorbance when the organic dye recording film is irradiated with light having the wavelength. The absorbance is a value obtained by allowing a laser beam having incident intensity Io to enter from the transparent substrate 2-2 into a completed write-once information storage medium (or a medium before the light-reflecting layer 4-2 is formed on the structure in which the recording layer 3-2 alone is formed on the transparent substrate 2-2 (FIG. 26B)), and measuring optical intensity Ir of the reflected laser beam (optical intensity It of the laser beam transmitted through the recording layer 3-2). Absorbance Ar (At) is represented by Ar≡—log₁₀(Ir/Io) (A-1) At≡—log₁₀(It/Io) (A-2)

In the following explanation, the absorbance is the reflection type absorbance Ar represented by expression (A-1) unless otherwise specified. In this embodiment, however, it is also possible to regard the absorbance as the transmission type absorbance At represented by expression (A-2). In the embodiment shown in FIG. 27, a plurality of light absorption regions including the color development region 8 exist, so there are a plurality of positions where the absorbance is a maximum. In this case, a plurality of maximum absorption wavelengths λₘₐₓ at which the absorbance takes a maximum value exist. The wavelength of a recording laser beam of the current DVD-R disk is 650 nm. When a plurality of maximum absorption wavelengths λₘₐₓ exist in this embodiment, the value of a maximum absorption wavelength λₘₐₓ closest to the wavelength of the recording laser beam is important. As far as the explanation of this embodiment is concerned, therefore, the value of the maximum absorption wavelength λₘₐₓ closest to the wavelength of the recording laser beam is defined as “λ”, and distinguished from another λₘₐₓ(λₘₐₓ0).

2-2) Difference between Shapes of Light-Reflecting Layers in Pre-Pit/Pre-Groove Region

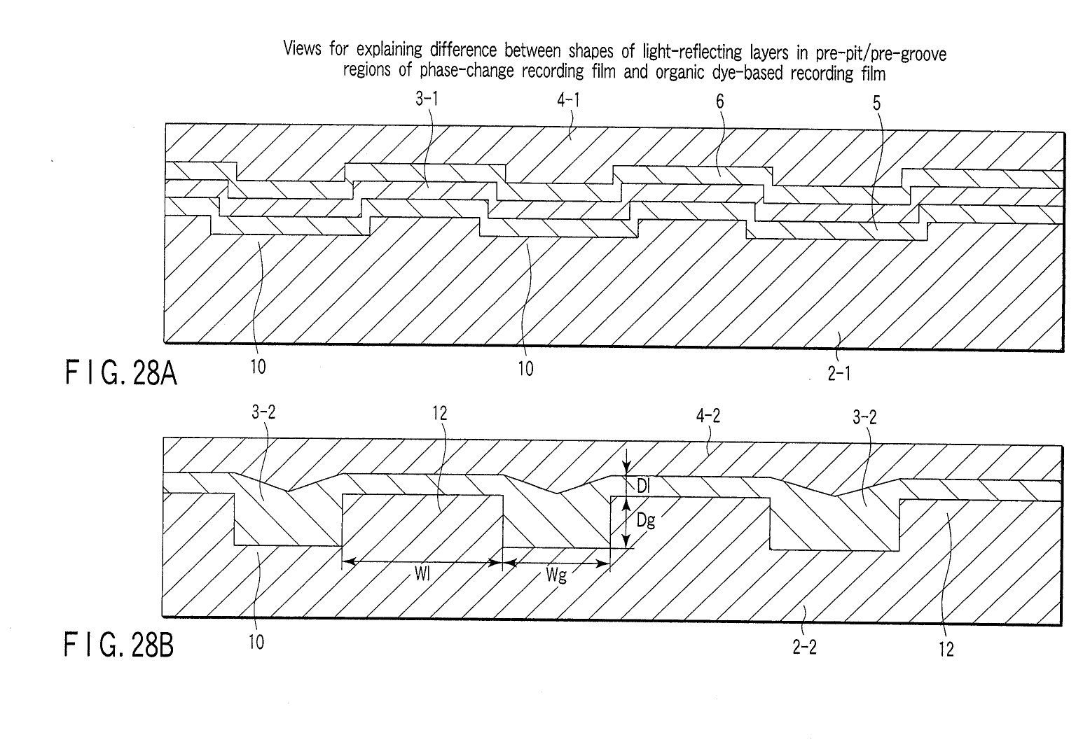

FIGS. 28A and 28B compare the shapes of recording films in pre-pit or pre-groove regions 10.

FIG. 28A shows the shape of a phase-change recording film. The undercoating intermediate layer 5, recording layer 3-1, upper intermediate layer 6, and light-reflecting layer 4-1 are all formed by using sputtering in a vacuum, vacuum evaporation, or ion plating.

Consequently, all the layers relatively faithfully reproduce the three-dimensional shape of the transparent substrate 2-1. For example, when the sectional shape of the transparent substrate 2-1 in the pre-pit or pre-groove region 10 is a rectangle or trapezoid, the sectional shapes of the recording layer 3-1 and light-reflecting layer 4-1 are also almost rectangles or trapezoids.

FIG. 28B shows a general recording film sectional shape of the current DVD-R disk as the prior art of a recording film using an organic dye recording film. In this case, the recording film 3-2 is formed by a method called spin coating (or spinner coating) entirely different from that shown in FIG. 28A. Spin coating is a method that forms the recording layer 3-2 by coating the transparent substrate 2-2 with a solution prepared by dissolving the organic dye recording material for forming the recording layer 3-2 in an organic solvent, spreading the coating agent toward the outer periphery of the transparent substrate 2-2 by the centrifugal force by rotating the transparent substrate 2-2 at high speed, and vaporizing the organic solvent. Since this method uses the organic solvent coating step, the surface of the recording layer 3-2 (the interface with the light-reflecting layer 4-2) readily flattens. This makes the sectional shape of the interface between the light-reflecting layer 4-2 and recording layer 3-2 different from the shape of the surface of the transparent substrate 2-2 (the interface between the transparent substrate 2-2 and recording layer 3-2). For example, in a pre-groove region or pre-pit region in which the sectional shape of the surface of the transparent substrate 2-2 (the interface between the transparent substrate 2-2 and recoding layer 3-2) is a rectangle or trapezoid, the sectional shape of the interface between the light-reflecting layer 4-2 and recording layer 3-2 is an almost V-shaped groove or almost conical side-surface shape, respectively. In addition, the organic solvent readily stays in recesses during spin coating, a thickness Dg (as shown in FIG. 28B, the distance from the bottom surface of the pre-pit region or pre-groove region 10 to the lowest position of the interface with the light-reflecting layer 4-2) of the recording layer 3-2 in the pre-pit region or pre-groove region 10 is much larger than a thickness Dl in a land region 12 (Dg>Dl). Consequently, the difference between the projections and recesses in the interface between the light-reflecting layer 4-2 and recording layer 3-2 is much smaller than that in the interface between the transparent substrate 2-2 and recording layer 3-2.

As described above, the three-dimensional shape in the interface between the light-reflecting layer 4-2 and recording layer 3-2 becomes dull, and the difference between the projections and recesses largely decreases. Therefore, when the three-dimensional shapes and dimensions of the surfaces (pre-pit regions or pre-groove regions 10) of the transparent substrates 2 are the same, the diffraction intensity of reflected light from the organic dye recording film deteriorates much more than that of reflected light from the phase-change recording film when the films are irradiated with a laser beam, owing to the difference between the recording film formation methods. Consequently, if the three-dimensional shapes and dimensions of the surfaces (pre-pit regions or pre-groove regions 10) of the transparent substrates 2 are the same, the conventional organic dye recording film has the following features compared to the phase-change recording film:

(1) The modulation factor of an optical playback signal from the pre-pit region is small, so the reliability of signal playback from the pre-pit region is low.

(2) It is difficult to obtain a sufficiently large track deviation detection signal from the pre-groove region by the push-pull method.

(3) A sufficiently large wobble detection signal is difficult to obtain if the pre-groove region wobbles (zigzags).

Furthermore, in the DVD-R disk, specific information such as address information is recorded by a fine three-dimensional shape (pit) in the land region 12. Therefore, a width Wl of the land region 12 is larger than a width Wg of the pre-pit region or pre-groove region 10 (Wg<Wl).

Explanation of Features of Organic Dye Recording Film of this Embodiment

3-1) Problem of Increasing Density of Write-Once Recording Film (DVD-R) Using Conventional Organic Dye Material

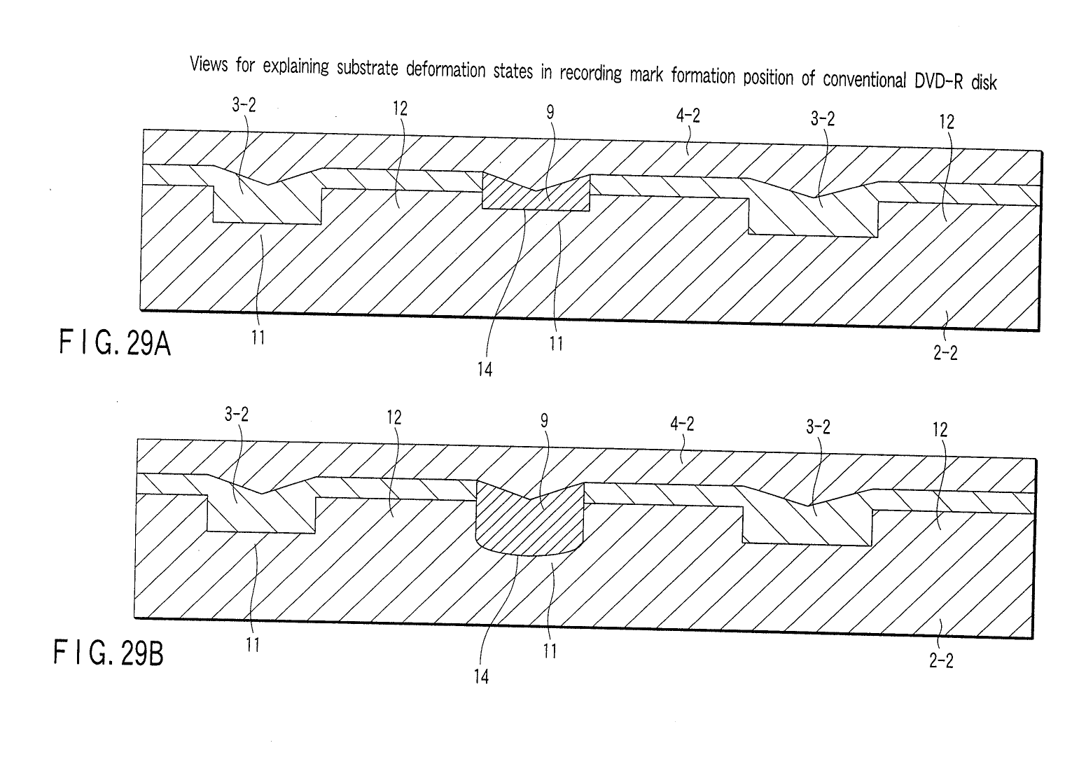

As already explained in “2-1) Difference in Recording Principle/Recording Film Structure and Basic Conceptual Difference Concerning Playback Signal Generation”, the general recording principle of the current DVD-R and CD-R as write-once information storage media using the conventional organic dye materials involves “local plastic deformation of the transparent substrate 2-2” or “local thermal decomposition or vaporization in the recording layer 3-2”. FIGS. 29A and 29B illustrate practical plastic deformation states of the transparent substrate 2-2 at the position of the recording mark 9 in the write-once information storage medium using the conventional organic dye material. There are two types of typical plastic deformation states. That is, as shown in FIG. 29A, the depth of a bottom surface 14 of the pre-groove region at the position of the recording mark 9 (i.e., the step amount between the bottom surface 14 and adjacent land regions 12) differs from that of the bottom surface of the pre-groove region 11 in an unrecorded region (in the example shown in FIG. 29A, the bottom surface 14 of the pre-groove region at the position of the recording mark 9 is shallower than the unrecorded region). Also, as shown in FIG. 29B, the bottom surface 14 of the pre-groove region at the position of the recording mark 9 strains and slightly curves (i.e., the flatness of the bottom surface 14 breaks: in the example shown in FIG. 29B, the bottom surface 14 of the pre-groove region at the position of the recording mark 9 slightly curves downward). In either case, the plastic deformation range of the transparent substrate 2-2 at the position of the recording mark 9 is broad. In the current DVD-R as the prior art, the track pitch is 0.74 μm, and the channel bit length is 0.133 μm. With these large values, relatively stable recording and playback can be performed even when the plastic deformation range of the transparent substrate 2-2 at the position of the recording mark 9 is wide.

If the track pitch is smaller than 0.74 μm described above, however, the wide plastic deformation range of the transparent substrate 2-2 at the position of the recording mark 9 has adverse effect on adjacent tracks. This causes a phenomenon “cross write” in which the recording mark 9 extends to an adjacent track, or a phenomenon “cross erase” in which multiple write practically erases the existing recording mark 9 on an adjacent track (makes the recording mark 9 impossible to play back). Also, if the channel bit length is smaller than 0.133 μm in the direction (circumferential direction) along tracks, inter-symbol interference appears. This largely increases the error rate of playback, and deteriorates the reliability of playback.

3-2) Explanation of Basic Features Common to Organic Dye Recording Films of this Embodiment

3-2-A] Range Requiring Application of Technique of this Embodiment

As shown in FIGS. 29A and 29B, the conventional write-once information storage medium (CD-R or DVD-R) involves plastic deformation of the transparent substrate 2-2 or local thermal decomposition or vaporization in the recording layer 3-2. The present inventors technically examined a decrease in track pitch or channel bit length at which these adverse effects appeared and the reasons for that. The results will be explained below. The range within which the bad influences start appearing when the conventional recording principle is used indicates the range within which the novel recording principle disclosed in this embodiment achieves its effects (i.e., the range suited to increasing the density).

(1) Conditions of Thickness Dg of Recording Layer 3-2

When performing thermal analysis in order to theoretically find the lower limit of an allowable channel bit length or the lower limit of an allowable track pitch, a practically possible range of the thickness Dg of the recording layer 3-2 is important. In the conventional write-once information storage medium (CD-R or DVD-R) accompanied by plastic deformation of the transparent substrate 2-2 as shown in FIGS. 29A and 29B, “the interference effect caused by the difference between the optical distances in the recording mark 9 and in an unrecorded region of the recording layer 3-2” is the largest cause of the change in light reflection amount when an information playback light spot exists in the recording mark 9 and exists in the unrecorded region. Also, the difference between the optical distances is mainly caused by “the change in physical thickness Dg of the recording layer 3-2 caused by plastic deformation of the transparent substrate 2-2 (i.e., the change in physical distance from the interface between the transparent substrate 2-2 and recording layer 3-2 to the interface between the recording layer 3-2 and light-reflecting layer 4-2)”, and “the change in refractive index n₃₂ of the recording layer 3-2 in the recording mark 9”. Therefore, to obtain a sufficient playback signal (light reflection amount change) between the recording mark 9 and an unrecorded region, the thickness Dg of the recording layer 3-2 in the unrecorded region must have a certain large value compared to λ/n₃₂ where λ is the wavelength of a laser beam in a vacuum. If not so, no optical distance difference (phase difference) appears between the recording mark 9 and an unrecorded region, and the light interference effect decreases. A minimum practical condition is Dg ≧ λ/8n₃₂ (1)

and desirably, Dg ≧ λ/4n₃₂ (2)

At the present point of examination, the present inventors temporarily assume that λ=about 405 nm. The value of the refractive index n₃₂ of the organic dye recording material at 405 nm is generally 1.3 to 2.0. Accordingly, as the value of the thickness Dg of the recording layer 3-2,
Dg≧25 nm (3)
is an essential condition when substituting n₃₂=2.0 into expression (1). Note that this examination is made on conditions when the organic dye recording layer of the conventional write-once information storage medium (CD-R or DVD-R) accompanied by plastic deformation of the transparent substrate 2-2 is made to correspond to light having a wavelength of 405 nm. In this embodiment as will be described later, the transparent substrate 2-2 does not plastically deform, and the change in absorption coefficient k₃₂ will be explained as the main cause of the recording principle. However, it is necessary to detect a track deviation from the recording mark 9 by using the DPD (Differential Phase Detection) method. In practice, therefore, the refractive index n₃₂ changes in the recording mark 9. Accordingly, the condition of expression (3) is also the condition that this embodiment unaccompanied by plastic deformation of the transparent substrate 2-2 must satisfy.

The range of the thickness Dg of the recording layer 3-2 can also be designated from another viewpoint. In the phase-change recording film shown in FIG. 28A, letting n₂₁ be the refractive index of the transparent substrate, the step amount between the pre-pit region and land region when the push-pull method maximizes the track deviation detection signal is λ/(8n₂₁). In the organic dye recording film shown in FIG. 28B, however, the shape becomes dull and the step amount decreases in the interface between the recording layer 3-2 and light-reflecting layer 4-2 as described above. Therefore, the step amount between the pre-pit region and land region on the transparent substrate 2-2 must be larger than λ/(8n₂₂). When polycarbonate, for example, is used as the material of the transparent substrate 2-2, the refractive index at 405 nm is n₂₂≈1.62, so it is necessary to make the step amount between the pre-pit region and land region larger than 31 nm. When spin coating is used, the thickness Dl of the recording layer 3-2 in the land region 12 may be zero if the thickness Dg of the recording layer 3-2 in the pre-groove region is not larger than the step amount between the pre-pit region and land region on the transparent substrate 2-2. The above examination results show that it is also necessary to satisfy the condition indicated by
Dg≧31 nm (4)

The condition of expression (4) is also the condition that this embodiment unaccompanied by plastic deformation of the transparent substrate 2-2 must satisfy. Expressions (3) and (4) indicate the conditions of the lower limit. However, a value of Dg≈60 nm obtained by substituting n₃₂=1.8 into the equal sign part of expression (2) was used as the thickness Dg of the recording layer 3-2 used in thermal analysis.

The present inventors assumed polycarbonate normally used as the material of the transparent substrate 2-2, and set 150° C. that is the glass transition temperature of polycarbonate as the estimated value of the thermal deformation temperature of the transparent substrate 2-2. The present inventors also assumed k₃₂=0.1 to 0.2 as the value of the absorption coefficient of the organic dye recording film 3-2 at 405 nm in the examination using thermal analysis. Furthermore, the present inventors examined the case that the NA value of a condenser objective lens was NA=0.60 and the incident light intensity distributions when the incident light passed through the objective lens were H format ((D1): NA=0.65) and B format ((D2): NA=0.85) as the prior conditions of the conventional DVD-R format.

(2) Conditions of Lower Limit of Channel Bit Length

The present inventors checked the change in length along the track direction of a region where the thermal deformation temperature of the transparent substrate 2-2 in contact with the recording layer 3-2 was reached when changing the recording power, and examining the lower limit of the allowable channel bit length by taking account of the window margin of playback as well. Consequently, when the channel bit length was smaller than 105 nm, the length in the track direction of the region where the thermal deformation temperature of the transparent substrate 2-2 was reached changed in accordance with a slight change in recording power, so no sufficient window margin was obtained. The examination by thermal analysis indicates similar tendencies when the NA value is 0.60, 0.65, and 0.85. This is so because although the light spot size changes when the NA value is changed, the heat spreading range is wide (the slope of the temperature distribution of the transparent substrate 2-2 in contact with the recording layer 3-2 is relatively gentle). The above thermal analysis examines the temperature distribution of the transparent substrate 2-2 in contact with the recording layer 3-2. Accordingly, no influence of the thickness Dg of the recording layer 3-2 appears.

In addition, when the transparent substrate 2-2 changes its shape as shown in FIGS. 29A and 29B, the boundary position of the substrate deformation region is blurred (vague), and this further decreases the window margin. Observation of the sectional shape of the formation region of the recording mark 9 with an electron microscope shows that the amount of blur of the boundary position of the substrate deformation region presumably increases as the value of the thickness Dg increases. When this blur of the boundary position of the substrate deformation region is taken into account in addition to the influence of the length of the thermal deformation region that changes in accordance with the change in recording power, the lower limit of the channel bit length allowed to secure a sufficient window margin is probably about twice the thickness Dg of the recording layer 3-2, and desirably larger than 120 nm.

The examination made by using thermal analysis on the case that thermal deformation of the transparent substrate 2-2 occurs is mainly explained above. As another recording principle (the formation mechanism of the recording mark 9) of the conventional write-once information storage medium (CD-R or DVD-R), the case that plastic deformation of the transparent substrate 2-2 is very small and thermal decomposition or vaporization (evaporation) of the organic dye recording material in the recording layer 3-2 is dominant also exists. This case will be additionally explained below. The vaporization (evaporation) temperature of an organic dye recording material changes from one organic dye material to another, but it is generally 220° C. to 370° C., and the thermal decomposition temperature is lower than that. The above examination is based on the assumption that the temperature reached when substrate deformation occurs is a glass transition temperature of 150° C. of polycarbonate resin. However, the temperature difference between 150° C. and 220° C. is small, so the temperature has exceeded 220° C. inside the recording layer 3-2 when the transparent substrate 2-2 reaches 150° C. Although there are some exceptions depending on organic dye recording materials, therefore, almost the same results as the examination results described above are obtained even when plastic deformation of the transparent substrate 2-2 is very small and thermal decomposition or vaporization (evaporation) of the organic dye recording material in the recording layer 3-2 is dominant.

The results of examination on the channel bit length described above can be summarized as follows. In the conventional write-once information storage medium (CD-R or DVD-R) accompanied by plastic deformation of the transparent substrate 2-2, the window margin decreases when the channel bit length becomes smaller than 120 nm, and stable playback probably becomes difficult to perform if the channel bit length is smaller than 105 nm. That is, the effect of using the novel recording principle disclosed in this embodiment is achieved when the channel bit length is smaller than 120 nm (105 nm).

(3) Conditions of Lower Limit of Track Pitch

When the recording layer 3-2 is exposed by the recording power, the interior of the recording layer 3-2 absorbs energy and heats up. In the conventional write-once information storage medium (CD-R or DVD-R), the interior of the recording layer 3-2 must absorb energy until the transparent substrate 2-2 reaches the thermal deformation temperature. The temperature at which a structural change of the organic dye recording material occurs in the recording layer 3-2 and the value of the refractive index n₃₂ or absorption coefficient k₃₂ starts changing is much lower than the temperature at which the transparent substrate 2-2 starts thermal deformation. Accordingly, the value of the refractive index n₃₂ or absorption coefficient k₃₂ changes in a relatively wide region in the recording layer 3-2 around the recording mark 9 that thermally deforms on the side of the transparent substrate 2-2. This is presumably the cause of “cross write” or “cross erase” to adjacent tracks. It is possible to set the lower limit of the track pitch at which neither “cross write” nor “cross erase” occurs in the wide region where the temperature at which the refractive index n₃₂ or absorption coefficient k₃₂ changes in the recording layer 3-2 is reached when the transparent substrate 2-2 exceeds the thermal deformation temperature. From the above perspective, “cross write” or “cross erase” perhaps occurs in a portion where the track pitch is 500 nm or less. In addition, when the influence of the warpage or inclination of the information storage medium or the change in recording power (the recording power margin) is taken into consideration, it is difficult to set the track pitch to 600 nm or less in the conventional write-once information storage medium (CD-R or DVD-R) in which the interior of the recording layer 3-2 absorbs energy until the transparent substrate 2-2 reaches the thermal deformation temperature. As described previously, even when the NA value is changed to 0.60, 0.65, and 0.85, almost similar tendencies are obtained because when the transparent substrate 2-2 reaches the thermal deformation temperature in the central portion, the slope of the temperature distribution in the recording layer 3-2 in the peripheral portion is relatively gentle, so the heat spreading range is broad. Even in the case that plastic deformation of the transparent substrate 2-2 is very small and thermal decomposition or vaporization (evaporation) of the organic dye recording material in the recording layer 3-2 is dominant, as the other recording principle (the formation mechanism of the recording mark 9) in the conventional write-once information recording medium (CD-R or DVD-R), the values of the track pitch at which “cross write” or “cross erase” begins are almost similar as already explained in “(2) Conditions of Lower Limit of Channel Bit Length”. For the above reasons, the effect of using the novel recording principle disclosed in this embodiment is achieved when the track pitch is 600 nm (500 nm) or less.

3-2-B] Basic Features Common to Organic Dye Recording Materials of this Embodiment

As described above, in the case that plastic deformation of the transparent substrate 2-2 occurs or thermal decomposition or vaporization (evaporation) locally occurs in the recording layer 3-2 as the recording principle (the formation mechanism of the recording mark 9) in the conventional write-once information storage medium (CD-R or DVD-R), the interior of the recording layer 3-2 or the surface of the transparent substrate 2-2 reaches a high temperature when the recording mark 9 is formed. This makes it impossible to decrease the channel bit length or track pitch. To solve this problem, this embodiment is characterized by “inventing an organic dye material” that uses

“a local optical characteristic change in the recording layer 3-2 occurring at a relatively low temperature as the recording principle” without causing any substrate deformation or vaporization (evaporation) in the recording layer 3-2, and by “setting the environment (the recording film structure or shape)” in which this recording principle readily occurs. Practical features of this embodiment have the following contents.

α] As a method of changing optical characteristics in the recording layer 3-2, design an organic dye material that causes one of:
Change in color development characteristics
   A change in light absorption sectional area or a change in molar absorption coefficient caused by a change in properties of the color development region 8 (Formula 1)

The effective light absorption sectional area changes because the color development region 8 is partially broken or changes its size. This changes the amplitude (absorbance) at the position of λₘₐₓ write in the recording mark 9 while the light absorption spectrum (FIG. 27) profile (characteristic) itself is saved;
Change in electron structure (electron orbit) with respect to electrons contributing to color development phenomenon
   A change in light absorption spectrum (FIG. 27) based on decoloration by local disconnection of the electron orbit (local dissociation of a molecular bond) or a change in dimension or structure of the color development region 8 (Formula 1);
Change in orientation or alignment in molecule (or between molecules)
   For example, an optical characteristic change based on an alignment change in the azo metal complex shown in Formula 1; and
Change in molecular structure inside molecule
   For example, dissociation of a bond between the anion part and cation part, thermal decomposition of one of the anion part and cation part, and production of tar (a change into black coal tar) by which the molecular structure itself is destroyed and carbon atoms precipitate. This makes optical playback possible by changing the refractive index n₃₂ or absorption coefficient k₃₂ in the recording mark 9 with respect to an unrecorded region.

β] Set the recording film structure or shape that readily causes the changes in optical characteristics described in [α].
Practical contents of this technique will be described in detail later from “3-2-C] Ideal Recording Film Structure That Readily Causes Recording Principle Disclosed in This Embodiment”.

γ] Decrease the recording power to form a recording mark while the interior of the recording layer and the surface of the transparent substrate are at relatively low temperatures.
The changes in optical characteristics described in [α] occur at a temperature lower than the deformation temperature of the transparent substrate 2-2 and the vaporization (evaporation) temperature in the recording layer 3-2. Therefore, the recording exposure amount (recording power) is decreased to prevent the temperature from exceeding the deformation temperature on the surface of the transparent substrate 2-2 and the vaporization (evaporation) temperature in the recording layer 3-2. The contents will be explained in detail later in “3-3) Recording Characteristics Common to Organic Dye Recording Films of This Embodiment”. It is also possible to determine by checking the optical power value during recording whether a change in optical characteristics described in [α] has occurred.

δ] Prevent easy occurrence of structural decomposition with respect to ultraviolet radiation or playback light radiation by stabilizing the electron structure in the color development region.
The internal temperature of the recording layer 3-2 rises when the recording layer 3-2 is irradiated with ultraviolet rays or with playback light during playback. It is necessary to prevent characteristic deterioration by this temperature rise, and at the same time record information at a temperature lower than the substrate deformation temperature and the vaporization (evaporation) temperature in the recording layer 3-2. That is, the performances apparently conflicting each other in respect of the temperature characteristics are required. This embodiment ensures the apparently conflicting performances by “stabilizing the electron structure in the color development region”. Practical contents of this technique will be explained in “Chapter 4 Explanation of Practical Embodiments of Organic Dye Recording Film of This Embodiment”.

ε] Improve the reliability of playback information in preparation for the case that playback signal deterioration occurs due to ultraviolet radiation or playback light radiation.
This embodiment makes technical improvements for “stabilizing the electron structure in the color development region”. However, compared to the local cavity formed in the recording layer 3-2 by plastic deformation of the surface of the transparent substrate 2-2 or vaporization (evaporation), the reliability of the recording mark 9 formed by the recording principle disclosed in this embodiment deteriorates in principle. As a countermeasure, this embodiment achieves the effect of increasing the density and ensuring the reliability of recorded information at the same time by a combination with powerful error correction capability (a novel ECC block structure) as will be described later in “Chapter 7 Explanation of H Format” and “§1. Explanation of B Format”. In addition, this embodiment adopts the PRML (Partial Response Maximum Likelihood) method as a playback method as will be explained in “4-2) Explanation of Playback Circuit of This Embodiment”, and combines the method with the error correction technique for ML demodulation, thereby further increasing the density and securing the reliability of recorded information at the same time.

It is already explained that [α] to [γ] of the practical features of this embodiment are the contents of the novel technical improvements devised by this embodiment to “decrease the track pitch” and “decrease the channel bit length”. Also, “decreasing the channel bit length” leads to “decreasing the minimum recording mark length”. The meanings (objects) of this embodiment with respect to [δ] and [ε] will be explained in detail below. In this embodiment, the velocity (linear velocity) of a light spot passing through the recording layer 3-2 when performing playback by H format is set at 6.61 m/s, and the linear velocity for B format is set within the range of 5.0 to 10.2 m/s. In either case, the linear velocity for playback in this embodiment is 5 m/s or more. The start position of a data lead-in region DTLDI for H format is a diameter of 47.6 mm. Even when B format is taken into consideration, user data is recorded in a position where the diameter is 45 mm or more. Since the circumference at a diameter of 45 mm is 0.141 m, the rotational speed of the information storage medium is 35.4 r/s when playing back this position at a linear velocity of 5 m/s. Recording video information such as a TV program is one method of using the write-once information storage medium of this embodiment. For example, when a user presses a “pause button” when playing back video he or she recorded, the playback light spot stays on a track in this pause position. When the playback light spot thus stays on the track in the pause position, playback can be started from the pause position immediately after the user presses “a playback start button”. For example, if a visitor comes immediately after the user presses “the pause button” and stands up for some reason, the pause button may be kept pressed for one hour while the user keeps company with the visitor. During this one hour, the write-once information storage medium rotates

35.4×60×60≈130,000 times and the light spot keeps tracing the same track (repetitively plays back the information 130,000 times). If the recording layer 3-2 deteriorates by the repetitive playback and the video information becomes impossible to play back during that time, the user who has come back in an hour may get into a rage because he or she cannot watch a partial image, and may take legal proceedings in the worst case. Accordingly, as the condition that recorded video information does not break even if the disk is left to stand (the same track is continuously played back) for about an hour, it is necessary to guarantee that no playback deterioration occurs even if playback is repetitively performed at least 100,000 times. Almost no general users repeat one-hour pause (repetitive playback) 10 times in the same position. Therefore, when desirably 1,000,000-time repetitive playback is guaranteed for the write-once information storage medium of this embodiment, no problem arises for any general users, so it is probably satisfactory to set the upper limit of the number of times of repetitive playback by which the recording layer 3-2 does not deteriorate to about 1,000,000. If the upper limit of the number of times of repetitive playback is set to a value largely exceeding 1,000,000, the inconvenience that “the recording sensitivity lowers” or “the medium cost rises” occurs.

When guaranteeing the upper limit of the number of times of repetitive playback described above, the playback power value is an important factor. This embodiment defines the recording power within the range set by expressions (8) to (13) to be described later. A semiconductor laser is said to have the characteristic that continuous light emission is unstable at a value that is 1/80 or less the maximum operation power. A semiconductor laser barely starts emitting light at the 1/80 power of the maximum operation power, so mode hop readily occurs. This is so because at this light emitting power, the light emission amount always varies if light reflected by the light-reflecting layer 4-2 of the information storage medium returns to the semiconductor laser source, i.e., so-called “return light noise” is produced. Accordingly, this embodiment sets the value of the playback power to [Optimum playback power] 35.4 × 60 × ≈ 130,000 times [Optimum playback power] > 0.19 × (0.65/NA)2 × (V/6.6) (B-1) [Optimum playback power] [Optimum playback power] > 0.19 × (0.65/NA)2 × (V/6.6)1/2 (B-2)

on the basis of the value that is 1/80 the value described on the right side of expression (12) or (13).

Also, the dynamic range of a power monitoring photodetector limits the value of the optimum playback power. An optical head for recording/playback exists in an information recording/playback unit. This optical head incorporates a photodetector that monitors the light emission amount of a semiconductor laser source. To increase the light emission accuracy of the playback power during playback, this embodiment detects the light emission amount by using the photodetector, and feeds back the detected amount to the amount of electric current to be supplied to the semiconductor laser source. A very inexpensive photodetector must be used to decrease the cost of the optical head. Many inexpensive photodetectors put on the market are molded with resin (light-detecting portions are surrounded by the resin).

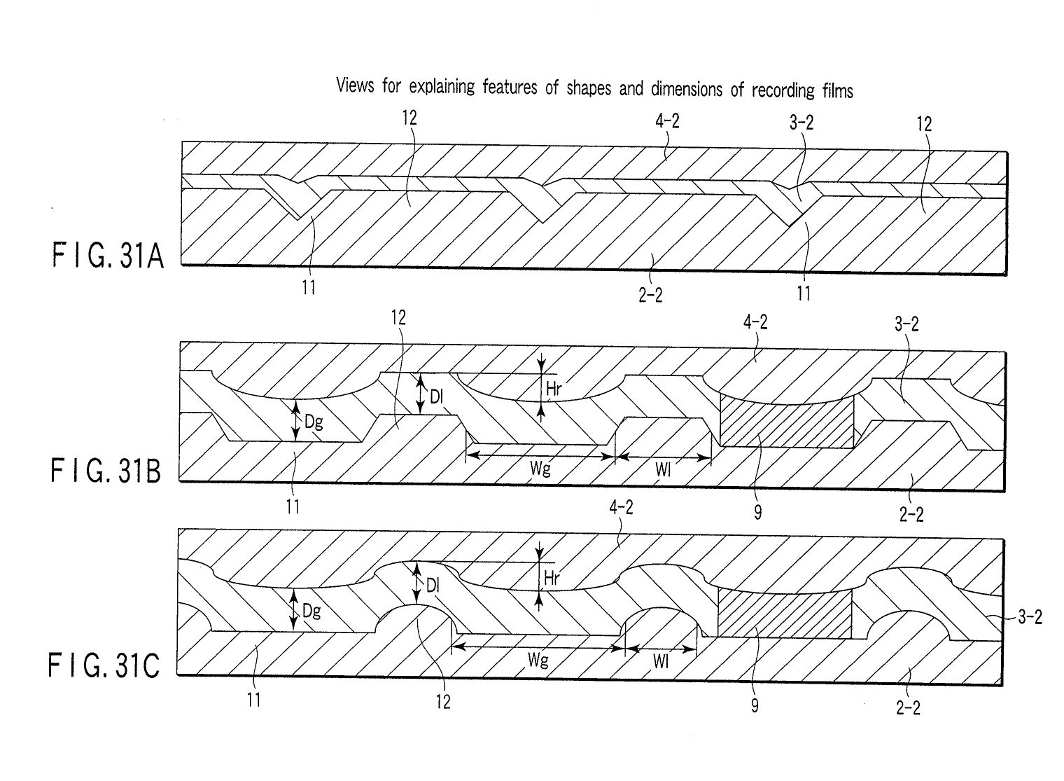

This embodiment uses 530 nm or less (particularly, 455 nm or less) as the light-source wavelength. In this wavelength region, the resin (particularly, epoxy-based resin) molding the light-detecting portion deteriorates (changes the color to unclear yellow or cracks (produces fine white lines)) when irradiated with light having the above wavelength in the same manner as when the mold is irradiated with ultraviolet rays. This worsens the light detection characteristics. This molding resin deterioration easily occurs especially in the write-once information storage medium disclosed in this embodiment because the medium has the pre-groove regions 11 as shown in FIGS. 31A to 31C. As a method of detecting an out-of-focus state of the optical head, “the knife edge method” is most often used in which a photodetector is placed in an image formation position (an image formation magnification M is about ×3 to ×10) with respect to the information storage medium in order to remove the adverse effect of diffracted light from the pre-groove region 11. When the photodetector is placed in the image formation position, light focuses on the photodetector. This increases the density of light irradiating the molding resin, thereby making resin deterioration easy to occur. This molding resin characteristic deterioration mainly occurs due to the photon mode (optical action), but the upper limit of the allowable irradiation amount can be predicted by comparison with the light irradiation amount in the thermal mode (thermal excitation). An optical system in which the photodetector is placed in the image formation position as an optical head is assumed by assuming the worst state.

The contents described in “(1) Conditions of Thickness Dg of Recording Layer 3-2” of “3-2-A] Range Requiring Application of Techniques of This Embodiment” presume that when the optical characteristic change (thermal mode) occurs in the recording layer 3-2 during recording of this embodiment, the internal temperature of the recording layer 3-2 temporarily rises to the range of 80° C. to 150° C. Assuming that room temperature is around 15° C., a temperature difference ΔT_{write} is 65° C. to 135° C. Although pulse light is emitted during recording, continuous light is emitted during playback. So, the temperature rises in the recording layer 3-2 during playback as well, and this produces a temperature difference ΔT_{read}. Letting M be the image formation magnification of the detection system in the optical head, the light density of detection light focusing on the photodetector is 1/M2 the light density of convergent light irradiating the recording layer 3-2. Accordingly, a rough estimation of the temperature rise on the photodetector during playback is ΔT_{read}/M2. Since the molding resin deteriorates in the photon mode, the upper limit of the density of light that can be emitted on the photodetector is probably about ΔT_{read}/M2≦1° C. as a temperature rise. The image formation magnification M of the detection system in the optical head is generally about ×3 to ×10. Therefore, when provisionally estimating that M2≈10, it is necessary to set the playback power to satisfy
ΔT_{read}/ΔT_{write}≦20 (B-3)

Assuming that the duty ratio of recording pulses during recording is 50%,
[optimum playback power]≦[optimum recording power]/10 (B-4)
is required. Therefore, expressions (8) to (13) to be described later and expression (B-4) above are taken into consideration, the optimum playback power is given by [Optimum playback power] [Optimum playback power] < 3 × (0.65/NA)2 × (V/6.6) (B-5) [Optimum playback power] [Optimum playback power] < 3 × (0.65/NA)2 × (V/6.6)1/2 (B-6) ]Optimum playback power] [Optimum playback power] < 2 × (0.65/NA)2 × (V/6.6) (B-7) [Optimum playback power] [Optimum playback power] < 2 × (0.65/NA)2 × (V/6.6)1/2 (B-8) [Optimum playback power] [Optimum playback power] < 1.5 × (0.65/NA)2 × (V/6.6) (B-9) [Optimum playback power] [Optimum playback power] < 1.5 × (0.65/NA)2 × (V/6.6)1/2 (B-10)
(The parameters are defined in “3-2-E] Basic Features Concerning Thickness Distribution of Recording Layer of This Embodiment”.) For example, when NA = 0.65 and V = 6.6 m/s, [Optimum playback power]< 3 mW, [Optimum playback power]< 2 mW, or [Optimum playback power]< 1.5 mW

In reality, while the information storage medium relatively moves by rotation, the photodetector is fixed. Therefore, the optimum playback power must be set to about ⅓ or less of those values of the above expressions by taking that into account. In an information recording/playback apparatus according to this embodiment, the value of the playback power is set to 0.4 mW.

3-2-C] Ideal Recording Film Structure that Readily Causes Recording Principle Disclosed in this Embodiment

A method of “setting the environment (the recording film structure or shape)” that readily causes the recording principle described above in this embodiment will be explained below.

As the environment that easily changes the optical characteristics inside the recording layer 3-2 explained above, this embodiment technically improves the recording film structure or shape such that

“the critical temperature at which the optical characteristics change is exceeded in a region where the recording mark 9 is formed, the vaporization (evaporation) temperature is not exceeded in the center of the recording mark 9, and the surface of the transparent substrate 2-2 near the center of the recording mark 9 does not exceed the thermal deformation temperature”

This is another feature of this embodiment.

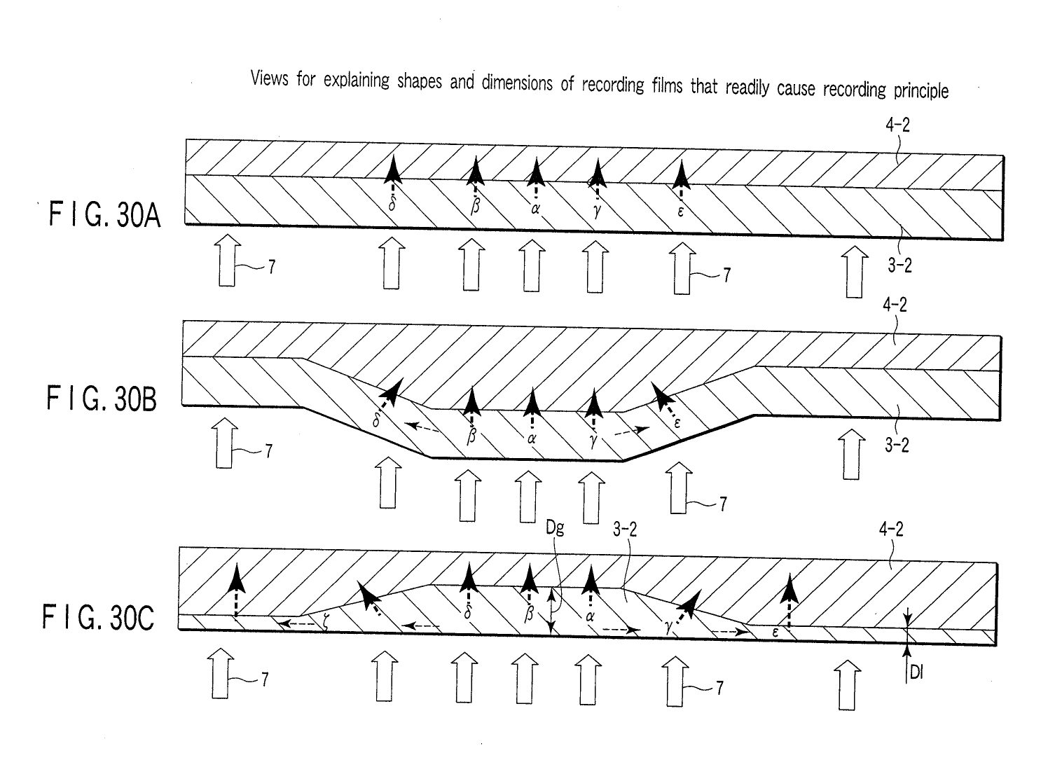

Practical contents of the above technical improvement will be explained below with reference to FIGS. 30A to 30C. Referring to FIGS. 30A to 30C, blank arrows indicate the optical paths of the laser beam 7, and broken-line arrows indicate heat flows. A recording film structure shown in FIG. 30A shows an environment that most easily causes the optical characteristic change inside the recording layer 3-2 corresponding to this embodiment. That is, referring to FIG. 30A, the recording layer 3-2 made of an organic dye recording material has a (sufficiently large) uniform thickness everywhere within the range indicated by expression (2) or (4), and is irradiated with the laser beam 7 in a direction perpendicular to the recording layer 3-2. As will be described in detail later in “6-1) Light-Reflecting Layer (Material and Thickness)”, this embodiment uses a silver alloy as the material of the light-reflecting layer 4-2. Materials containing metals having high light reflectance, such as a silver alloy, generally have high thermal conductivity and heat dissipation properties. Accordingly, the recording layer 3-2 raises its temperature by absorbing the energy of the radiated laser beam 7, but the heat is released toward the light-reflecting layer 4-2 having heat dissipation properties. Since the recording film shown in FIG. 30A has a uniform shape everywhere, the temperature relatively evenly rises inside the recording layer 3-2, so temperature differences between a central point α and points β and γ are relatively small. When the recording mark 9 is formed, therefore, while the critical temperature at which the optical characteristics change is exceeded at the points β and γ, the vaporization (evaporation) temperature is not exceeded at the central point α, and the surface of the transparent substrate (not shown) in a position closest to the central point a does not exceed the thermal deformation temperature either.

By contrast, if the recording layer 3-2 partially has a step as shown in FIG. 30B, at points δ and ε the recording layer 3-2 is irradiated with the laser beam 7 in a direction oblique to the direction along which the recording layer 3-2 is formed. This relatively decreases the irradiation amount of the laser beam 7 per unit area compared to the central point α. Consequently, the temperature rise in the recording layer 3-2 decreases at the points δ and ε. Heat is dissipated toward the light-reflecting layer 4-2 at the points δ and ε as well. When compared to the central point α, therefore, the temperatures at the points δ and ε largely decrease. As a consequence, heat flows from the point β to the point δ, and from the point γ to the point ε. This greatly increases the temperature differences between the central point α and points β and γ. During recording, the temperature rise is low at the points β and γ, so the critical temperature at which the optical characteristics change is not easily exceeded at the points β and γ. As a countermeasure, therefore, it is necessary to increase the exposure amount (recording power) of the laser beam 7 in order to change the optical characteristics (exceed the critical temperature) at the points β and γ. In the recording film structure shown in FIG. 30B, the temperature at the central point α is much higher than those at the points β and γ. Accordingly, when the temperature rises to the critical temperature at which the optical characteristics change at the points β and γ, the vaporization (evaporation) temperature is easily exceeded at the central point α, or the surface of the transparent substrate (not shown) near the central point α readily exceeds the thermal deformation temperature.

Also, even when that surface of the recording layer 3-2 which is irradiated with the laser beam 7 is perpendicular to the radiation direction of the laser beam 7 everywhere, if the thickness of the recording layer 3-2 changes from one place to another, the optical characteristic change inside the recording layer 3-2 of this embodiment hardly occurs in the structure. For example, assume that, as shown in FIG. 30C, the thickness Dl in the peripheral portion of the recording layer 3-2 is much smaller than the thickness Dg of the recording layer 3-2 at the central point α (e.g., expression (2) or (4) is not satisfied). Although heat is dissipated to the light-reflecting layer 4-2 at the central point α as well, heat can be accumulated and a high temperature can be reached because the thickness Dg of the recording layer 3-2 is sufficiently large. By contrast, at points ζ and η where the thickness Dl of the recording layer 3-2 is very small, heat is not sufficiently accumulated but dissipated toward the light-reflecting layer 4-2, so the temperature rise is small. Consequently, heat is dissipated not only in the direction of the light-reflecting layer 4-2 but also in the direction of point β→point δ→point ζ or in the direction of point γ→point ε→point η. This extremely increases the temperature differences between the central point α and points β and γ similar to FIG. 30B. If the exposure amount (recording power) of the laser beam 7 is increased to change the optical characteristics (exceed the critical temperature) at the points β and γ, the vaporization (evaporation) temperature is readily exceeded at the central point α, or the surface of the transparent substrate (not shown) near the central point α easily exceeds the thermal deformation temperature.

The contents of technical improvements made on the pre-groove shape/dimensions by this embodiment in order to “set the environment (recording film structure or shape)” that easily causes the recording principle of this embodiment on the basis of the contents explained above, and the contents of technical improvements made on the thickness distribution of the recording layer by this embodiment will be explained below with reference to FIGS. 31A to 31C. FIG. 31A shows the recording film structure in the conventional write-once information storage medium such as a CD-R or DVD-R. FIGS. 31B and 31C each illustrate the recording film structure according to this embodiment. In this explanation, the recording mark 9 is formed in the pre-groove region 11 as shown in FIGS. 31B and 31C.

3-2-D] Basic Features Concerning Pre-groove Shape/Dimensions in this Embodiment

As shown in FIG. 31A, in the conventional write-once information storage medium such as a CD-R or DVD-R, the pre-groove region 11 has a “V-groove” shape in many cases. In this structure, as explained with reference to FIG. 30B, the energy absorption efficiency of the laser beam 7 is low, and the temperature distribution variation in the recording layer 3-2 is very large. This embodiment is characterized by at least “forming a planar region perpendicular to the propagation direction of the incident laser beam 7 in the pre-groove region 11 of the transparent substrate 2-2” in order to make the structure close to the ideal state shown in FIG. 30A. As explained with reference to FIG. 30A, this planar region is desirably as wide as possible. Accordingly, not only the planar region is formed in the pre-groove region 11, but also the width Wg of the pre-groove region is made larger than the width Wl of the land region (Wg>Wl). This is another feature of this embodiment. The following explanation defines the width Wg of the pre-groove region and the width Wl of the land region as the widths of the pre-groove region and land region, respectively, at a position where an inclined plane in the pre-groove intersects a plane having a height intermediate between the height at the position of the plane of the pre-groove region and the height at the highest position of the land region.

The present inventors made examinations by thermal analysis, and recorded data on actually formed write-once information storage media. The present inventors repetitively observed substrate deformation by sectional SEM (Scanning Electron Microscope) images at the position of the recording mark 9, and the presence/absence of cavities formed by vaporization (evaporation) in the recording layer 3-2. Consequently, it is found that making the width Wg of the pre-groove region larger than the width Wl of the land region (Wg>Wl) is effective. In addition, when the ratio of the pre-groove region width Wg to the land region width Wl is made higher than Wg:Wl=6:4, preferably, Wg:Wl=7:3, a local optical characteristic change presumably readily occurs more stably in the recording layer 3-2 during recording. When the difference between the pre-groove region width Wg and land region width Wl is thus increased, no flat surface exists any longer on the land regions 12 as shown in FIG. 31C. The format of the conventional DVD-R disk is that pre-pits (land pre-pits: not shown) are formed in the land regions 12, and address information and the like are prerecorded in the pre-pits. This makes it essential to form a flat region in the land region 12, and as a consequence the pre-groove region 11 has a “V-groove” shape in many cases. Also, in the conventional CD-R disk, a wobble signal is inserted into the pre-groove region 11 by frequency modulation. In this frequency modulation method of the conventional CD-R disk, slot intervals (details will be described later in the explanation of each format) are not constant, and this makes phase matching (synchronization of PLL: PhaseLockLoop) relatively difficult when detecting the wobble signal. Therefore, the wobble signal detection accuracy is guaranteed by concentrating the wall surfaces of the pre-groove region 11 (making them close to a V-groove) near the center at which the intensity of the playback light spot is highest, and increasing the wobble amplitude amount. A wobble detection signal is difficult to obtain when, as shown in FIGS. 31B and 31C, the flat region in the pre-groove region 11 of this embodiment is widened to relatively move the inclined surfaces of the pre-groove region 11 outward from the central position of the playback light spot. This embodiment is characterized by increasing the width Wg of the pre-groove region 11 as described above, and combining, with that, H format using phase modulation (PSK: Phase Shift Keying) that always fixes the slot intervals during wobble detection or B format using FSK (Frequency Shift Keying) or STW (Saw Tooth Wobble), thereby assuring stable recording characteristics at low recording power (suitable for high-speed recording and a multilayered disk), and stable wobble signal detection characteristics. This is a great feature of this embodiment. Especially when using H format, this embodiment further facilitates synchronization for wobble signal detection by “making the ratio of the wobble modulation region lower than that of a non-modulation region” in addition to the above combination.

3-2-E] Basic Features Concerning Thickness Distribution of Recording Layer of this Embodiment

This explanation defines the largest thickness of the recording layer 3-2 in the land region 12 as the recording layer thickness Dl in the land region, and the largest thickness of the recording layer 3-2 in the pre-groove region 11 as the recording layer thickness Dg in the pre-groove region. As already explained with reference to FIG. 30C, when the recording layer thickness Dl in the land region is relatively increased, the local optical characteristics stably easily change in the recording layer 3-2.

In the same manner as above, the present inventors made examinations by thermal analysis, and recorded data on actually formed write-once information storage media. The present inventors repetitively observed substrate deformation by sectional SEM (Scanning Electron Microscope) images at the position of the recording mark 9, and the presence/absence of cavities formed by vaporization (evaporation) in the recording layer 3-2. Consequently, it is necessary to set the maximum ratio of the recording layer thickness Dg in the pre-groove region to the recording layer thickness Dl in the land region to Dg: Dl=4:1 or less. Furthermore, when Dg:Dl=3:1 or less, preferably, Dg:Dl=2:1 or less, the stability of the recording principle of this embodiment can be assured.

3-3) Recording Characteristics Common to Organic Dye Recording Films of this Embodiment

As described in [γ] as one of “3-2-B] Basic Features Common to Organic Dye Recording Materials of This Embodiment”, recording power control is a big feature of this embodiment.

The local optical characteristic change in the recording layer 3-2 forms the recording mark 9 at a temperature much lower than the plastic deformation temperature of the conventional transparent substrate 2-2 or the thermal decomposition temperature or vaporization (evaporation) temperature in the recording layer 3-2. Therefore, the upper limit of the recording power is limited so that the transparent substrate 2-2 does not locally exceed the plastic deformation temperature or the interior of the recording layer 3-2 does not locally exceed the thermal decomposition temperature or vaporization (evaporation) temperature during recording.

In parallel with examination by thermal analysis, the present inventors verified the value of optimum power when recording was performed by the recording principle disclosed in this embodiment, by using an apparatus to be described later in “4-1) Explanation of Structure and Features of Playback Apparatus or Recording/Playback Apparatus of This Embodiment” under recording conditions to be described later in “4-3) Explanation of Recording Conditions of This Embodiment”. The NA (Numerical Aperture) value of the objective lens in the recording/playback apparatus used in the verification experiment was 0.65, and the linear velocity of recording was 6.61 m/s. The value of the recording power (peak power) to be defined later in “4-3) Explanation of Recording Conditions of This Embodiment” must satisfy the following conditions:
Most of the organic dye recording material vaporizes (evaporates) at 30 mW to form a cavity in the recording mark.
   The temperature of the transparent substrate 2-2 near the recording layer 3-2 largely exceeds the glass transition temperature.
The temperature of the transparent substrate 2-2 near the recording layer 3-2 reaches the plastic deformation temperature (glass transition temperature) at 20 mW.
The recording power is desirably 15 mW or less when the surface movement or warpage of the information storage medium or the margin for the recording power variation is taken into consideration.

“The recording power” explained above means the total sum of the exposure amounts irradiating the recording layer 3-2. The optical energy density in the central portion of the light spot where the optical intensity density is highest is a parameter to be examined in this embodiment. Since the light spot size is inversely proportional to the NA value, the optical energy density in the light spot central portion increases in proportion to the square of the NA value. Accordingly, the recording power can be converted into the value of optimum recording power in B format (to be described later) or another format (another NA value) shown in Table 1 (D3) by using
[recording power adaptable to different NA]=[recording power when NA=0.65]×0.652/NA2 (5)

Furthermore, the optimum recording power changes in accordance with a recording linear velocity V. It is generally said that the optimum recording power changes in proportion to the ½ power of the linear velocity V for a phase-change recording material, and changes in proportion to the linear velocity V for an organic dye recording material. Therefore, the optimum recording power converting expression taking account of the linear velocity V as well is obtained by extending expression (5) to
[general recording power]=[recording power when NA=0.65; 6.6 m/s]×(0.65/NA)2×(V/6.6) (6)
or
[general recording power]=[recording power when NA=0.65; 6.6 m/s]×(0.65/NA)2×(V/6.6)1/2 (7)

Collectively, as the recording power for assuring the recording principle disclosed in this embodiment, it is desirable to set the upper limits represented by: [Optimum recording power] [Optimum playback power] < 30 × (0.65/NA)2 × (V/6.6) (8) [Optimum recording power] [Optimum playback power] < 30 × (0.65/NA)2 × (V/6.6)1/2 (9) [Optimum recording power] [Optimum playback power] < 20 × (0.65/NA)2 × (V/6.6) (10) [Optimum recording power] [Optimum playback power] < 20 × (0.65/NA)2 × (V/6.6)1/2 (11) [Optimum recording power] [Optimum playback power] < 15 × (0.65/NA)2 × (V/6.6) (12) [Optimum recording power] [Optimum playback power] < 15 × (0.65/NA)2 × (V/6.6)1/2 (13)

Of the above expressions, the condition of expression (8) or (9) is an essential condition, expression (10) or (11) is a target condition, and expression (12) or (13) is a desirable condition.

3-4) Explanation of Features Concerning “H→L” Recording Film of this Embodiment

A recording film having the characteristic that the light reflection amount in the recording mark 9 is smaller than that in an unrecorded region is called an “H→L” recording film. A recording film having the characteristic that the former is larger than the latter is called an “L→H” recording film. The “H→L” recording film of this embodiment is characterized by:

(1) setting an upper limit of the ratio of the absorbance at the playback wavelength to the absorbance at the position of λ_{max write} of the light absorption spectrum; and

(2) forming a recording mark by changing the light absorption spectral profile.

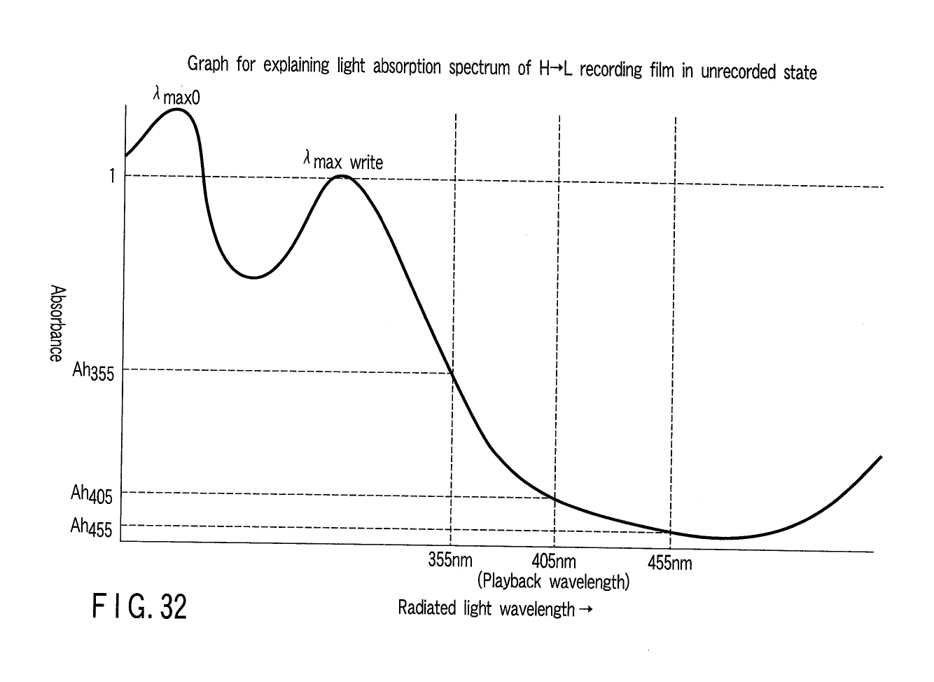

The above-mentioned contents will be explained in detail below with reference to FIG. 32. In the H→L recording film of this embodiment as shown in FIG. 32, the wavelength λ_{max write} is shorter than the wavelength (near 405 nm) used in recording/playback. As is apparent from Formula 14, the absorbance changes little between an unrecorded region and recorded region near the wavelength λ_{max write}. If the absorbance changes little between an unrecorded region and recorded region, the playback signal amplitude cannot be increased. By taking account of the ability to stably record or play back information even when the wavelength of the recording or playback laser source varies, as shown in FIG. 32, this embodiment designs the recording film 3-2 so that the wavelength λ_{max write} is outside the range of 355 to 455 nm, i.e., shorter than 355 nm. Note that FIG. 33 is a graph for explaining the light absorption spectra in a recording mark of the “H→L” recording film.

The relative absorbances at 355, 455, and 405 nm explained in “Chapter 0 Explanation of Relationship between Use Wavelengths and This Embodiment” when the absorbance at the position of λ_{max write} already defined in “2-1) Difference in Recording Principle/Recording Film Structure and Basic Conceptual Difference Concerning Playback Signal Generation” is normalized to “1” are respectively defined as Ah₃₅₅, Ah₄₅₅, and Ah₄₀₅

When Ah₄₀₅=0.0, the light reflectance of the recording film in an unrecorded state is equal to that of the light-reflecting layer 4-2 at 405 nm. The light reflectance of the light-reflecting layer 4-2 will be described in detail later in “6-1) Light-Reflecting Layer”. For the descriptive simplicity, however, an explanation will be made by assuming that the light reflectance of the light-reflecting layer 4-2 is 100%.

A common playback circuit can play back the write-once information storage medium using the “H→L” recording film of this embodiment and a single-sided, single-layered, read-only information storage medium (HD DVD-ROM disk). Therefore, the light reflectance in this case is set at 40% to 85% in accordance with that of a single-sided, single-layered, read-only information storage medium (HD DVD-ROM disk). For this purpose, the light reflectance in an unrecorded position must be set at 40% or more. Since 1−0.4=0.6, it is possible to intuitively understand that the absorbance Ah₄₀₅ at 405 nm need only be
Ah₄₀₅≦0.6 (14)

It is possible to readily understand that the light reflectance in an unrecorded position can be set at 40% or more if expression (14) is met. Accordingly, this embodiment selects organic dye recording materials meeting expression (14) in an unrecorded portion. Expression (14) assumes that the light reflectance is 0% when the light-reflecting layer 4-2 reflects light having the wavelength λ_{max write} through the recording layer 3-2 in FIG. 32. In practice, however, this light reflectance is not 0% but has a value to some extent. Strictly speaking, therefore, it is necessary to correct expression (14). Letting Rλ_{max write} be the light reflectance when the light-reflecting layer 4-2 reflects light having the wavelength λ_{max write} through the recording layer 3-2 in FIG. 32, a strict conditional expression for setting the light reflectance in an unrecorded position at 40% or more is
1−Ah₄₀₅×(1−Rλ_{max write})≧0.4 (15)

In the “H→L” recording film, Rλ_{max write}≧0.25 holds in many cases. Therefore, expression (15) can be rewritten into
Ah₄₀₅≦0.8 (16)

The “H→L” recording film of this embodiment must satisfy expression (16) as an indispensable condition. The present inventors performed detailed optical film design in order to satisfy the condition of expression (14), and also satisfy the condition of expression (3) or (4) as the film thickness of the recording layer 3-2.

Consequently,
Ah₄₀₅≦0.3 (17)
is desirable when various margins for, e.g., the film thickness variation and playback light wavelength variation are taken into consideration. When expression (14) is a precondition, the recording/playback characteristics further stabilize by setting Ah₄₅₅ ≦ 0.6 (18)
or Ah₃₅₅ ≦ 0.6 (19)

The reason is as follows. That is, if at least one of expressions (18) and (19) is met while expression (14) holds, the value of Ah is 0.6 or less over the range of 355 to 405 nm or 405 to 455 nm (or the range of 355 to 455 nm in some cases). Even when the light emission wavelength of the recording laser source (or playback laser source) varies, therefore, the value of the absorbance does not largely change.

As a practical recording principle of the “H→L” recording film of this embodiment, the phenomenon “intermolecular alignment change” or “intramolecular structural change” of the recording mechanisms described in [α] of already explained “3-2-B] Basic Features Common to Organic Dye Recording Materials of This Embodiment”. As a consequence, the light absorption spectral profile changes as described above in (2). In Formula 14, the solid line indicates the light absorption spectral profile in a recording mark of this embodiment, and the broken line indicating the light absorption spectral profile in an unrecorded portion is superposed on the solid line, so that the two profiles can be compared. In this embodiment, the light absorption spectral profile relatively broadly changes in a recording mark, indicating the possibility that the molecular structure changes in the molecule to precipitate some carbon atoms (form coal tar). This embodiment is characterized by generating a playback signal in the “H→L” recording film by making the value of a wavelength λlₘₐₓ, at which the absorbance in a recording mark is a maximum, closer to a playback wavelength of 405 nm than the value of the wavelength λ_{max write} in an unrecorded position. This makes the absorbance at the wavelength λlₘₐₓ at which the absorbance is a maximum smaller than “1”, and the value of the absorbance Al₄₀₅ at a playback wavelength of 405 nm larger than the value of Ah₄₀₅. As a result, the total light reflectance in a recording mark decreases.

H format in this embodiment uses ETM (Eight to Twelve: 8-bit code data is converted into 12 channel bits) and RLL(1,10) (in the modulated code sequence, a minimum inversion length and maximum inversion length with respect to a channel bit length T are respectively 2T and 11T) as the modulation methods. The present inventors evaluated the performance of a playback circuit to be described later in “4-2) Explanation of Playback Circuit of This Embodiment”. Consequently, to stably play back information by this playback circuit, the ratio of [a difference I₁₁≡I₁₁H−I₁₁L between a playback signal amount I₁₁H from an unrecorded region having a sufficiently large length (11 T) and a playback signal amount I₁₁L from a recording mark having the sufficiently large length (11 T)] to [the playback signal amount I₁₁H] must satisfy at least I₁₁/I₁₁H ≧0.4 (20)

and desirably, I₁₁/I₁₁H ≧ 0.2 (21)

This embodiment uses the PRML method to play back a signal recorded at high density. To detect a playback signal with high accuracy by the PRML method, the playback signal must have linearity. Letting 13 be a playback signal amplitude from a repetitive signal of recording marks having a length of 3T and unrecorded spaces, to ensure the linearity of the playback signal, the ratio of I₃ to I₁₁ must satisfy I₃/I₁₁ ≦ 0.35 (22)

and desirably, I₃/I₁₁ ≦ 0.2 (23)

The technical feature of this embodiment lies in that the value of Al₄₀₅ is set to meet expressions (20) and (21) while the condition of expression (16) is taken into consideration. From expression (16),
1−0.3=0.7 (24)

From the correspondence of expression (24) to expression (20),
(Al₄₀₅−0.3)/0.7≧0.4 that is,

This derives a condition indicated by

That is,
Al₄₀₅≧0.58 (25)

Expression (25) is derived from the very rough examination result, and merely indicates the basic concept. Since expression (16) defines the setting range of Ah₄₀₅, this embodiment requires at least
Al₄₀₅>0.3 (26)
as the condition of Al₄₀₅.

As a practical method of selecting an organic dye recording material suited to the “H→L” recording film, this embodiment selects, on the basis of optical film design, an organic dye material having refractive index n₃₂=1.3 to 2.0, preferably, 1.7 to 1.9 and absorption coefficient k₃₂=0.1 to 0.2, preferably, 0.15 to 0.17, in an unrecorded state, thereby satisfying the series of conditions explained above.

In the “H→L” recording film shown in FIG. 32 or Formula 14, the wavelength λ_{max write} is shorter than the wavelength (e.g., 405 nm) of playback light or recording/playback light. However, this embodiment is not limited to this condition, and the wavelength λ_{max write} may also be longer than the wavelength (e.g., 405 nm) of playback light or recording/playback light.

To satisfy expression (22) or (23), the thickness Dg of the recording layer 3-2 has a large effect. For example, if the thickness Dg of the recording layer 3-2 largely exceeds the allowable value, the state after the recording mark 9 is formed is that the optical characteristics change in only that portion of the recording layer 3-2 which is in contact with the transparent substrate 2-2, and the optical characteristics in a portion adjacent to the former portion and in contact with the light-reflecting layer 4-2 remain the same as in other unrecorded regions. As a consequence, the playback light amount change decreases, and this decreases the value of I₃ in expression (22) or (23), so expression (22) or (23) cannot be met any longer. To meet expression (22), therefore, it is necessary to change the optical characteristics in that portion of the recording layer 3-2 which is in contact with the light-reflecting layer 4-2 as shown in FIGS. 31B and 31C. In addition, if the thickness Dg of the recording layer 3-2 largely exceeds the allowable value, a temperature gradient forms in the thickness direction of the recording layer 3-2 when a recording mark is formed. Consequently, before the temperature at which the optical characteristics change in that portion of the recording layer 3-2 which is in contact with the light-reflecting layer 4-2 is reached, the vaporization (evaporation) temperature of the portion in contact with the transparent substrate 2-2 is exceeded, or the thermal deformation temperature of the transparent substrate 2-2 is exceeded. For the above reasons, this embodiment sets the thickness Dg of the recording layer 3-2 to “3T” or less in order to satisfy expression (22), and sets the thickness Dg of the recording layer 3-2 to “3×3T” or less in order to satisfy expression (23), on the basis of examination using thermal analysis. Basically, expression (22) can be met if the thickness Dg of the recording layer 3-2 is “3T” or less. However, the thickness Dg is sometimes set to “T” or less when the influence of tilt caused by the surface movement or warpage of the write-once information storage medium and the margin for an out-of-focus state are taken into consideration. When the results of expressions (1) and (2) already explained earlier are also taken into consideration, the thickness Dg of the recording layer 3-2 of this embodiment is set within the range of
9T≧Dg≧λ/8n₃₂ (27)
as a minimum necessary condition, or within the range of
3T≧Dg≧λ/4n₃₂ (28)
as a desirable condition. It is also possible to set
T≧Dg≧λ/4n₃₂ (29)
as a most strict condition. As will be described later, the value of the channel bit length T is 102 nm for H format and 69 to 80 nm for B format. Accordingly, the value of 3T is 306 nm for H format and 207 to 240 nm for B format, and the value of 9T is 918 nm for H format and 621 to 720 nm for B format. Although the “H→L” recording film is explained here, the conditions of expressions (27) to (29) are not limited to the “H→L” recording film but applicable to the “L→H” recording film as well.

Detailed Explanation of Organic Dye Recording Films of this Embodiment

5-1) Explanation of Features Concerning “L→H” Recording Film of this Embodiment

The “L→H” recording film in which the light reflection amount in a recording mark is smaller than that in an unrecorded region will be explained below. As a recording principle when using this recording film, one of:
a color development characteristic change;
a change in electron structure (electron orbit) with respect to electrons contributing to a color development phenomenon [an example of this change is decoloration]; and
An intermolecular alignment change of the recording principles explained in “3-2-B] Basic Features Common to Organic Dye Recording Materials of this Embodiment” is used to change the characteristic of the light absorption spectrum. The “L→H” recording film of this embodiment is particularly characterized in that the reflection amount ranges in an unrecorded portion and recorded portion are defined by taking account of the characteristics of a read-only information storage medium having a single-sided, double-layered structure. This embodiment defines that a lower limit δ of the reflectance in an unrecorded portion of the “H→L” recording film is higher than an upper limit γ in an unrecorded portion of the “L→H” recording film. When the information storage medium is set in an information recording/playback apparatus or information playback apparatus, whether the medium has the “H→L” recording film or “L→H” recording film can be instantaneously discriminated by measuring the light reflectance of an unrecorded portion by a slice level detector 132 or PR equalizer 130. This extremely facilitates discrimination between the types of recording films. The prevent inventors formed “H→L” recording films and “L→H” recording films by changing many manufacturing conditions, and measured these films. Consequently, when a light reflectance α between the lower limit δ in an unrecorded portion of the “H→L” recording film and the upper limit γ in an unrecorded portion of the “L→H” recording film is set within the range of 32% to 40%, the productivity of the recording film is high, so the cost of the medium can be readily reduced. When a light reflectance range 801 in an unrecorded portion (“L” portion) of the “L→H” recording film is matched with a light reflectance range 803 of a single-sided, double-layered recording film of a read-only information storage medium and a light reflectance range 802 in an unrecorded portion (“H” portion) of the “H→L” recording film is matched with a light reflectance range 804 of a single-sided, single-layered film of a read-only information storage medium, the compatibility with the read-only information storage media improves. Since a common playback circuit of an information playback apparatus can be used, the information playback apparatus can be manufactured at low cost. The present inventors formed “H→L” recording films and “L→H” recording films by changing many manufacturing conditions, and measured these films. Consequently, to increase the productivity of the recording films and reduce the cost of the media, this embodiment sets a lower limit β and the upper limit γ of the light reflectance in an unrecorded portion (“L” portion) of the “L→H” recording film to 18% and 32%, respectively, and sets the lower limit δ and an upper limit ε of the light reflectance in an unrecorded portion (“H” portion) of the “H→L” recording film to 40% and 85%, respectively.

When H format is used and the light reflectance range in an unrecorded portion is defined, signals appear in the same direction in an emboss region (e.g., a system lead-in region SYLDI) and a recording mark region (a data lead-in region DTLDI, data lead-out region DTLDO, or data region DTA) of the “L→H” recording film, on the basis of groove level. On the other hand, signals appear in the opposite directions in the emboss region (e.g., the system lead-in region SYLDI) and the recording mark region (the data lead-in region DTLDI, data lead-out region DTLDO, or data region DTA) of the “H→L” recording film, on the basis of groove level. It is possible by using these phenomena not only to distinguish between the “L→H” recording film and “H→L” recording film, but also to facilitate designing a detection circuit corresponding to the “L→H” recording film and “H→L” recording film. In addition, expressions (20) to (23) are met by matching the playback signal characteristics obtained from a recording mark recorded on the “L→H” recording film of this embodiment with the signal characteristics obtained from the “H→L” recording film. This makes it possible to use the same signal processor for the “L→H” recording film and “H→L” recording film, thereby simplifying the arrangement and reducing the cost of the signal processor.

5-2) Features of Light Absorption Spectrum Concerning “L→H” Recording Film of this Embodiment

As explained in “3-4) Explanation of Features Concerning “H→L” Recording Film of this Embodiment”, the relative absorbance in an unrecorded region of the “H→L” recording film is basically low. When irradiated with playback light during playback, therefore, the “H→L” recording film hardly changes its optical characteristics by absorbing the energy of the playback light. Even if the optical characteristic change (update of the recording action) occurs by absorbing the energy of the playback light in a recording mark where the absorbance is high, the light reflectance from the recording mark keeps decreasing. As a result, the amplitude (I₁₁=I₁₁H−I₁₁L) of the playback signal increases, and this reduces the bad influence on playback signal processing.

By contrast, the “L→H” recording film has the optical characteristic that the light reflectance in an unrecorded portion is lower than that in a recording mark”. As is apparent from the contents explained with reference to FIG. 26B, this means that the absorbance in an unrecorded portion is higher than that in a recording mark. Accordingly, playback signal deterioration occurs more easily in the “L→H” recording film than in the “H→L” recording film. As explained in “3-2-B] Basic Features Common to Organic Dye Recording Materials of this Embodiment”, it is necessary to “ε] improve the reliability of playback information in preparation for the case that playback signal deterioration occurs due to ultraviolet radiation or playback light radiation”.

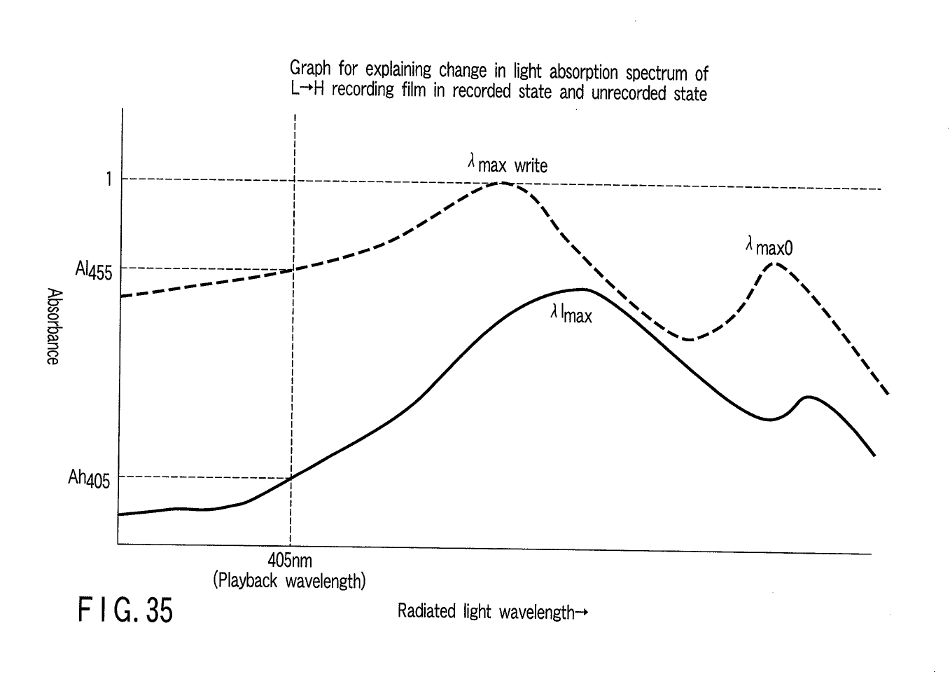

The present inventors examined the characteristics of organic dye recording materials in detail. As a result, the mechanism that changes the optical characteristics by absorbing the energy of playback light is almost similar to the mechanism that changes the optical characteristics by ultraviolet radiation. This means that a structure that increases the resistance to ultraviolet radiation in an unrecorded region prevents easy occurrence of playback signal deterioration. Therefore, this embodiment is characterized by making the value of λ_{max write} (the maximum absorption wavelength closest to the wavelength of recording light) of the “L→H” recording film larger than that of the wavelength (about 405 nm) of recording light or playback light. This makes it possible to decrease the absorbance to ultraviolet rays, and greatly increases the resistance to ultraviolet radiation. As shown in FIG. 35, the difference in absorbance between a recorded portion and unrecorded portion is small near λ_{max write}. This decreases the playback signal modulation factor (signal amplitude) when playing back information with light having a wavelength near λ_{max write}. When the wavelength variation of a semiconductor laser source is also taken into account, it is desirable to obtain a sufficiently large playback signal modulation factor (signal amplitude) within the range of 355 to 455 nm. Accordingly, this embodiment designs the recording film 3-2 such that the wavelength λ_{max write} falls outside the range of 355 to 455 nm (i.e., is longer than 455 nm).

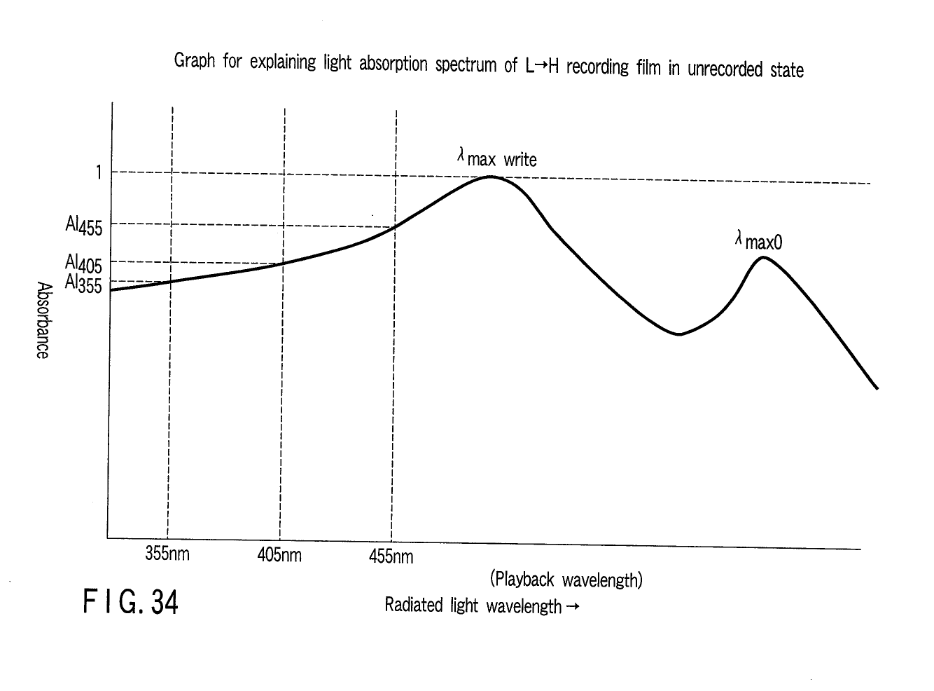

FIG. 34 shows an example of the light absorption spectrum of the “L→H” recording film of this embodiment. As explained in “5-1) Explanation of Features Concerning “L→H” Recording Film of This Embodiment”, this embodiment sets the lower limit β and upper limit γ of the light reflectance in an unrecorded portion (“L” portion) of the “L→H” recording film at 18% and 32%, respectively. It is possible to intuitively understand from 1−0.32=0.68 that in order to satisfy the above conditions, the value Al₄₀₅ of the absorbance in an unrecorded region at 405 nm must satisfy
Al₄₀₅≧68% (36)

For the descriptive simplicity, assume that the light reflectance at 405 nm of the light-reflecting layer 4-2 in FIG. 26 is almost 100%, although it is actually slightly lower than 100%. Accordingly, the light reflectance is almost 100% when absorbance Al=0. Referring to FIG. 34, Rλ_{max write} represents the light reflectance of the whole recording film at the wavelength λ_{max write}. Expression (36) is derived by assuming that the light reflectance at that time is zero (Rλ_{max write}≈0). In reality, however, this light reflectance is not “0”, so a more strict expression must be derived. A strict conditional expression for setting the upper limit γ of the light reflectance in an unrecorded portion (“L” portion) of the “L→H” recording film at 32% is given by
1-Al₄₀₅×(1−Rλ_{max write})≦0.32 (37)

All the conventional write-once information storage media use the “H→L” recording film, so there is no information pertaining to the “L→H” recording film. However, when this embodiment to be described later in “5-3) Anion Part: Azo Metal Complex+Cation Part: Dye” and “5-4) Azo Metal Complex+“Copper” as Central Metal” is used, a most strict condition meeting expression (37) is
Al₄₀₅≧80% (38)

When organic dye recording materials to be described later in this embodiment are used and optical design of the recording is performed by taking account of the characteristic variations during manufacture and the margin for, e.g., the thickness change of the recording layer 3-2, a minimum necessary condition meeting the reflectance explained in “5-1) Explanation of Features Concerning “L→H” Recording Film of this Embodiment” need only satisfy Al₄₀₅ ≧ 40% (39)

In addition, it is possible by satisfying one of Al₃₅₅ ≧ 40% (40) Al455 ≧ 40% (41)

to secure the stable recording or playback characteristic even when the wavelength of the light source changes within the range of 355 to 405 nm or 405 to 455 nm (or the range of 355 to 455 nm if the two expressions are simultaneously met).

FIG. 35 shows the change in light absorption spectrum after information is recorded in the “L→H” recording film of this embodiment. Since the value of the maximum absorption wavelength λlₘₐₓ in the recording mark shifts from the wavelength λ_{max write}, the intermolecular alignment change (e.g., the alignment change between azo metal complexes) has probably occurred. Furthermore, both the absorbance at λlₘₐₓ and the absorbance Al₄₀₅ at 405 nm decrease, and the light absorption spectrum widely spreads. Therefore, decoloration (local electron orbit disconnection (local molecular bond dissociation)) has presumably occurred.

Since the “L→H” recording film of this embodiment also satisfies expressions (20), (21), (22), and (23), the same signal processor can be used for both the “L+H” recording film and “H→L” recording film. This makes it possible to simplify the arrangement and reduce the cost of the signal processor. Deforming expression (20) into I₁₁/I₁₁H≡(I₁₁H—I₁₁L)/I₁₁H ≧ 0.4 (42)

yields I₁₁H ≧ /I₁₁L/0.6 (43)

As already explained above, this embodiment sets the lower limit β of the light reflectance in an unrecorded portion (“L” portion) of the “L→H” recording film at 18%, and this value corresponds to I₁₁L. In addition, this value conceptually corresponds to
I₁₁H≈1−Ah₄₀₅×(1−Rλ_{max write}) (44)

From expressions (43) and (44), therefore,
1−Ah₄₀₅×(1−Rλ_{max write})≧0.18/0.6 (45)

When 1−Rλ_{max write}≈0, expression (45) is obtained by
Ah₄₀₅≦0.7 (46)

Comparing expression (46) with expression (36) indicates that the values of the absorbances Al₄₀₅ and Ah₄₀₅ are preferably set close to 68% to 70% as the boundary. Furthermore, the value of Al₄₀₅ falls within the range of expression (39), or satisfies
Ah₄₀₅≦0.4 (47)
as a strict condition when the performance stability of the signal processor is taken into account. If possible, the value of Al₄₀₅ desirably satisfies
Ah_{405≦}0.3 (48)

5-3) Anion Part: Azo Metal Complex+Cation Part: Dye

Practical organic dye materials of this embodiment that have the features explained in “5-1) Explanation of Features Concerning “L→H” Recording Film of This Embodiment” and satisfy the conditions explained in “5-2) Features of Light Absorption Spectrum Concerning “L→H” Recording Film of This Embodiment” will be explained below. The recording layer 3-2 has a thickness meeting the conditions indicated by expressions (3), (4), (27), and (28), and is formed by spinner coating (spin coating). As an example for comparison, the crystal of “salt” is formed by “an ionic bond” between “a sodium ion” that is positively charged and “a chlorine ion” that is negatively charged. Likewise, a plurality of different polymers sometimes combine to form an organic dye material in a form close to “an ionic bond”. The organic dye recording film 3-2 of this embodiment is made up of “a cation part” that is positively charged and “an anion part” that is negatively charged. This embodiment is particularly characterized by using “a dye” having color generating properties in “the cation part” that is positively charged, and an organic metal complex in “the anion part” that means a counter ion part and is negatively charged, thereby increasing the stability of the bond, and satisfying the condition “δ] Prevent easy occurrence of structural decomposition with respect to ultraviolet radiation or playback light radiation by stabilizing the electron structure in the color development region” of “3-2-B] Basic Features Common to Organic Dye Recording Materials of This Embodiment”. Practical contents are that this embodiment uses “an azo metal complex” having a formula indicated by Formula 1 as the organic metal complex. This embodiment obtained by combining the anion part and cation part uses cobalt or nickel as a central metal M of this azo metal complex, thereby increasing the optical stability. However, it is also possible to use, e.g., scandium, yttrium, titanium, zirconium, hafnium, vanadium, niobium, tantalum, chromium, molybdenum, tungsten, manganese, technetium, rhenium, iron, ruthenium, osmium, rhodium, iridium, palladium, platinum, copper, silver, gold, zinc, cadmium, or mercury. As the dye for use in the cation part, this embodiment uses one of a cyanine dye, styryl dye, and monomethinecyanine dye having formulas indicated by Formula 3. Although this embodiment uses the azo metal complex in the anion part, a formazan metal complex may also be used. The organic dye recording material made up of the anion part and cation part described above is initially powdery. To form the recording layer 3-2, this powdery organic dye recording material is dissolved in an organic solvent, and the transparent substrate 2-2 is coated with the solution by spin coating. Examples of the organic solvent are fluorine alcohol-based TFP (tetrafluoropropanol), hydrocarbons such as pentane, hexane, cyclohexane, petroleum ether, and petroleum benzine, alcohols, phenols, ethers, nitrites, nitro compounds, sulfur-containing compounds, and combinations of these solvents.

5-4) Azo Metal Complex+“Copper” as Central Metal

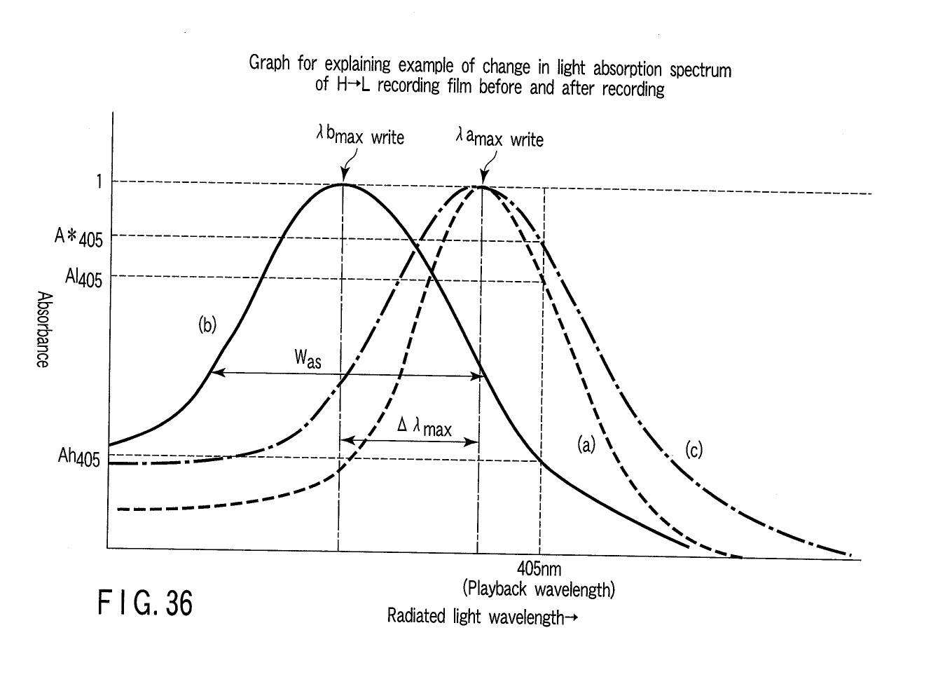

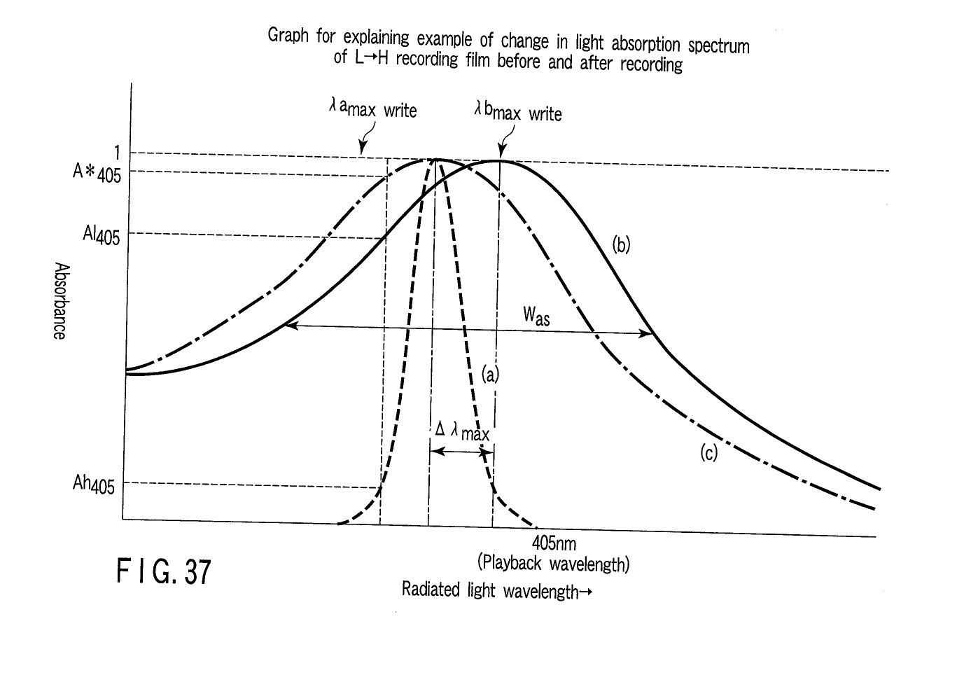

FIGS. 36 and 37 show examples of changes in light absorption spectra before and after information is recorded (recording marks are formed) in the “H→L” recording film and “L→H” recording film using the optical characteristic change of this embodiment as the recording principle. Let λb_{max write} be the wavelength λ_{max write} (in an unrecorded region) before recording, Wₐₛ be the half-width (the width of a wavelength region that satisfies the range of “A≧0.5” when the absorbance A at λb_{max write} is “1”) of a light absorption spectrum (b) centering around λb_{max write}, and λa_{max write} be the wavelength λ_{max write} of a light absorption spectrum (a) (in a recording mark) after recording. The recording film 3-2 having the characteristics shown in FIGS. 36 and 37 uses “a change in electron structure (electron orbit) with respect to electrons contributing to a color development phenomenon” and “a change in molecular structure inside a molecule” of the recording principles described in [α] of “3-2-B] Basic Features Common to Organic Dye Recording Materials of This Embodiment”. When “a change in electron structure (electron orbit) with respect to electrons contributing to a color development phenomenon” occurs, for example, the dimension or structure of the color development region 8 as shown in Formula 1 changes. As an example, if the dimension of the color development region 8 changes, the resonant absorption wavelength of those local electrons there changes. Consequently, the maximum absorption wavelength of the light absorption spectrum changes from λb_{max write} to λa_{max write}, Likewise, when “a change in molecular structure inside a molecule” occurs, the structure of the color development region 8 also changes, so the maximum absorption wavelength of the light absorption spectrum similarly changes. Letting Δλₘₐₓ be the change amount of the maximum absorption wavelength, the relationship indicated by
Δλₘₐₓ≡|a_{max write}−λb_{max write}| (49)
holds. When the maximum absorption wavelength of the light absorption spectrum thus changes, the half-width Wₐₛ of the light absorption spectrum changes accordingly. The influence on a playback signal obtained from the position of a recording mark when the maximum absorption wavelength and half-width Wₐₛ of the light absorption spectrum thus simultaneously change will be explained below. Referring to FIG. 36 (37), the light absorption spectrum before recording/in an unrecorded region is given by (b), so the absorbance to 405-nm playback light is Ah₄₀₅ (Al₄₀₅). If only the maximum absorption wavelength changes to λa_{max write} as the light spectrum (in a recording mark) after recording and the half-width Wₐₛ remains unchanged, the light absorption spectrum is as indicated by (c) in FIG. 36 (37), i.e., the absorbance to the 405-nm playback light changes to A*₄₀₅. In reality, however, the absorbance (in a recording mark) after recording is Al₄₀₅ (Ah₄₀₅) because the half-width changes. The change amount |Al₄₀₅−Ah₄₀₅| of the absorbance before and after recording is proportional to the amplitude of a playback signal. In the example shown in FIG. 36 (37), therefore, the change in maximum absorption wavelength and the change in half-width cancel the increase in amplitude of a playback signal. This worsens the C/N ratio of the playback signal. To eliminate this problem, the first application example of this embodiment is characterized by setting the characteristics of the recording layer 3-2 (designing the film) such that the change in maximum absorption wavelength and the change in half-width synergistically act on the increase in playback signal amplitude. That is, as can be readily predicted from the changes shown in FIG. 36 (37), the characteristics of the recording layer 3-2 are set (the film is designed) such that: in the “H→L” recording film, the half-width increases independently of the moving direction of λa_{max write} after recording with respect to λb_{max write} before recording, and

in the “L→H” recording film, the half-width decreases independently of the moving direction of λa_{max write} after recording with respect to λb_{max write} before recording.

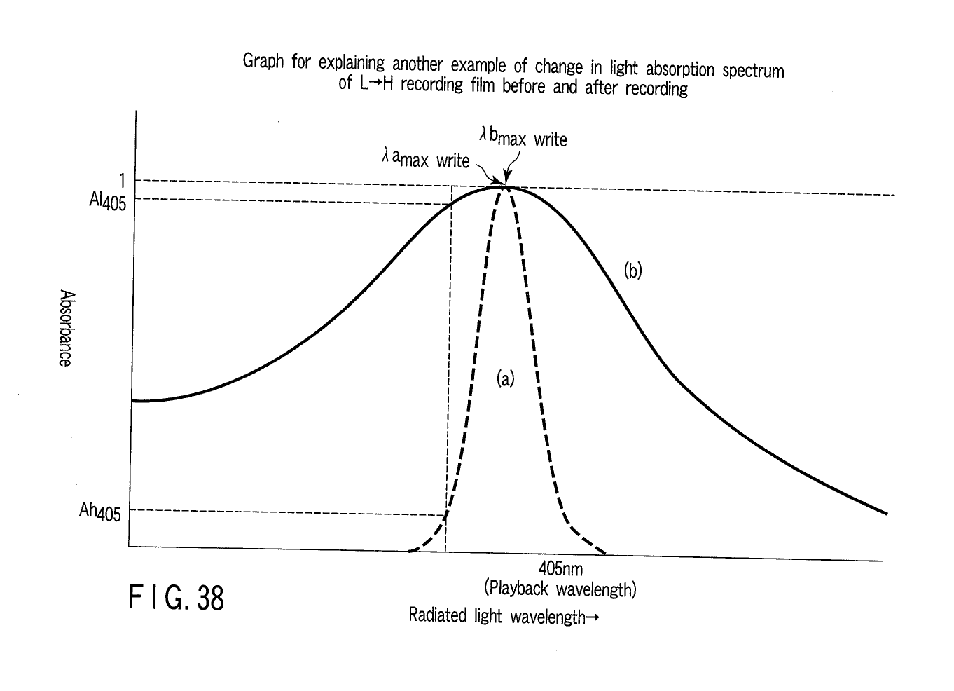

The second application example of this embodiment will be explained below. As described above, the change in maximum absorption wavelength and the change in half-width Wₐₛ are sometimes used to cancel the difference between Ah₄₀₅ and Al₄₀₅, thereby decreasing the C/N ratio of a playback signal. In addition, in the first application example and the embodiment shown in FIG. 36 or 37, the maximum absorption wavelength and the half-width Wₐₛ of the light absorption spectrum simultaneously change. Therefore, both the maximum absorption wavelength change amount Δλₘₐₓ and half-width change amount have influence on the value of the absorbance A (in a recording mark) after recording. When mass-producing write-once information storage media 12, it is difficult to accurately control the maximum absorption wavelength change amount Δλₘₐₓ and half-width change amount at the same time. As a result, the playback signal amplitude largely varies when information is recorded on the mass-produced, write-once information storage medium 12, and the reliability of a playback signal deteriorates when the medium is played back by an information playback apparatus. By contrast, the second application example of this embodiment is characterized by improving the material of the recording layer 3-2 so that the maximum absorption wavelength (in a recording mark and unrecorded region) does not change before and after recording, thereby suppressing the variation in value of the absorbance A (in a recording mark) after recording, decreasing the variation in playback signal amplitude between individual media, and improving the reliability of a playback signal. In the second application example, the maximum absorption wavelength (in a recording mark and unrecorded region) does not change before and after recording, so only the spreads of the light absorption spectra (in a recording mark and unrecorded region) before and after recording determine the value of the absorbance A. When mass-producing a large number of write-once information storage media 12, it is only necessary to control the spreads of the light absorption spectra (in a recording mark and unrecorded region) before and after recording. This makes it possible to decrease the variations in characteristics between the media. Strictly speaking, even when an improvement is done to prevent the change in maximum absorption wavelength (in a recording mark and unrecorded region) before and after recording, it is still difficult to completely match the values of λb_{max write} and λb_{max write} as shown in FIG. 38. The half-width Wₐₛ of the light absorption spectrum centering around λb_{max write} shown in FIG. 36 or 37 often falls within the range of 100 to 200 nm in general organic dye recording materials. Accordingly, it is readily possible to predict from FIG. 36 or 37 that if the value of the maximum absorption wavelength change amount Δλₘₐₓ exceeds 100 nm, a bit difference is produced between the absorbance Ah₄₀₅ (Al₄₀₅) obtained from the characteristic indicated by (b) and the absorbance A*₄₀₅ obtained from the characteristic indicated by (c). In the second application example, therefore, “the maximum absorption wavelength does not change” means satisfying a condition indicated by
Δλmax≦100 nm (50)

Furthermore, when the maximum absorption wavelength change amount Δλₘₐₓ is ⅓ that indicated by expression (50), i.e.,
Δλₘₐₓ≦30 nm (51)
the difference between the absorbance Ah₄₀₅ (Al₄₀₅) obtained from the characteristic indicated by (b) and the absorbance A*₄₀₅ obtained from the characteristic indicated by (c) becomes very small. This makes it possible to decrease the variations in playback signal characteristics between mass-produced media.

FIG. 38 shows “L→H” recording film characteristics meeting expression (50) or (51). The light absorption spectrum (in an unrecorded region) before recording is a wide spectrum as indicated by (b) in FIG. 38, and the absorbance Ah₄₀₅ at a playback wavelength of 405 nm has a sufficiently small value.

The light absorption spectrum (in a recording mark) after recording is a narrow spectrum as indicated by (a) in FIG. 38, and the absorbance Al₄₀₅ at a playback wavelength of 405 nm rises.

To meet expression (50) or (51), this embodiment uses “an intramolecular alignment change” of [α] in “3-2-B] Basic Features Common to Organic Dye Recording Materials of This Embodiment” as the recording principle. Practical contents of this embodiment (the second application example) will be explained below. In the azo metal complex shown in Formula 1, a radical bond forms in a benzene nucleus ring, so a plurality of benzene nucleus rings are arranged in the same plane. That is, in Formula 1, four benzene nucleus rings above the central metal M form a U (Up) plane by a benzene nucleus group, and four benzene nucleus rings below the central metal M form a D (Down) plane by a benzene nucleus group. The U and D planes are always parallel in any case (before and after recording). Side-chain groups R1 and R3 are arranged perpendicularly to the U and D planes. The central metal atom M and oxygen atoms 0 are bonded by ionic bonds (solid lines), and a plane formed by the lines connecting O-M-O is parallel to the U and D planes. The color development region 8 indicated as a circular region in Formula 1 has this three-dimensional structure. In the following explanation, a direction from R4 to R5 in the U plane is provisionally defined as “a Yu direction”, and a direction from R4 to R5 in the D plane is provisionally defined as “a Yd direction”. Nitrogen atoms N included in the U or D plane and the central metal atom M sandwiched between the two planes are bonded by coordinate bonds (broken lines), so the nitrogen atoms N can rotate around the central metal atom M. That is, while the U and D planes are kept parallel to each other, the Yd direction can rotate with respect to the Yu direction. In the azo metal complex shown in Formula 1, the Yu and Yd directions are parallel to each other as indicated by (a) in Formula 2 (the two directions can be opposite as indicated by (a) in Formula 2 or the same), or twisted as indicated by (b) in Formula 2. The directions Yu and Yd naturally make any arbitrary angle between the states indicated by (a) and (b) in Formula 2. As described above, the side-chain groups R1 and R3 are arranged perpendicularly to the U and D planes. In the structure indicated by (a) in Formula 2, therefore, the side-chain groups R1 or R3 or, e.g., side-chain groups R4 in the upper and lower portions easily collide against each other. Accordingly, the structure is most stable when the Yu and Yd directions are twisted (the Yu and Yd directions look perpendicular to each other when viewed from a position far above the U plane) as indicated by (b) in Formula 2. The light absorption wavelength in the color development region 8 in this state indicated by (b) in Formula 2 matches the value of λa_{max write}=λb1 in FIG. 38. When the relationship between the Yu and Yd directions start deviating from the state indicated by (b) in Formula 2, the electron structure and the local distance (the size of a local region) of light absorption electrons in the color development region 8 slightly change to shift the light absorption wavelength from the value of λa_{max write}=λb_{max write}. In the recording layer 3-2 (in an unrecorded state) immediately after being formed on the transparent substrate 2-2 by spinner coating, the Yu and Yd directions have an arbitrary relationship. This increases the distribution width of the light absorption spectrum as indicated by (b) in FIG. 38. When the internal temperature of the recording layer 3-2 is locally raised to form a recording mark, the molecular alignment starts moving due to the high temperature. Finally, most molecules take the structurally stable state indicated by (b) in Formula 2. Therefore, electron structures in the color development region 8 match anywhere in the recording mark, and the light absorption spectrum changes to have a small distribution width as indicated by (a) in FIG. 38. As a consequence, the absorbance at the playback wavelength (e.g., 405 nm) changes from Al₄₀₅ to Ah₄₀₅-Another effect obtained by the use of the color development region 8 in the azo metal complex as shown in Formula 1 will be explained. When using the combination of the anion part and cation part as described previously, a dye is used in the cation part. The combination of this cation part and the anion part not contributing to the color development region reduces the relative volume occupied by the color development region in the recording layer 3-2. This relatively reduces the light absorption sectional area, and decreases the molar absorption coefficient. Consequently, the value of the absorbance at the position of λ_{max write} shown in FIG. 34 decreases, and the recording sensitivity lowers. By contrast, when using the color development properties around the central metal of the azo metal complex alone to be explained below, the azo metal complex itself emits light, so there is no extra portion, such as the anion part described above, that does not contribute to the color development region. This eliminates an unnecessary factor that reduces the relative volume occupied by the color development region. In addition, the volume occupied by the color development region 8 in the azo metal complex is large as shown in Formula 1. Since this increases the light absorption sectional area, the molar absorption coefficient rises. This effectively increases the value of the absorbance at the position of λ_{max write} shown in FIG. 34, thereby increasing the recording sensitivity.

This embodiment is characterized by stabilizing the structure of the color development region by optimizing the central metal of the azo metal complex described above, as a practical method of “δ] preventing easy occurrence of structural decomposition with respect to ultraviolet radiation or playback light radiation by stabilizing the electron structure in the color development region” explained in “3-2-B] Basic Features Common to Organic Dye Recording Materials of This Embodiment”.

Metal ions have their respective unique ionization tendency characteristics. When metal atoms are arranged in descending order of ionization, the order is
Na>Mg>Al>Zn>Fe>Ni>Cu>Hg>Ag>Au

The ionization tendency of a metal atom represents “the property that the metal releases electrons to become a cation”.

The present inventors examined the stability of repetitive playback by placing various metal atoms as the central metal of the azo metal complex having the structure shown in Formula 1 (i.e., examined the stability of color development characteristics by repetitively radiating light close to 405 nm by the playback power). Consequently, the higher the ionization tendency of a metal atom, the more easily the metal atom releases electrons to disconnect the bond and destroy the color development region 8. The results of many experiments demonstrate that it is desirable to use metal materials (Ni, Cu, Hg, Ag, and Au) from nickel (Ni) as the central metal in order to stabilize the structure of the color development region. In addition, it is most desirable to use copper (Cu) as the central metal in this embodiment from the viewpoints of “high structural stability of the color development region”, “low cost”, and “use safety”. Note that this embodiment uses one of CH₃, CₓH_{y}, H, Cl, F, NO₂, and SO₂NHCH₃ as the side chains R1, R2, R3, R4, and R5 in Formula 1.

A method of forming the organic dye recording material having the molecular structure shown in Formula 1 as the recording layer 3-2 on the transparent substrate 2-2 will be explained below. A 1.49-g sample of the initially powdery organic dye recording material described above is dissolved in 100 ml of TFP (tetrafluoropropanol) as a fluorine alcohol-based solvent. The above numerical value means that the mixing ratio is 1.4 wt %. The actual use amount changes in accordance with the manufacturing amount of the write-once information recording media. The mixing ratio is desirably 1.2 to 1.5 wt %. The essential condition of the solvent is not to dissolve the surface of the transparent substrate 2-2 made of polycarbonate resin, so an alcohol-based solvent as described above is used. TFP (tetrafluoropropanol) has polarity, and hence increases the solubility of the powdery organic dye recording material. While the transparent substrate 2-2 on a spindle motor is rotated, the central portion of the transparent substrate 2-2 is coated with the organic dye recording material dissolved in the solvent. After the organic dye recording material is spread by using the centrifugal force, the transparent substrate 2-2 is left to stand until the solvent evaporates. Then, the recording layer 3-2 is hardened by baking that raises the temperature of the whole structure.

5-5) Azo Metal Complex Having Central Metal Bonding to Four Oxygen Atoms by Ionic Bonds

In the structure shown in Formula 1 in which two oxygen atoms bond to the central metal by ionic bonds, the alignment angle that the U and D planes formed by benzene nucleus groups make as indicated by (a) and (b) in Formula 2 achieves the recording principle.

As explained above, the use of copper or the like as the central metal M strengthens molecular bonds, and makes molecular destruction by ultraviolet radiation difficult to occur. This ensures the long-term stability as shown in Formula 2. However, if only two oxygen atoms bond to the central metal M by ionic bonds, the U and D planes formed by benzene nucleus groups easily rotate as indicated by (a) and (b) in Formula 2. Therefore, repetitive playback gradually changes the unrecorded region indicated by (a) in Formula 2 into the arrangement after recording as indicated by (b) in Formula 2. As a result, the recorded signal deteriorates.

[image]

[image]

Note that the present invention is not directly limited to the above embodiments, but can be embodied by modifying the constituent elements when practiced without departing from the spirit and scope of the invention. Note also that various inventions can be formed by appropriately combining a plurality of constituent elements disclosed in the embodiments. For example, some of all the constituent elements disclosed in the embodiments may also be deleted. It is also possible to appropriately combine the constituent elements of different embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage medium from which to record and play back information from one side of said medium, said medium comprising:
a substrate having lands and grooves with one of a concentric shape or a spiral shape and having a central hole;
a first recording layer formed along the lands and grooves of the substrate, having lands and grooves synchronized with said one of the concentric shape and the spiral shape, and comprising an organic dye material;
a first barrier layer formed on the first recording layer;
a spacer layer formed on the first barrier layer and having lands and grooves synchronized with said one of the concentric shape and the spiral shape on a surface opposite to a surface in contact with the first barrier layer;
a second recording layer formed along the lands and grooves of the spacer layer, having lands and grooves synchronized with said one of the concentric shape and the spiral shape, and comprising an organic dye material;
a second barrier layer formed on the second recording layer; and
a protective layer formed on the second barrier layer, an outer side surface and an inner side surface of the protective layer making an angle with a direction parallel to the surface of the second barrier layer between 30° to 150°.

2. A medium according to claim 1, wherein the angle which the outer side surface and inner side surface of the protective layer make with the surface of the second barrier layer is 45° to 135°.

3. A medium according to claim 1, wherein the angle which the outer side surface and inner side surface of the protective layer make with the surface of the second barrier layer is 60° to 120°.

4. A medium according to claim 1, wherein the first barrier layer and the second barrier layer are formed using aqueous paint.

5. An information storage medium from which to record and play back information from one side of said medium, said medium comprising:
a substrate having lands and grooves with one of a concentric shape or a spiral shape;
a first recording layer formed along the lands and grooves of the substrate, having lands and grooves synchronized with said one of the concentric shape and the spiral shape, and comprising an organic dye material;
a first barrier layer formed on the first recording layer;
a spacer layer formed on the first barrier layer and having lands and grooves synchronized with said one of the concentric shape and the spiral shape on a surface opposite to a surface in contact with the first barrier layer;
a second recording layer formed along the lands and grooves of the spacer layer, having lands and grooves synchronized with said one of the concentric shape and the spiral shape, and comprising an organic dye material;
a second barrier layer formed on the second recording layer; and
a protective layer formed on the second barrier layer,
wherein at least one of the first barrier layer and the second barrier layer has lands and grooves synchronized with said one of the concentric shape and the spiral shape on first and second major surfaces thereof, and a depth of the lands on the first major surface is smaller than a depth of the lands on the second major surface closer to the substrate.

6. A medium according to claim 5, wherein the first barrier layer and the second barrier layer are formed using aqueous paint.

7. An information storage medium from which to record and play back information from one side of said medium, said medium comprising:
a substrate having lands and grooves with one of a concentric shape or a spiral shape;
a first recording layer formed along the lands and grooves of the substrate, having lands and grooves synchronized with said one of the concentric shape and the spiral shape, and comprising an organic dye material;
a first barrier layer formed on the first recording layer from a material formable by coating;
a spacer layer formed on the first barrier layer and having lands and grooves synchronized with said one of the concentric shape and the spiral shape on a surface opposite to a surface in contact with the first barrier layer;
a second recording layer formed along the lands and grooves of the spacer layer, having lands and grooves synchronized with said one of the concentric shape and the spiral shape, and comprising an organic dye material;
a second barrier layer formed on the second recording layer from a material formable by coating; and
a protective layer formed on the second barrier layer.

8. A medium according to claim 7, wherein the first barrier layer and the second barrier layer are formed using aqueous paint.

9. An information storage medium from which to record and play back information from one side of said medium, said medium comprising:
a substrate having lands and grooves with one of a concentric shape or a spiral shape;
a light-reflecting layer formed along the lands and grooves of the substrate and having lands and grooves synchronized with said one of the concentric shape and the spiral shape;
a first recording layer formed along the lands and grooves of the light-reflecting layer, the first recording layer having lands and grooves synchronized with said one of the concentric shape and the spiral shape, and comprising an organic dye material;
a spacer layer formed on the first recording layer and having lands and grooves synchronized with said one of the concentric shape and the spiral shape on a surface opposite to a surface in contact with the first recording layer;
a semi-light transmitting layer formed on the spacer layer and having lands and grooves synchronized with said one of the concentric shape and the spiral shape on a surface opposite to a surface in contact with the spacer layer;
a second recording layer formed on the semi-light transmitting layer and comprising an organic dye material; and
a protective layer formed on the second recording layer,
wherein a wobble amplitude of the lands and grooves of the first recording layer which face the semi-light-transmitting layer is larger than a wobble amplitude of the lands and grooves of the second recording layer which face the light-reflecting layer.

10. A medium according to claim 9, wherein the first barrier layer is formed using aqueous paint.

11. An information storage medium from which to record and play back information from one side of said medium, said medium comprising:
a substrate having lands and grooves with one of a concentric shape or a spiral shape;
a light-reflecting layer formed along the lands and grooves of the substrate and having lands and grooves synchronized with said one of the concentric shape and the spiral shape;
a first recording layer formed along the lands and grooves of the light-reflecting layer, the first recording layer having lands and grooves synchronized with said one of the concentric shape and the spiral shape, and comprising an organic dye material;
a spacer layer formed on the first recording layer and having lands and grooves synchronized with said one of the concentric shape and the spiral shape on a surface opposite to a surface in contact with the first recording layer;
a semi-light transmitting layer formed on the spacer layer and having lands and grooves synchronized with said one of the concentric shape and the spiral shape on a surface opposite to a surface in contact with the spacer layer;
a second recording layer formed on the semi-light transmitting layer and comprising an organic dye material; and
a protective layer formed on the second recording layer, wherein a depth of the lands of the first recording layer differs from a depth of the lands of the second recording layer.

12. A medium according to claim 11, wherein the depth of the lands of the first recording layer is larger than the depth of the lands of the second recording layer.

13. A medium according to claim 11, wherein the first barrier layer and the second barrier layer are formed using aqueous paint.

14. A disk apparatus comprising:
a detecting mechanism configured to detect reflected light obtained by emitting a laser beam at an information storage medium configured to record and play back information from one side of said medium, said medium comprising:
a substrate having lands and grooves with one of a concentric shape or a spiral shape and having a central hole;
a first recording layer formed along the lands and grooves of the substrate, having lands and grooves synchronized with said one of the concentric shape and the spiral shape, and comprising an organic dye material;
a first barrier layer formed on the first recording layer;
a spacer layer formed on the first barrier layer and having lands and grooves synchronized with said one of the concentric shape and the spiral shape on a surface opposite to a surface in contact with the first barrier layer;
a second recording layer formed along the lands and grooves of the spacer layer, having lands and grooves synchronizing with said one of the concentric shape and the spiral shape, and comprising an organic dye material;
a second barrier layer formed on the second recording layer; and
a protective layer formed on the second barrier layer, an outer side surface and inner side surface of the protective layer making an angle with a direction parallel to the surface of the second barrier layer between 30° to 150°; and
a generating mechanism configured to generate a playback signal on the basis of the reflected light detected by the detecting mechanism.

15. An apparatus according to claim 14, wherein the angle which the outer side surface and inner side surface of the protective layer make with the surface of the second barrier layer is 45° to 135°.

16. An apparatus according to claim 14, wherein the angle which the outer side surface and inner side surface of the protective layer make with the surface of the second barrier layer is 60° to 120°.

17. An apparatus according to claim 14, wherein the first barrier layer and the second barrier layer are formed using aqueous paint.

18. A disk apparatus comprising:
a detecting mechanism configured to detect reflected light obtained by emitting a laser beam at an information storage medium configured to record and play back information from one side of said medium, said medium comprising:
a substrate having lands and grooves with one of a concentric shape or a spiral shape;
a first recording layer formed along the lands and grooves of the substrate, having lands and grooves synchronized with said one of the concentric shape and the spiral shape, and comprising an organic dye material;
a first barrier layer formed on the first recording layer;
a spacer layer formed on the first barrier layer and having lands and grooves synchronized with said one of the concentric shape and the spiral shape on a surface opposite to a surface in contact with the first barrier layer;
a second recording layer formed along the lands and grooves of the spacer layer, having lands and grooves synchronizing with said one of the concentric shape and the spiral shape, and comprising an organic dye material;
a second barrier layer formed on the second recording layer; and
a protective layer formed on the second barrier layer, wherein at least one of the first barrier layer and the second barrier layer has lands and grooves synchronized with said one of the concentric shape and the spiral shape on first and second major surfaces thereof, and a depth of the lands on the first major surface is smaller than a depth of the lands on the second major surface closer to the substrate; and
a generating mechanism configured to generate a playback signal on the basis of the reflected light detected by the detecting mechanism.

19. An apparatus according to claim 18, wherein the first barrier layer and the second barrier layer are formed using aqueous paint.

20. A disk apparatus comprising:
a detecting mechanism configured to detect reflected light obtained by emitting a laser beam at an information storage medium configured to record and play back information from one side of said medium, said medium comprising:
a substrate having lands and grooves with one of a concentric shape or a spiral shape;
a first recording layer formed along the lands and grooves of the substrate, having lands and grooves synchronized with said one of the concentric shape and the spiral shape, and comprising an organic dye material;
a first barrier layer formed on the first recording layer from a material formable by coating;
a spacer layer fonmed on the first barrier layer and having lands and grooves synchronized with said one of the concentric shape and the spiral shape on a surface opposite to a surface in contact with the first barrier layer;
a second recording layer formed along the lands and grooves of the spacer layer, having lands and grooves synchronized with said one of the concentric shape and the spiral shape, and comprising an organic dye material;
a second barrier layer formed on the second recording layer from a material formable by coating; and
a protective layer formed on the second barrier layer; and
a generating mechanism configured to generate a playback signal on the basis of the reflected light detected by the detecting mechanism.

21. An apparatus according to claim 20, wherein the first barrier layer and the second barrier layer are formed using aqueous paint.

22. A disk apparatus comprising:
a detecting mechanism configured to detect reflected light obtained by emitting a laser beam at an information storage medium to record and play back information from one side of said medium, said medium comprising:
a substrate having lands and grooves with one of a concentric shape or a spiral shape;
a light-reflecting layer formed along the lands and grooves of the substrate and having lands and grooves synchronized with said one of the concentric shape and the spiral shape;
a first recording layer formed along the lands and grooves of the light-reflecting layer, having lands and grooves synchronized with said one of the concentric shape and the spiral shape, and comprising an organic dye material;
a spacer layer formed on the first recording layer and having lands and grooves synchronized with said one of the concentric shape and the spiral shape on a surface opposite to a surface in contact with the first recording layer;
a semi-light-transmitting layer formed on the spacer layer and having lands and grooves synchronized with said one of the concentric shape and the spiral shape on a surface opposite to a surface in contact with the spacer layer;
a second recording layer formed on the semi-light-transmitting layer and comprising an organic dye material; and
a protective layer formed on the second recording layer, wherein a wobble amplitude of the lands and grooves of the first recording layer which face the semi-light-transmitting layer is larger than a wobble amplitude of the lands and grooves of the second recording layer which face the light-reflecting layer; and
a generating mechanism configured to generate a playback signal on the basis of the reflected light detected by the detecting mechanism.

23. An apparatus according to claim 22, wherein the first barrier layer is formed using aqueous paint.

24. A disk apparatus comprising:
a detecting mechanism configured to detect reflected light obtained by emitting a laser beam at an information storage medium configured to record and play back information from one side of said medium, said medium comprising:
a substrate having lands and grooves with one of a concentric shape or a spiral shape;
a light-reflecting layer formed along the lands and grooves of the substrate and having lands and grooves synchronized with said one of the concentric shape and the spiral shape;
a first recording layer formed along the lands and grooves of the light-reflecting layer, having lands and grooves synchronized with said one of the concentric shape and the spiral shape, and comprising an organic dye material;
a spacer layer formed on the first recording layer and having lands and grooves synchronized with said one of the concentric shape and the spiral shape on a surface opposite to a surface in contact with the first recording layer;
a semi-light transmitting layer formed on the spacer layer and having lands and grooves synchronized with said one of the concentric shape and the spiral shape on a surface opposite to a surface in contact with the spacer layer;
a second recording layer formed on the semi-light transmitting layer and comprising an organic dye material; and
a protective layer formed on the second recording layer, wherein a depth of the lands of the first recording layer differs from a depth of the lands of the second recording layer; and
a generating mechanism configured to generate a playback signal on the basis of the reflected light detected by the detecting mechanism.

25. An apparatus according to claim 24, wherein the depth of the lands of the first recording layer is larger than the depth of the lands of the second recording layer.

26. An apparatus according to claim 24, wherein the first barrier layer is formed using aqueous paint.
